(19) United States
(12) Patent Application Publication
(10) Pub. No.: US 2024/0405198 A1
(43) Pub. Date: Dec. 5, 2024

(54) JAGGED ELECTROCHEMICALLY-ACTIVE COMPOSITE PARTICLES FOR LITHIUM-ION BATTERIES

(71) Applicant: Sila Nanotechnologies, Inc., Alameda, CA (US)

(72) Inventors: Joel SANCHEZ, Modesto, CA (US); Ismael RODRÍGUEZ PÉREZ, Oakland, CA (US); Weimin WANG, San Mateo, CA (US); Christopher Leland MCGANN, San Francisco, CA (US); Gleb Nikolayevich YUSHIN, Atlanta, GA (US); John Frederick TANNACI, Santa Cruz, CA (US)

(21) Appl. No.: 18/398,718

(22) Filed: Dec. 28, 2023

Related U.S. Application Data
(60) Provisional application No. 63/477,727, filed on Dec. 29, 2022.

(51) Int. Cl. H01M 4/36; H01M 4/02; H01M 4/1393; H01M 4/1395; H01M 4/38; H01M 4/583; H01M 4/62; H01M 10/0525; H01M 10/058

(52) U.S. Cl. CPC H01M 4/364; H01M 4/1393; H01M 4/1395; H01M 4/386; H01M 4/583; H01M 4/625; H01M 10/0525; H01M 10/058; H01M 2004/021; H01M 2004/027; H01M 2004/028

(57) ABSTRACT

A battery electrode composition includes a population of jagged composite particles, in which each of the jagged composite particles includes silicon and carbon. In some embodiments, 90% or more of the jagged composite particles in the population are characterized by aspect ratios of 2.3 or less and 50% or more of the jagged composite particles in the population are characterized by aspect ratios of 1.25 or more. In some embodiments, the population is characterized by a particle size distribution (PSD) as determined by laser particle size distribution analysis (LPSA) and a fiftieth-percentile volume-weighted particle size parameter D₅₀ of the PSD is in a range of about 2.0 to about 17.0 μm.

### CROSS-REFERENCE TO RELATED APPLICATIONS

The present Application for Patent claims the benefit of U.S. Provisional Application No. 63/477,727, entitled “JAGGED ELECTROCHEMICALLY-ACTIVE COMPOSITE PARTICLES FOR LITHIUM-ION BATTERIES,” filed Dec. 29, 2022, assigned to the assignee hereof, and expressly incorporated herein by reference in its entirety.

### BACKGROUND

### Field

Aspects of the present disclosure relate generally to energy storage devices, and more particularly to battery technology and the like.

### Background

Owing in part to their relatively high energy densities, relatively high specific energy, light weight, and potential for long lifetimes, advanced rechargeable batteries are desirable for a wide range of consumer electronics, electric vehicle, grid storage and other important applications.

However, despite the increasing commercial prevalence of batteries, further development of these batteries is needed, particularly for applications in low- or zero-emission, hybrid-electric or fully-electric vehicles, consumer electronics, wearable devices, energy-efficient cargo ships and locomotives, drones, aerospace applications, and power grids. In particular, further improvements are desired for various rechargeable batteries, such as rechargeable Li and Li-ion batteries, rechargeable Na and Na-ion batteries, and rechargeable K and K-ion batteries, to name a few.

In certain types of Li metal and Li-ion rechargeable batteries, charge storing anodes may comprise silicon (Si)-comprising anode particles with gravimetric capacities in the range from about 800 mAh/g to about 3000 mAh/g (per mass of Si-comprising anode particles in a Li-free state). A subset of such anodes includes anodes with the electrode layer exhibiting capacity in the range from about 400 mAh/g to about 2800 mAh/g (per mass of the electrode layer, not counting the mass of the current collector, in a Li-free state). Such a class of charge-storing anodes offers great potential for increasing gravimetric and volumetric energy of rechargeable batteries.

In certain types of rechargeable batteries, charge storing anode active materials may be produced as high-capacity (nano) composite powders (e.g., at least partially comprised of active material nanomaterials or nanostructures that may be embedded on and/or in a porous structure, such as a C-comprising matrix material), which exhibit moderately high volume changes (e.g., about 8-180 vol. %) during the first charge-discharge cycle and moderate volume changes (e.g., about 5-50 vol. %) during the subsequent charge-discharge cycles. A subset of such charge-storing anode particles includes anode particles with an average size (e.g., diameter or thickness) in the range of about 0.2 to about 40 μm (micrometers, or μm), as measured using laser particle size distribution analysis (LPSA), laser image analysis, electron microscopy, optical microscopy or other suitable techniques. Such a class of charge-storing particles offers great promises for scalable manufacturing and achieving high cell-level energy density and other performance characteristics.

Examples of electrode materials that exhibit moderately high volume changes (e.g., about 8-180 vol. %) during the first charge-discharge cycle and moderate volume changes (e.g., about 5-50 vol. %) during the subsequent charge-discharge cycles include (nano) composites comprising so-called conversion-type (which includes both so-called chemical transformation and so-called “true conversion” subclasses) and so-called alloying-type active electrode materials. In the case of metal-ion batteries (such as Li-ion batteries), examples of such conversion-type active electrode materials include, but are not limited to, metal fluorides (such as lithium fluoride, iron fluoride, copper fluoride, bismuth fluoride, their mixtures and alloys, etc.), metal chlorides, metal iodides, metal bromides, metal chalcogenides (such as sulfides, including lithium sulfide and other metal sulfides), sulfur, selenium, metal oxides (including but not limited to lithium oxide and silicon oxide), metal nitrides, metal phosphides (including lithium phosphide), metal hydrides, and others. In the case of metal-ion batteries (such as Li-ion batteries), examples of such alloying-type electrode materials include, but are not limited to, silicon, germanium, antimony, aluminum, magnesium, zinc, gallium, arsenic, phosphorus, silver, cadmium, indium, tin, lead, bismuth, their alloys, and others. These materials typically offer higher gravimetric and volumetric capacity than so-called intercalation-type electrodes commonly used in commercial metal-ion (e.g., Li-ion) batteries. Alloying-type electrode materials are particularly advantageous for use in certain high-capacity anodes for Li-ion batteries. Silicon-based alloying-type anodes may be particularly attractive for such applications.

An example of low swelling particles may comprise the mixture of conversion silicon-based (or, broadly, silicon-comprising) anode active materials with graphite, so-called silicon-graphite blends. In some examples of a blended anode, the Si-comprising anode active material may be Si-comprising and C-comprising nanocomposite (referred to herein as Si—C composite or Si—C nanocomposite or Si—C composite (or nanocomposite) particles, even if such particles comprise elements other than Si and C in relatively small quantities of less than about 10-20 at. %) and offers from about 20 to 80% of total blended anode capacity, while the rest of the capacity is from graphite. (In other examples, the Si—C composite (e.g., Si—C composite particles) may contribute more than about 80% or less than about 20% of the anode's capacity). Such anodes offer much higher volumetric and gravimetric energy density than the intercalation-type graphite anodes commonly used in commercial Li-ion batteries. In addition, in such blended anode, the graphite may be composed of natural, artificial or a mixture of natural and artificial graphites. In some designs, it is more advantageous to use natural graphite or a mixture of natural and artificial graphites since such graphite particles are able to accommodate stresses caused by the high-swelling (during Li insertion) Si-based (e.g., Si—C) particles. Such properties of Si—C nanocomposite-graphite blends may offer overall moderate volume changes during the first cycle and low volume changes during the subsequent charging cycles. Such properties are advantageous for high-capacity loading anode particles, which may also reduce the cost of manufacturing of such battery cells.

In some designs, active electrode materials for use in electrochemical energy storage devices, such as batteries or electrochemical capacitors or hybrid devices, may be carbon-containing composite particles. A sub-class of such composite particles may include composite particles where conversion-type, alloying-type, intercalation-type or pseudocapacitive materials are confined within or infiltrated within carbon- or carbon-containing matrix material. However, existing approaches of synthesis or thermochemical processing of such carbon- or carbon-containing matrix materials can suffer from low efficiency, low packing density, low throughput, or insufficient control over uniformity or other limitations.

Accordingly, there remains a need for improved batteries, components, and other related materials and manufacturing processes.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a battery electrode composition includes a population of jagged composite particles, each of the jagged composite particles comprising silicon and carbon; wherein: about 90% or more of the jagged composite particles in the population are characterized by aspect ratios of about 2.3 or less; about 50% or more of the jagged composite particles in the population are characterized by aspect ratios of about 1.25 or more; and the population is characterized by a particle size distribution (PSD) as determined by laser particle size distribution analysis (LPSA) such that: a fiftieth-percentile volume-weighted particle size parameter (D₅₀) of the PSD of the population is in a range of about 2.0 to about 17.0 μm.

In some aspects, about 90% or more of the jagged composite particles in the population are characterized by aspect ratios of about 2.1 or less.

In some aspects, about 50% or more of the jagged composite particles in the population are characterized by aspect ratios of about 1.35 or more.

In some aspects, about 10% or more of the jagged composite particles in the population are characterized by aspect ratios of about 1.3 or less.

In some aspects, a mass fraction of the silicon in the jagged composite particles is in a range of about 3 wt. % to about 80 wt. %.

In some aspects, the mass fraction of the silicon is in a range of about 33 wt. % to about 60 wt. %.

In some aspects, a Brunauer-Emmett-Teller (BET) specific surface area (SSA) of the population is in a range of about 1 m²/g to about 18 m²/g.

In some aspects, the BET-SSA is in a range of about 1 m²/g to about 10 m²/g.

In some aspects, the D50 is in a range of about 2.0 to about 8.0 μm.

In some aspects, the D50 is in a range of about 6.0 to about 17.0 μm.

In some aspects, the D50 is in a range of about 6.0 to about 9.0 μm.

In some aspects, a span of the PSD of the population is in a range of about 0.3 to about 1.8.

In some aspects, tenth-percentile volume-weighted particle size parameter (D₁₀) of the PSD of the population is at least about 1.0 μm; and a value of the D₁₀ of the PSD of the population divided by the D₅₀ of the PSD of the population is in a range of 35% to 75%.

In some aspects, the battery electrode composition comprises a blended mixture of the jagged composite particles and graphite particles; and a mass fraction of the jagged composite particles in the battery electrode composition, excluding any binder, is in a range of about 10 wt. % to about 70 wt. %, or a mass fraction of the graphite particles in the battery electrode composition, excluding any binder, is in a range of about 30 wt. % to about 90 wt. %, or a combination thereof.

In some aspects, the D₅₀ of the PSD of the population is in a range of about 6.0 to about 12.0 μm.

In some aspects, a tenth-percentile volume-weighted particle size parameter (D₁₀) of the PSD of the population is in a range of about 1.0 to about 4.0 μm.

In some aspects, a ninetieth-percentile volume-weighted particle size parameter (D₉₀) of the PSD of the population is in a range of about 7.0 to about 25.0 μm.

In some aspects, the Doo is in a range of about 12.0 to about 20.0 μm.

In some aspects, a ninety-ninth-percentile volume-weighted particle size parameter (D₉₉) of the PSD of the population is in a range of about 15.0 to about 28.0 μm.

In some aspects, a span of the PSD of the population is in a range of about 0.6 to about 2.1.

In some aspects, a Brunauer-Emmett-Teller (BET) specific surface area (SSA) of the population is in a range of about 1 m²/g to about 10 m²/g.

In some aspects, the jagged composite particles exhibit a specific first cycle lithiation capacity in the range of about 1600 mAh/g to about 2200 mAh/g.

In some aspects, a specific capacity of the blended mixture is in a range of about 600 mAh/g to about 1200 mAh/g when normalized by a mass of the blended mixture.

In an aspect, a battery electrode includes a battery electrode composition disposed on and/or in a current collector, wherein: the battery electrode comprises a binder.

In some aspects, a coating density of the battery electrode is in a range of about 0.9 to about 1.7 g/cm³.

In some aspects, a carbon-comprising functional additive.

In some aspects, the carbon-comprising functional additive is selected from: single-walled carbon nanotubes, multi-walled carbon nanotubes, carbon nanofibers, carbon black, exfoliated graphite, graphene oxide, and graphene.

In some aspects, a mass fraction of the carbon-comprising functional additive in the battery electrode is about 1 wt. % or less.

In some aspects, the D₅₀ of the PSD of the population is in a range of about 6.0 to about 8.0 μm; and a mass fraction of the binder in the battery electrode is in a range of about 7 wt. % to about 10 wt. %.

In some aspects, the D₅₀ of the PSD of the population is in a range of about 6.0 to about 8.0 μm; and an areal binder loading of the battery electrode is in a range of about 9.0 mg/m² to about 13.0 mg/m², the areal binder loading being defined as a mass fraction of the binder in the battery electrode, divided by a product of (1) a mass fraction of the jagged composite particles in the battery electrode, and (2) a Brunauer-Emmett-Teller (BET) specific surface area of the population.

In an aspect, a lithium-ion battery includes an anode current collector; a cathode current collector; a battery electrode configured as an anode, the current collector thereof being configured as the anode current collector; a cathode disposed on or in the cathode current collector; and an electrolyte ionically coupling the anode and the cathode.

In an aspect, a method of making a battery electrode includes (A1) providing a battery electrode composition; (A2) making a slurry comprising the battery electrode composition and a binder; and (A3) casting the slurry on and/or in a current collector to form the battery electrode.

In an aspect, a method of making a lithium-ion battery includes (B1) making a battery electrode, the battery electrode being configured as an anode and the current collector being configured as an anode current collector; (B2) making or providing a cathode disposed on and/or in a cathode current collector; and (B3) assembling a battery cell from the anode and the cathode and filling a space between the anode and the cathode with an electrolyte ionically coupling the anode and the cathode to form the lithium-ion battery.

In an aspect, a method of making a lithium-ion battery includes (C1) providing a battery electrode, the battery electrode being configured as an anode and the current collector being configured as an anode current collector; (C2) making or providing a cathode disposed on and/or in a cathode current collector; and (C3) assembling a battery cell from the anode and the cathode and filling a space between the anode and the cathode with an electrolyte ionically coupling the anode and the cathode to form the lithium-ion battery.

An aspect is directed to a battery electrode composition comprising a population of jagged composite particles, in which each of the jagged composite particles comprises silicon (Si) and carbon (C) (e.g., mostly graphitic carbon) and may comprise other elements, such as nitrogen (N), phosphorus (P), boron (B), oxygen (O), hydrogen (H), sulfur(S), to name a few. In some embodiments, a total mass of the Si and the C may contribute from about 75 wt. % to about 100 wt. % of the total mass of the composite particles. Such composite particles are sometimes referred to herein as Si—C composites. In some embodiments, such composite particles comprise nano-sized or nanostructured elements (e.g., nano-sized or nanostructured Si, nano-sized or nanostructured C), which may be referred to as nanocomposite particles. In some implementations, the Si or Si-comprising material present in such nanocomposites may be in the form of nanoparticles. In some implementations, the mass-average size of Si or Si-comprising material nanoparticles may range from about 1 nm to about 200 nm (in some designs, from about 1 nm to about 10 nm; in other designs, from about 10 nm to about 30 nm; in yet other designs, from about 30 nm to about 100 nm; in yet other designs, from about 100 nm to about 200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques. In some embodiments, 90% or more of the jagged composite particles in the population are characterized by aspect ratios of 2.3 or less, or aspect ratios of 2.1 or less. In some embodiments, 50% or more of the jagged composite particles in the population are characterized by aspect ratios of 1.25 or more, or aspect ratios of 1.35 or more. In some embodiments, 10% or more of the jagged composite particles in the population are characterized by aspect ratios of 1.3 or less. The population may be characterized by a particle size distribution (PSD) as determined by laser particle size distribution analysis (LPSA), image analysis of electron microscopy images, or other suitable techniques. In some embodiments, a fiftieth-percentile volume-weighted particle size parameter (D₅₀) of the PSD is in a range of about 2.0 μm to about 16.0 μm, or in a range of about 2.0 to about 4.0 μm, or in a range of about 4.0 to about 6.0 μm, or in a range of about 6.0 to about 8.0 μm or in a range of about 8.0 to about 16.0 μm. In some embodiments, a fiftieth-percentile volume-weighted particle size parameter (D₅₀) of the PSD is in a range of about 1.0 μm to about 17.0 μm, or in a range of about 1.0 to about 4.0 μm, or in a range of about 4.0 to about 6.0 μm, or in a range of about 6.0 to about 9.0 μm or in a range of about 9.0 to about 17.0 μm.

Another aspect is directed to a battery electrode composition comprising a population of nanocomposite particles, in which each of the nanocomposite particles comprises Si and C (so that the total mass of Si and C atoms contributes 75 to 100 wt. % of the nanocomposite particle mass), and the nanocomposite particles have certain characteristics. In some embodiments, a mass fraction of the silicon in the nanocomposite particles is in a range of about 3 wt. % to about 80 wt. % (in some designs, from about 3 wt. % to about 20 wt. %; in other designs, from about 20 wt. % to about 35 wt. %; in yet other designs, from about 35 wt. % to about 50 wt. %; in yet other designs, from about 50 wt. % to about 80 wt. %; in yet other designs, from about 33 wt. % to about 60 wt. %; in yet other designs from about 5 wt. % to about 50 wt. %; in yet other designs from about 7 wt. % to about 40 wt. %; in yet other designs from about 9 wt. % to about 30 wt. %.). In some embodiments, a Brunauer-Emmett-Teller (BET) specific surface area (SSA) of the composite particles is in a range of about 1 m²/g to about 50 m²/g (in some designs, from about 1 to about 3 m²/g; in other designs, from about 3 m²/g to about 12 m²/g; in yet other designs, from about 12 m²/g to about 18 m²/g; in yet other designs, from about 18 m²/g to about 30 m²/g; in yet other designs, from about 30 m²/g to about 50 m²/g).

Yet another aspect is directed to a battery electrode composition comprising a population of composite (e.g., nanocomposite) particles, in which some or all of the composite particles comprises silicon and carbon (so that the total mass of Si and C atoms contributes 75 to 100 wt. % of the nanocomposite particle mass). The population may be characterized by a particle size distribution (PSD) as determined by laser particle size distribution analysis (LPSA) on well-dispersed particle suspensions in one example. Note that other types of particle size distribution (e.g., by SEM image analysis) could also be utilized (and may even lead to more precise measurements, in some experiments). In some embodiments, a fiftieth-percentile volume-weighted particle size parameter (D₅₀) of the PSD is in a range of about 1.0 μm to about 12.0 μm (in some designs, from about 1.0 μm to about 2.0 μm; in other designs, from about 2.0 μm to about 4.0 μm; in yet other designs, from about 4.0 μm to about 6.0 μm; in yet other designs, from about 6.0 μm to about 12.0 μm). A cumulative volume fraction, defined as a cumulative volume of the composite particles with particle sizes of a threshold particle size or less, divided by a total volume of all of the composite particles, may be estimated by LPSA. In some embodiments (e.g., when the D₅₀ is in a range from about 2.0 μm to about 4.0 μm), the cumulative volume fraction, with the threshold particle size at 4.6 μm, is 90 vol. % or less, or 85 vol. % or less, or 80 vol. % or less. In other embodiments (e.g., when the D₅₀ is in a range from about 4.0 μm to about 6.0 μm), the cumulative volume fraction, with the threshold particle size at 7 μm, is 90 vol. % or less, or 85 vol. % or less, or 80 vol. % or less. In yet other embodiments (e.g., when the D₅₀ is in a range from about 6.0 μm to about 12.0 μm), the cumulative volume fraction, with the threshold particle size at 15 μm, is 90 vol. % or less, or 85 vol. % or less, or 80 vol. % or less. Note that the presence of excessively large particles may reduce cell performance characteristics (e.g., reduce cell stability, increase its impedance, reduce rate performance, etc.). In some embodiments (e.g., when the D₅₀ is in a range from about 2.0 μm to about 4.0 μm), the cumulative volume fraction, with the threshold particle size at 10 μm, is 80 vol. % or more. In some embodiments (e.g., when the D₅₀ is in a range from about 2.0 μm to about 4.0 μm), the cumulative volume fraction, with the threshold particle size at 12 μm, is 90 vol. % or more. In other embodiments (e.g., when the D₅₀ is in a range from about 4.0 μm to about 6.0 μm), the cumulative volume fraction, with the threshold particle size at 15 μm, is 80 vol. % or more. In other embodiments (e.g., when the D₅₀ is in a range from about 4.0 μm to about 6.0 μm), the cumulative volume fraction, with the threshold particle size at 22 μm, is 90 vol. % or more. In other embodiments (e.g., when the D₅₀ is in a range from about 6.0 μm to about 12.0 μm), the cumulative volume fraction, with the threshold particle size at 28 μm, is 80 vol. % or more. In yet other embodiments (e.g., when the D₅₀ is in a range from about 6.0 μm to about 12.0 μm), the cumulative volume fraction, with the threshold particle size at 32 μm, is 90 vol. % or more.

Yet another aspect is directed to a battery electrode composition comprising a population of composite (e.g., nanocomposite) particles, in which each of the composite particles comprises silicon and carbon (e.g., mostly graphitic, sp²-bonded carbon) (so that the total weight of Si and C atoms contributes to 75-100 wt. % of the nanocomposite particle mass). The population may be characterized by a particle size distribution (PSD) as determined by laser particle size distribution analysis (LPSA) in one example. In some embodiments, a fiftieth-percentile volume-weighted particle size parameter (D₅₀) of the PSD is in a range of about 6.0 μm to about 8.0 μm. In some embodiments, a Brunauer-Emmett-Teller (BET) specific surface area of the composite particles is in a range of about 1 m²/g to about 50 m²/g (in some designs, from about 1 to about 3 m²/g; in other designs, from about 3 m²/g to about 12 m²/g; in yet other designs, from about 12 m²/g to about 18 m²/g; in yet other designs, from about 18 m²/g to about 30 m²/g; in yet other designs, from about 30 m²/g to about 50 m²/g).

Yet another aspect is directed to a battery electrode composition comprising a population of composite (e.g., nanocomposite) particles, in which each of the composite particles comprises silicon and carbon (mostly graphitic, sp²-bonded carbon) (so that the total mass of Si and C atoms contributes 75 to 100 wt. % of the nanocomposite particle mass). In some embodiments, the battery electrode composition may comprise one or more carbon-comprising functional additives (e.g., additives that enhance electrical conductivity or rate performance of mechanical properties of the electrode). In some embodiments, the carbon-comprising functional additive is selected from: carbon nanotubes (e.g., single walled carbon nanotubes (SWCNTs), multi-walled carbon nanotubes (MWCNTs), carbon nanofibers, carbon black, graphite, exfoliated graphite, graphene oxide (e.g., single-walled graphene oxide, multi-walled graphene oxide), and graphene (e.g., single-walled graphene, multi-walled graphene). In some embodiments, the battery electrode composition may comprise one or more binders (in some designs, two or more binder components).

Yet another aspect is directed to a battery electrode. In some embodiments, the battery electrode comprises any of the foregoing battery electrode compositions, disposed on or in a current collector. In some embodiments, the battery electrode comprises a battery electrode composition and a binder. In some embodiments, a coating density of the battery electrode is in a range of about 0.8 to about 1.5 g/cm³ or in a range of about 0.8 to about 1.7 g/cm³ (in some designs, from about 0.8 to about 0.9 g/cm³; in other designs, from about 0.9 to about 1.0 g/cm³; in yet other designs, from about 1.0 to about 1.2 g/cm³; in yet other designs, from about 1.2 to about 1.5 g/cm³; in yet other designs, from about 0.9 to about 1.6 g/cm³; in yet other designs, from about 0.9 to about 1.2 g/cm³; in yet other designs, from about 0.9 to about 1.7 g/cm³). In some embodiments, the battery electrode comprises a carbon-comprising functional additive. In some implementations, the carbon-comprising functional additive may be selected from: carbon nanotubes (e.g., SWCNT, MWCNT), carbon nanofibers, carbon black, graphite, exfoliated graphite, graphene oxide (e.g., single-walled graphene oxide, multi-walled graphene oxide), and graphene (e.g., single-walled graphene, multi-walled graphene).

Yet another aspect is directed to a battery electrode. In some embodiments, the battery electrode comprises any of the foregoing battery electrode compositions, disposed on or in a current collector. In some embodiments, the battery electrode comprises a battery electrode composition and a binder. In some embodiments, the battery electrode composition comprises a population of jagged composite particles characterized by a particle size distribution (PSD) as determined by laser particle size distribution analysis (LPSA). In some embodiments, a fiftieth-percentile volume-weighted particle size parameter (D₅₀) of the PSD is in a range of about 6.0 to about 8.0 μm. In some embodiments, a mass fraction of the binder in the battery electrode is in a range of about 7 wt. % to about 10 wt. %.

The battery electrode (e.g., an anode comprising Si—C nanocomposite particles) may be characterized by an areal binder loading, defined as a mass fraction of the binder in the battery electrode, divided by a product of (1) a mass fraction of the jagged composite (e.g., nanocomposite) particles in the battery electrode, and (2) a Brunauer-Emmett-Teller (BET) specific surface area of the particle population. In some embodiments, an areal binder loading of the battery electrode (e.g., anode comprising Si—C nanocomposite particles) is in a range of about 2.0 mg/m² to about 15.0 mg/m² (e.g. in some designs, from about 2.0 mg/m² to about 5.0 mg/m²; in other designs, from about 5.0 mg/m² to about 9.0 mg/m²; in yet other designs, from about 9.0 mg/m² to about 13.0 mg/m²).

Yet another aspect is directed to a lithium-ion battery. In some embodiments, the lithium-ion battery comprises an anode current collector, a cathode current collector, any one of the foregoing battery electrodes configured as an anode disposed on or in the anode current collector, a cathode disposed on or in the cathode current collector, and an electrolyte ionically coupling the anode and the cathode.

Yet another aspect is directed to a process of making a battery electrode, comprising stages (A1), (A2), and (A3). Stage (A1) comprises providing any of the foregoing battery electrode compositions. Stage (A2) comprises making a slurry comprising the battery electrode composition and a binder. Stage (A3) comprises casting the slurry on or in a current collector to form the battery electrode, which may optionally include densification (calendering) operation, namely densifying the battery electrode to a desired value. The casting of the slurry may also include evaporating the slurry solvent. In some embodiments, a coating density of the battery electrode (e.g., an anode comprising nanocomposite Si—C particles) is in a range of about 0.8 to about 1.5 g/cm³ (in some designs, from about 0.8 to about 0.9 g/cm³; in other designs, from about 0.9 to about 1.0 g/cm³; in other designs, from about 1.0 to about 1.2 g/cm³; in other designs, from about 1.2 to about 1.5 g/cm³; in yet other designs, from about 0.9 to about 1.6 g/cm³; in yet other designs, from about 0.9 to about 1.2 g/cm³). In some embodiments, a coating density may be within a range of about 0.9 to about 1.7 g/cm³. In some embodiments, the battery electrode comprises a carbon-comprising functional additive. In some implementations, the carbon-comprising functional additive may be selected from: carbon nanotubes (SWCNT or MWCNT or both), carbon nanofibers, carbon black, graphite, exfoliated graphite, and graphene. In some embodiments, a mass fraction of the binder in the battery electrode is in a range of about 7 wt. % to about 10 wt. %. The battery electrode may be characterized by an areal binder loading, defined as a mass fraction of the binder in the battery electrode, divided by a product of (1) a mass fraction of the jagged composite particles in the battery electrode, and (2) a Brunauer-Emmett-Teller (BET) specific surface area of the population. In some embodiments, an areal binder loading of the battery electrode (e.g., anode comprising Si—C nanocomposite particles) is in a range of about 2.0 mg/m² to about 15.0 mg/m² (e.g. in some designs, from about 2.0 mg/m² to about 5.0 mg/m²; in other designs, from about 5.0 mg/m² to about 9.0 mg/m²; in yet other designs, from about 9.0 mg/m² to about 13.0 mg/m²).

Yet another aspect is directed to a process of making a lithium-ion battery, comprising stages (B1), (B2), and (B3). Stage (B1) comprises making a battery electrode according to any one of the foregoing processes of making a battery electrode, with the battery electrode being configured as an anode and the current collector being configured as the anode current collector. Stage (B2) comprises making or providing a cathode disposed on or in a cathode current collector. Stage (B3) comprises assembling a battery cell from the anode and the cathode (and, in some designs, a porous separator membrane or a porous separator layer(s) in between) and filling a space between the anode and the cathode with an electrolyte ionically coupling the anode and the cathode to form the lithium-ion battery.

Yet another aspect is directed to a process of making a lithium-ion battery, comprising stages (C1), (C2), and (C3). Stage (C1) comprises providing any of the foregoing battery electrodes, with the battery electrode being configured as an anode and the current collector being configured as the anode current collector. Stage (C2) comprises making or providing a cathode disposed on or in a cathode current collector. Stage (C3) comprises assembling a battery cell from the anode and the cathode (and, in some designs, a porous separator membrane or a porous separator layer(s) in between) and filling a space between the anode and the cathode with an electrolyte ionically coupling the anode and the cathode to form the lithium-ion battery.

In an aspect, a battery electrode composition includes a population of jagged composite particles, each of the jagged composite particles comprising silicon and carbon; wherein: 90% or more of the jagged composite particles in the population are characterized by aspect ratios of 2.3 or less; 50% or more of the jagged composite particles in the population are characterized by aspect ratios of 1.25 or more; and the population is characterized by a particle size distribution (PSD) as determined by laser particle size distribution analysis (LPSA) such that: a fiftieth-percentile volume-weighted particle size parameter D₅₀ of the PSD is in a range of about 2.0 to about 8.0 μm.

In some aspects, about 90% or more of the jagged composite particles in the population are characterized by aspect ratios of about 2.1 or less.

In some aspects, about 50% or more of the jagged composite particles in the population are characterized by aspect ratios of about 1.35 or more.

In some aspects, about 10% or more of the jagged composite particles in the population are characterized by aspect ratios of about 1.3 or less.

In some aspects, a mass fraction of the silicon in the jagged composite particles is in a range of about 3 wt. % to about 80 wt. %.

In some aspects, the mass fraction of the silicon is in a range of about 35 wt. % to about 70 wt. %.

In some aspects, the mass fraction of the silicon is in a range of about 35 wt. % to about 50 wt. %.

In some aspects, the mass fraction of the silicon is in a range of about 40 wt. % to about 55 wt. %.

In some aspects, a Brunauer-Emmett-Teller (BET) specific surface area of the population is in a range of about 3 m²/g to about 18 m²/g.

In some aspects, the D₅₀ is in a range of about 2.0 to about 4.0 μm.

In some aspects, a cumulative volume fraction, defined as a cumulative volume of the jagged composite particles with particle sizes of about 4.6 μm or less, divided by a total volume of all of the jagged composite particles, is about 90 vol. % or less; and the particle sizes, the cumulative volume, and the total volume are estimated by the LPSA.

In some aspects, the cumulative volume fraction is about 85 vol. % or less.

In some aspects, the cumulative volume fraction is about 80 vol. % or less.

In some aspects, the D₅₀ is in a range of about 6.0 to about 8.0 μm.

In some aspects, a Brunauer-Emmett-Teller (BET) specific surface area of the population is in a range of about 3 m²/g to about 12 m²/g.

In an aspect, a battery electrode includes the battery electrode composition of claim 1 disposed on or in a current collector, wherein: the battery electrode comprises a binder.

In some aspects, a coating density of the battery electrode is in a range of about 0.9 to about 1.0 g/cm³.

In some aspects, the battery electrode additionally comprises a carbon-comprising functional additive.

In some aspects, the carbon-comprising functional additive is selected from: carbon nanotubes, carbon nanofibers, carbon black, graphite, exfoliated graphite, graphene oxide, and graphene.

In some aspects, the D₅₀ of the PSD of the population is in a range of about 6.0 to about 8.0 μm; and a mass fraction of the binder in the battery electrode is in a range of about 7 wt. % to about 10 wt. %.

In some aspects, the D₅₀ of the PSD of the population is in a range of about 6.0 to about 8.0 μm; and an areal binder loading of the battery electrode is in a range of about 9.0 mg/m² to about 13.0 mg/m², the areal binder loading being defined as a mass fraction of the binder in the battery electrode, divided by a product of (1) a mass fraction of the jagged composite particles in the battery electrode, and (2) a Brunauer-Emmett-Teller (BET) specific surface area of the population.

In an aspect, a lithium-ion battery includes an anode current collector; a cathode current collector; the battery electrode configured as an anode, the current collector thereof being configured as the anode current collector; a cathode disposed on or in the cathode current collector; and an electrolyte ionically coupling the anode and the cathode.

In an aspect, a method of making a battery electrode includes (A1) providing the battery electrode composition; (A2) making a slurry comprising the battery electrode composition and a binder; and (A3) casting the slurry on or in a current collector to form the battery electrode (note in some designs, this stage may often include evaporating the slurry solvent and/or densifying the battery electrode to a desired value).

In an aspect, a method of making a lithium-ion battery includes (B1) making the battery electrode according to the method of (A1), (A2) and (A3), the battery electrode being configured as an anode and the current collector being configured as an anode current collector; (B2) making or providing a cathode disposed on or in a cathode current collector; and (B3) assembling a battery cell from the anode and the cathode (and, in some designs, a porous separator membrane or a porous separator layer(s) in between) and filling a space between the anode and the cathode with an electrolyte ionically coupling the anode and the cathode to form the lithium-ion battery.

In an aspect, a method of making a lithium-ion battery includes (C1) providing the battery electrode, the battery electrode being configured as an anode and the current collector being configured as an anode current collector; (C2) making or providing a cathode disposed on or in a cathode current collector; and (C3) assembling a battery cell from the anode and the cathode (and, in some designs, a porous separator membrane or a porous separator layer(s) in between) and filling a space between the anode and the cathode with an electrolyte ionically coupling the anode and the cathode to form the lithium-ion battery.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw contrast between different components, elements, features, etc., and are not meant to convey the use of particular materials, colors, or other properties that may be defined outside of the present disclosure for the specific pattern employed.

FIG. 1 illustrates an example Li-ion battery in which the components, materials, processes, and other techniques described herein may be implemented.

FIG. 2 is a flow diagram of a process of making a Li-ion rechargeable battery cell in accordance with certain embodiments.

FIG. 3 is a flow diagram of a process of making anode (or cathode) particles in accordance with certain embodiments including carrying out an activation process on carbon particles.

FIG. 4 shows a schematic illustration of a jagged particle 400 and a graphical plot 420 of a dependence of cumulative particle number distributions of jagged composite particles on the aspect ratios of the jagged composite particles.

FIG. 5 shows an SEM image (502) of jagged composite particles taken from a population with D₅₀ of about 2.5 μm and an SEM image (504) of jagged composite particles taken from a population with D₅₀ of about 7 μm.

FIG. 6 shows an SEM image 602 of jagged composite particles taken from a population with D₅₀ of about 9 μm and an SEM image 604 of jagged composite particles taken from a population with D₅₀ of about 14 μm.

FIG. 7 shows a graphical plot 702 of a dependence of a full width D₉₀-D₁₀ on D₅₀ of each of the example jagged composite particle populations and a graphical plot 704 of a dependence of mass fraction of silicon in the composite particles on D₅₀ of each of the example particle populations.

FIG. 8 shows SEM images (802, 804) of cross sections of electrode coatings comprising a jagged composite particle population sample of D₅₀ of about 4 μm and a jagged composite particle population sample of D₅₀ of about 14 μm, respectively.

FIG. 9 shows a graphical plot 902 of a dependence of a cycle life on D₅₀ of each of the example particle populations and a graphical plot 904 of a dependence of a normalized coating thickness change on D₅₀ of each of the example particle populations.

FIG. 10 shows a graphical plot 1002 of a dependence of a volumetric energy density on D₅₀ of each of the example jagged composite particle populations and a graphical plot 1004 of a dependence of a volumetric charge density on D₅₀ of each of the example particle populations.

FIG. 11 shows a graphical plot 1102 of a dependence of a normalized high-rate discharge capacity density on D₅₀ of each of the example jagged composite particle populations and a graphical plot 1104 of a dependence of a discharge voltage on D₅₀ of each of the example particle populations.

FIG. 12 shows a graphical plot 1202 of a dependence of a normalized capacity (expressed as a fraction of a reference capacity) as a function of charge rate (charge C-rate) for lithium-ion battery test cells comprising jagged composite particle populations of D₅₀ of about 3 μm and about 5 μm.

FIG. 13 shows a graphical plot 1302 of a dependence of a first-cycle efficiency on D₅₀ of each of the example particle populations and a graphical plot 1304 of a dependence of a formation efficiency on D₅₀ of each of the example particle populations.

FIG. 14 shows a graphical plot 1402 of a dependence of an internal resistance on D₅₀ of each of the example jagged composite particle populations and a graphical plot 1404 of a dependence of a coating density on D₅₀ of each of the example particle populations.

FIG. 15 shows a graphical plot 1502 of a dependence of a Brunauer-Emmett-Teller specific surface area (BET-SSA) on D₅₀ of each of the example jagged composite particle populations and a graphical plot 1504 of a dependence of an areal binder loading on D₅₀ of each of the example particle populations.

FIG. 16 shows a graphical plot 1602 showing the relationship between cycle life values and cumulative volume fractions (D₅₀ threshold of 4.6 μm) for jagged composite particle populations with D₅₀ values in a range of about 2.0 μm to about 4.0 μm. The cumulative volume fraction is defined as a cumulative volume of particles with D₅₀ values of a threshold D₅₀ value or less, divided by a total volume of all the particles.

FIG. 17 shows a graphical plot 1702 of a dependence of an areal binder loading on binder mass fraction of each test cell. The test cells comprised jagged composite particle populations with D₅₀ values of about 7.42 μm. The control sample test cell comprised a particle population with a D₅₀ value of about 5.35 μm.

FIG. 18 shows a graphical plot 1802 of a dependence of a cycle life on binder mass fraction of each of the test cells of FIG. 17 and a graphical plot 1804 of a dependence of a normalized coating thickness change on binder mass fraction of each of the test cells of FIG. 17.

FIG. 19 shows a graphical plot 1902 of a dependence of a volumetric energy density (VED) on binder mass fraction of each of the test cells of FIG. 17 and a graphical plot 1904 of a dependence of a volumetric charge density (VQD) on binder mass fraction of each of the test cells of FIG. 17.

FIG. 20 shows a graphical plot 2002 of a dependence of a discharge voltage on binder mass fraction of each of the test cells of FIG. 17 and a graphical plot 2004 of a dependence of an internal resistance on binder mass fraction of each of the test cells of FIG. 17.

FIG. 21 shows a graphical plot 2102 of a dependence of a formation efficiency on binder mass fraction of each of the test cells of FIG. 17 and a graphical plot 2104 of a dependence of a first-cycle efficiency on binder mass fraction of each of the test cells of FIG. 17.

FIG. 22 shows an SEM image (2201) of a population of jagged composite particles (including agglomerates of jagged particles), without any optimization of the population's particle size distribution (PSD) and an SEM image (2202) of a cross section of an electrode coating comprising a mixture of the population of jagged particles shown in 2201 and graphite particles as the electrode active material. The D₅₀ of the population is about 10 μm and the population comprises fine particles (“fines”) and coarse particles.

FIG. 23 shows an SEM image (2301) of a population of jagged composite particles, after optimization of the population's particle size distribution (PSD), and an SEM image (2302) of a cross section of an electrode coating comprising a mixture of the jagged particles shown in 2301 and graphite particles. Before undergoing optimization of its PSD, the population had a D₅₀ of about 10 μm. The PSD optimization process included removal of fine particles (the removed fine particles exhibited a D₅₀ of about 1.5 μm) and removal of coarse particles (the removed coarse particles exhibited a D₅₀ of about 15 μm.

FIG. 24 shows graphical plots 2401 and 2402 of volume-weighted particle size distributions (PSDs) of example populations of jagged composite particles. Graphical plot 2401 shows the PSDs of example populations of respective D₅₀ values exhibiting relatively broad PSDs, before any optimization of the respective PSDs. Graphical plot 2402 shows (1) the PSD of an example population before any optimization of its PSD (D₅₀ of about 10.1 μm) and (2) the PSD of an example population after optimization of its PSD (D₅₀ of about 9.8 μm). The PSD optimization includes removal of fine particles and removal of coarse particles. As a result of these PSD optimization processes, the PSD has changes from a relatively broader PSD (e.g., greater span, greater FWHM) to a relatively narrower PSD (e.g., smaller span, smaller FWHM).

FIG. 25 shows a Table 1 tabulating selected characteristics (D₁₀, D₅₀, D₉₀, D₉₉, span, FWHM, D₁₀/D₅₀, BET-SSA, and whether the population has not undergone any optimization of its PSD (so-called “broad” PSD) or has undergone optimization of its PSD (so-called “narrow” PSD)) of example populations of jagged composite particles, and selected characteristics (estimated capacity of electrode active material comprising the respective jagged composite particles and graphite particles, electrode coating density, and cycle life) of electrode coatings and battery cells derived from the respective example populations of jagged composite particles.

FIG. 26 shows an SEM image (2601) of a population of spheroidal composite particles. In the example shown, the D₅₀ value of the population is in a range of about 5 to about 7 μm.

FIG. 27 shows a graphical plot 2701 showing the dependence of the BET-SSA values of example populations of composite particles (jagged composite particles before PSD optimization (exhibiting so-called “broad” PSDs), jagged composite particles after PSD optimization (exhibiting so-called “narrow” PSDs), and spheroidal particles) on their respective D₅₀ values. In the example shown, the D₅₀ values were measured by LPSA.

FIG. 28 shows graphical plots 2802, 2804, and 2806 of selected PSD characteristics of example populations of jagged composite particles. Graphical plot 2802 shows the dependence of D₉₉ values on D₅₀ values of respective populations of jagged composite particles, illustrating trends among populations that have not undergone PSD optimization (so-called “broad” PSDs) and populations that have undergone PSD optimization (so-called “narrow” PSDs). Graphical plot 2804 shows the dependence of Doo values on D₅₀ values of respective populations of jagged composite particles, illustrating trends among populations that have not undergone PSD optimization (so-called “broad” PSDs) and populations that have undergone PSD optimization (so-called “narrow” PSDs). Graphical plot 2806 shows the dependence of D₁₀ values on D₅₀ values of respective populations of jagged composite particles, illustrating trends among populations that have not undergone PSD optimization (so-called “broad” PSDs) and populations that have undergone PSD optimization (so-called “narrow” PSDs).

FIG. 29 shows graphical plots 2901 and 2902 showing the dependence of cycle life performance of Li-ion batteries made using respective example populations of jagged composite particles on the D₅₀ values of the respective example populations. Graphical plots 2901 and 2901 illustrate trends among populations that have not undergone PSD optimization (so-called “broad” PSDs) and populations that have undergone PSD optimization (so-called “narrow” PSDs). In the examples shown, the Li-ion batteries employed anodes comprising a mixture of the jagged composite particles and graphite particles (“active material mixtures”). Graphical plot 2901 shows cycle life performance of Li-ion batteries employing active material mixtures exhibiting a Li-ion capacity of about 600 mAh/g. Graphical plot 2902 shows cycle life performance of Li-ion batteries employing active material mixtures exhibiting a Li-ion capacity of about 1000 mAh/g.

FIG. 30 shows graphical plots 3002, 3004, 3006, and 3008 showing the dependence of selected PSD characteristics of example populations of jagged composite particles on the D₅₀ values of the example populations. In the examples shown in FIG. 30, the PSDs of the respective populations were modified by comminution (either jet milling or ball milling). Graphical plots 3002, 3004, 3006, and 3008 illustrate trends among populations that have undergone ball milling and populations that have undergone jet milling. The PSD characteristics shown are span for 3002, D₉₀ for 3004, D₁₀ for 3006, and volume fraction of fine particles (defined as particles with diameters of 1 μm and below as measured by LPSA) in the population for 3008.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternate embodiments may be devised without departing from the scope of the invention. Additionally, well-known elements of the invention may not be described in detail or may be omitted so as not to obscure other, more relevant details.

Aspects of the present disclosure provide for processes of making advanced carbon-containing (e.g., mostly graphitic, sp²-bonded carbon-containing) composite particles for use in electrodes (e.g., anode electrodes or cathode electrodes) of Li-ion or Na-ion or K-ion rechargeable batteries, among other types of batteries, electrochemical capacitors and hybrid electrochemical energy storage devices.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about—120° C. to about—60° C. encompasses (in ° C.) a set of temperature ranges from about—120° C. to about—119° C., from about—119° C. to about—118° C., . . . from about—61° C. to about—60° C., as if the intervening numbers (in ° C.) between—120° C. and—60° C. in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range. In yet another example, a numerical range with upper and lower bounds defined at different levels of precision shall be interpreted in increments corresponding to the bound with the higher level of precision. For example, a numerical percentage range from 30.92% to 47.4% (i.e., levels of precision in units or increments of hundredths and tenths, respectively) encompasses (in %) a set of [30.92, 30.93, 30.94, . . . , 47.39, 47.40], as if 47.4% (tenths) was recited as 47.40% (hundredths) and as if the intervening numbers between 30.92 and 47.40 in units or increments of hundredths were expressly disclosed.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about”, “approximately”, “around”, “≈” or “˜” 80%, which encompasses “exactly” 80% (e.g., 80.0000 . . . %) plus some range around 80%. In some designs, the range encompassed around a measurement or threshold via the “about”, “approximately”, “around” or “˜” qualifier may encompass the level of precision for which the respective measurement or threshold is capable of being measured by the most accurate commercially available instrumentation as of the priority date of the subject application.

While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, alkaline batteries, flow batteries, etc.) as well as electrochemical capacitors and hybrid energy storage devices.

While the description below may describe certain examples in the context of composites comprising alloying-type anode active materials (such as Si, Sn, Sb, Al, among others), it will be appreciated that various aspects may be applicable to conversion-type anode and cathode active materials, intercalation-type anode and cathode active materials, pseudocapacitive anode and cathode active materials, and materials that may exhibit mixed electrochemical energy storage mechanisms. Note that high-capacity alloying-type (conversion-type) anode material choice may be different for Na and Na-ion, Mg and Mg-ion, K and K-ion, Ca and Ca-ion and Li or Li-ion. For example, while Si may be a preferred alloying-type material for Li or Li-ion batteries, Sn or Sb or Sn- or Sb-comprising alloys may be preferred alloying-type material(s) for Na or Na-ion batteries.

While the description below may also describe certain examples of the material formulations in a Li-free state (for example, as in silicon-comprising nanocomposite anodes or metal fluoride cathodes), it will be appreciated that various aspects may be applicable to Li-comprising electrodes and active materials (for example, partially or fully lithiated Si-comprising anodes or partially or fully lithiated Si-comprising anode particles, partially or fully lithiated metal fluoride comprising cathodes (such as a mixture of LiF and metals such as Cu, Fe, Ni, Bi, and various other metals and metal alloys and mixtures of such and other metals, etc.) or partially or fully lithiated metal halide comprising cathode particles, partially or fully lithiated chalcogenides (such as Li₂S, Li₂S/metal mixtures, Li₂Se, Li₂Se/metal mixtures, Li₂S—Li₂Se mixtures, various other compositions comprising lithiated chalcogenides etc.), partially or fully lithiated metal oxides (such as Li₂O, Li₂O/metal mixtures, etc.), partially or fully lithiated carbons, among others). In some designs, various material properties (e.g., at particle level, at inter-particle level, at electrode level, etc.) may change based on whether active material particle(s) are in a Li-free state, a partially lithiated state, or a fully lithiated state. Such Li-dependent material properties may include particle pore volume, electrode pore volume, and so on. Below, unless stated or implied otherwise, reference to such Li-dependent material properties (e.g., at particle level, at inter-particle level, at electrode level, etc.) may be assumed to be provided as if the active material particles are in the Li-free state. Further, some examples below are characterized at the electrode level (e.g., as opposed to particle level or interparticle level or cell level, etc.). Below, unless stated or implied otherwise, reference to such electrode level properties (e.g., electrode porosity or areal capacity loading or gravimetric/volumetric capacity, etc.) may be assumed to refer to the electrode components (e.g., active material particles, binder, conductive additives, etc.), excluding the current collector.

In the following description, various material properties are described so as to characterize materials (e.g., molecules, particles, powders, slurries, electrodes, separators, electrolytes, battery cells, etc.) in various states. Note that one of ordinary skill in the art is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types such as precursor particles (e.g., carbon particles, etc.). Hence, unless otherwise indicated, the following Table provides examples of how such material properties may be readily measured by one of ordinary skill in the art using commercially available instrumentation:

Table of Techniques and Instrumentation for Material Property Measurements

| Material | | Measurement | |
|---|---|---|---|
| Type | Property Type | Instrumentation | Measurement Technique |
| Active | Coulombic | Potentiostat | Charge (current) is passed to |
| Material | Efficiency | | an electrode containing the |
| | | | active material of interest until |
| | | | a given voltage limit is |
| | | | reached. Then, the current is |
| | | | reversed (discharge current) |
| | | | until a second voltage limit is |
| | | | reached. The ratio of the two |
| | | | charges passed determines the |
| | | | Coulombic Efficiency (CE). In |
| | | | the simplest case, the charge |
| | | | and discharge currents may be |
| | | | constant and often have |
| | | | absolute values that are the |
| | | | same or close to each other. It |
| | | | should be understood though |
| | | | that in some experiments, |
| | | | either charge current or |
| | | | discharge current or both may |
| | | | be changing during such |
| | | | experiments (e.g., be initially |
| | | | constant and when the voltage |
| | | | limit is reached, diminishing to |
| | | | a predetermined value). In |
| | | | addition, the absolute value of |
| | | | the charge and discharge |
| | | | currents may differ. |
| Active | Partial Vapor | Manometer | The partial vapor pressure of |
| Material | Pressure (e.g., | | an active material in a mixture |
| | Torr.) at a | | (e.g., composite particle) at a |
| | Temperature | | particular temperature is given |
| | (e.g., K) | | by the known vapor pressure |
| | | | of the active material |
| | | | multiplied by its mole fraction |
| | | | in the mixture. |
| Active | Volume | Gas pycnometer | Gas pycnometer measures the |
| Material | | | skeletal volume of a material |
| Particle | | | by gas displacement using the |
| | | | volume-pressure relationship |
| | | | of Boyle's Law. A sample of |
| | | | known mass is placed into the |
| | | | sample chamber and |
| | | | maintained at a constant |
| | | | temperature. An inert gas, |
| | | | typically helium, is used as the |
| | | | displacement medium. |
| | | | Note: A vol. % change may be |
| | | | calculated from two volume |
| | | | measurements of the active |
| | | | material particle. |
| Active | Open Internal | nitrogen | Nitrogen sorption/desorption |
| Material | Pore Volume | sorption/desorption | isotherm (typically at 77 K) is |
| Particle | (e.g., cc/g or | isotherm | collected and analyzed to |
| | cm³/g) | | estimate the total amount of |
| | | | gas adsorbed/desorbed and |
| | | | internal pore volume of the |
| | | | sample with known mass is |
| | | | estimated from such |
| | | | measurements. Pore size |
| | | | distribution (PSD) may be |
| | | | further estimated from the |
| | | | sorption/desorption isotherm |
| | | | using various analyses, such as |
| | | | Non-Local Density Functional |
| | | | Theory (NLDFT) |
| Active | Volume- | PSA, scanning | PSA using laser scattering, |
| Material | Average Pore | electron microscope | electron microscopy (SEM, |
| Particle | Size and Pore | (SEM), transmission | TEM, STEM) in combination |
| | Size | electron microscope | with image analyses, laser |
| | Distributions | (TEM), scanning | microscopy (for larger |
| | (e.g., nm) | transmission | particles and larger pores) in |
| | | microscope (STEM), | combination with image |
| | | laser microscope, | analyses, optical microscopy |
| | | Synchrotron X-ray, | (for larger particles and larger |
| | | X-ray microscope | pores), neutron scattering, X- |
| | | | ray scattering, X-ray |
| | | | microscopy imaging may be |
| | | | employed to measure pore |
| | | | sizes (average pore size or |
| | | | pore size distribution) in |
| | | | different size ranges (in |
| | | | addition to the analysis of the |
| | | | sorption/desorption isotherms). |
| Active | Closed | Gas pycnometer | Closed porosity may be |
| Material | Internal Pore | | measured by analyzing true |
| Particle | Volume (e.g., | | density values measured by |
| | cc/g or cm³/g) | | using an argon gas pycnometer |
| | | | and comparing them to the |
| | | | theoretical density of the |
| | | | individual material |
| | | | components present in Si- |
| | | | comprising particles. In |
| | | | addition, closed internal pore |
| | | | volume may be estimated by |
| | | | comparing the total pore |
| | | | volume estimated from |
| | | | neutron scattering and the |
| | | | nitrogen-accessible pore |
| | | | volume estimated from |
| | | | nitrogen sorption isotherms. |
| Active | Closed | Gas pycnometer | With a pycnometer, the |
| Material | Internal | | amount of a certain medium |
| Particle | Volume- | | (liquid or Helium or other |
| | Average Size | | analytical gases) displaced by |
| | (e.g., nm) | | a solid can be determined. |
| Active | Size | TEM, STEM, SEM, | Laser particle size distribution |
| Material | (e.g., nm, μm, | X-Ray, PSA, etc. | analysis (LPSA), laser image |
| Particle | etc.) | | analysis, electron microscopy, |
| | | | optical microscopy or other |
| | | | suitable techniques |
| | | | transmission electron |
| | | | microscopy (TEM), scanning |
| | | | transmission electron |
| | | | microscopy (STEM), scanning |
| | | | electron microscopy (SEM)), |
| | | | X-ray microscopy, X-ray |
| | | | diffraction, neutron scattering |
| | | | and other suitable techniques |
| Active | Composition | Balance | Note #1: A wt. % change may |
| Material | (e.g., mass | | be calculated by comparing the |
| Particle | fraction or wt. | | mass fraction of a material in |
| | %, mg, | | the particle relative to the total |
| | number of | | particle mass. |
| | atoms, etc.) | | Note #2: The capacity |
| | | | attributable to particular active |
| | | | material(s) in the particle may |
| | | | be derived from the |
| | | | composition, based on the |
| | | | known (e.g., theoretical or |
| | | | practically attainable) |
| | | | capacity(ies) of each active |
| | | | material. |
| | | | Note #3: The composition of |
| | | | the particle may be |
| | | | characterized in terms of |
| | | | weight (e.g., mg). The |
| | | | composition of may |
| | | | alternatively be characterized |
| | | | by a number of atoms of a |
| | | | particular element (e.g., Fe, F, |
| | | | C, etc.). In case of atoms, the |
| | | | number of atoms may be |
| | | | estimated from the weight of |
| | | | that atom in the particle (e.g., |
| | | | based on gas chromatography) |
| Active | Composition | X-ray Fluorescence | |
| Material | (e.g., mass | (XRF), Inductively | |
| Particle | fraction or wt. | Coupled Plasma | |
| | % of various | Optical Emission | |
| | atomic | Spectroscopy (ICP- | |
| | elements or | OES); Energy | |
| | molecules, | Dispersive | |
| | atomic | Spectroscopy (EDS), | |
| | fraction or at. | Wavelength | |
| | % of various | Dispersive | |
| | elements, etc.) | Spectroscopy (WDS), | |
| | | Electron Energy Loss | |
| | | Spectroscopy (EELS), | |
| | | Nuclear Magnetic | |
| | | Resonance (NMR); | |
| | | Secondary Ion Mass | |
| | | Spectrometry (SIMS); | |
| | | X-Ray Photoelectron | |
| | | Spectroscopy (XPS); | |
| | | Fourier Transform | |
| | | Infrared Spectroscopy | |
| | | (FTIR) and Raman | |
| | | Spectroscopy | |
| | | (Raman) | |
| Active | Specific | Potentiostat | An electrode containing an |
| Material | Capacity | | active anode or cathode |
| Particle, | | | material of interest is charged |
| Battery Half- | | | or discharged (by passing |
| Cell | | | electrical current to the |
| | | | electrode) within certain |
| | | | potential limits using an |
| | | | electrochemical cell with a |
| | | | suitable reference electrode, |
| | | | typically lithium metal. The |
| | | | total charge passed (e.g., in |
| | | | mAh) divided by the active |
| | | | material mass (e.g., in g) gives |
| | | | this quantity (e.g., in mAh/g). |
| | | | The active mass is computed |
| | | | by multiplying the total mass |
| | | | of the electrode by the active |
| | | | material mass fraction. Both |
| | | | reversible and irreversible |
| | | | capacity during charge or |
| | | | discharge may be calculated in |
| | | | this way. |
| Active | BET SSA | BET instrument | A sample is placed into a |
| Material | (e.g., m²/g) | | sealed chamber at 77 K, where |
| Particle | | | nitrogen is introduced at |
| | | | increasing pressure. The |
| | | | change in pressure of the |
| | | | nitrogen is used to calculate |
| | | | the surface area of the sample. |
| Active | Aspect Ratio | SEM, TEM | The dimensions and shape of |
| Material | | | the particles are typically |
| Particle | | | measured by using SEM or |
| | | | TEM or (for large particles) by |
| | | | using optical microscopy. |
| Active | True Density | Argon Gas | True density values may be |
| Material | of Particle | Pycnometer | measured by using an argon |
| Particle | (e.g., g/cc or | | gas pycnometer and |
| | g/cm³) | | comparing to the theoretical |
| | | | density of the individual |
| | | | material components present |
| | | | in the particle. |
| Active | Particle Size | Dynamic light | laser particle size distribution |
| Material | Distribution | scattering particle size | analysis (LPSA) on well- |
| Particle | (e.g., nm or | analyzer, scanning | dispersed particle suspensions |
| Population | μm) | electron microscope | in one example or by image |
| | | | analysis of electron |
| | | | microscopy images, or by |
| | | | other suitable techniques. |
| | | | While there are diverse |
| | | | processes of measuring PSDs, |
| | | | laser particle size distribution |
| | | | analysis (LPSA) is quite |
| | | | efficient for some applications. |
| | | | Note that other types of |
| | | | particle size distribution (e.g., |
| | | | by SEM image analysis) could |
| | | | also be utilized (and may even |
| | | | lead to more precise |
| | | | measurements, in some |
| | | | experiments). Using LPSA, |
| | | | particle size parameters of a |
| | | | population's PSD may be |
| | | | measured, such as: a tenth- |
| | | | percentile volume-weighted |
| | | | particle size parameter (e.g., |
| | | | abbreviated as D10), a fiftieth- |
| | | | percentile volume-weighted |
| | | | particle size parameter (e.g., |
| | | | abbreviated as D50), a |
| | | | ninetieth-percentile volume- |
| | | | weighted particle size |
| | | | parameter (e.g., abbreviated as |
| | | | D90), and a ninety-ninth- |
| | | | percentile volume-weighted |
| | | | particle size parameter (e.g., |
| | | | abbreviated as D99). |
| Active | Width (e.g., | PSA | Parameters relating to |
| Material | nm) | | characteristic widths of the |
| Particle | | | PSD may be derived from |
| Population | | | these particle size parameters, |
| | | | such as D50 − D10 (sometimes |
| | | | referred to herein as a left |
| | | | width), D90 − D50 (sometimes |
| | | | referred to herein as a right |
| | | | width), and D90 − D10 |
| | | | (sometimes referred to herein |
| | | | as a full width). |
| Active | Cumulative | Computed via LPSA | A cumulative volume fraction, |
| Material | Volume | data | defined as a cumulative |
| Particle | Fraction | | volume of the composite |
| Population | | | particles with particle sizes of |
| | | | a threshold particle size or |
| | | | less, divided by a total volume |
| | | | of all of the composite |
| | | | particles, may be estimated by |
| | | | LPSA. |
| Active | Composition | Balance | The mass of active materials |
| Material | (e.g., wt. %) | | added to the electrode divided |
| Particle | | | by the total mass of the |
| Population | | | electrode. |
| Active | BET SSA | BET Isotherm | obtained from the data of |
| Material | (e.g., m²/g) | | nitrogen sorption-desorption at |
| Particle | | | cryogenic temperatures, such |
| Population | | | as about 77 K |
| Electrolyte | Salt | balance, volumetric | Total volume of the solution is |
| | Concentration | pipette | computed either via the sum of |
| | (e.g., M or | | the volume of the constituents |
| | mol. %) | | (measured by a volumetric |
| | | | pipette), or by the mass of the |
| | | | constituents divided by the |
| | | | density. The molar mass of the |
| | | | salt is then used to calculate |
| | | | the total number of moles of |
| | | | salt in the solution. The moles |
| | | | of salt is then divided by the |
| | | | total volume to obtain the |
| | | | solvent concentration in M |
| | | | (mol/L). |
| Electrolyte | Solvent | balance, volumetric | Total volume of the solution is |
| | Concentration | pipette | computed either via the sum of |
| | (e.g., M or | | the volume of the constituents |
| | mol. %) | | (measured by a volumetric |
| | | | pipette), or by the mass of the |
| | | | constituents divided by the |
| | | | density. The molar volume of |
| | | | each solvent is then used to |
| | | | calculate the total number of |
| | | | moles of solvent in the |
| | | | solution. The moles of solvent |
| | | | is then divided by the total |
| | | | volume to obtain the solvent |
| | | | concentration in M (mol/L). |
| Electrode | Composition | Balance | The mass fraction of a material |
| | (e.g., mass | | (e.g., active material, active |
| | fraction or wt. | | material particle, binder, etc.) |
| | %) | | in the electrode is calculated |
| | | | based on a measured or |
| | | | estimated mass of the material |
| | | | and a measured or estimated |
| | | | mass of the electrode, |
| | | | excluding the electrode current |
| | | | collector. |
| | | | Note: The mass of individual |
| | | | components (e.g., composite |
| | | | active material particles, |
| | | | graphite particles, binder, |
| | | | function additive(s), etc.) of |
| | | | the battery electrode |
| | | | composition may be measured |
| | | | before being mixed into a |
| | | | slurry to estimate their mass in |
| | | | a casted electrode. The mass of |
| | | | materials deposited onto the |
| | | | casted electrode may be |
| | | | measured by comparing the |
| | | | weight of the casted electrode |
| | | | before/after the material |
| | | | deposition. |
| Electrode | Areal Binder | balance | A mass fraction of the binder |
| | Loading (e.g., | | in the battery electrode, |
| | mg/m²) | | divided by a product of (1) a |
| | | | mass fraction of the active |
| | | | material (e.g., Si—C |
| | | | nanocomposite, etc.) particles |
| | | | in the battery electrode, and |
| | | | (2) a Brunauer-Emmett-Teller |
| | | | (BET) specific surface area of |
| | | | the active material particle |
| | | | population. |
| Electrode | Capacity | Calculated | Measure the mass (wt.) of |
| | Attributable to | | active material in the |
| | Active | | electrode, and calculate |
| | Material | | electrode capacity based on the |
| | (active | | known theoretical capacity of |
| | material | | the active material. For |
| | capacity | | example, the average wt. % of |
| | fraction) | | active material in each active |
| | | | material particle may be |
| | | | measured and used to calculate |
| | | | the mass of the active material |
| | | | based on the mass of the active |
| | | | material particles before being |
| | | | mixed in the slurry. This |
| | | | process may be repeated if the |
| | | | electrode includes two or more |
| | | | active materials to calculate |
| | | | the relative capacity attribution |
| | | | for each active material in the |
| | | | electrode. |
| Electrode | Capacity | Potentiostat and | Determine the average specific |
| | Attributable to | balance | capacity (mAh/g) of active |
| | Active | | material particles. For |
| | Material | | example, the average specific |
| | Particles | | capacity may be estimated |
| | (active | | from the average wt. % of |
| | material | | active material(s) in each |
| | particle | | particle and its associated |
| | capacity | | known theoretical |
| | fraction) | | capacity(ies). Then, measure |
| | | | the mass (wt.) of active |
| | | | material particles in the |
| | | | electrode before being mixed |
| | | | in slurry, which may be used |
| | | | to calculate the capacity |
| | | | attributable to that active |
| | | | material. This process may be |
| | | | repeated if the electrode |
| | | | includes two or more active |
| | | | material particle types to |
| | | | calculate the relative capacity |
| | | | attribution for each active |
| | | | material particle type in the |
| | | | electrode. |
| Electrode | Mass of | balance | The average wt. % of active |
| | Active | | material in each active |
| | Material in | | material particle may be |
| | Electrode | | measured, and used to |
| | | | calculate the mass of the active |
| | | | material based on the mass of |
| | | | the active material particles |
| | | | before being mixed in slurry. |
| Electrode | Mass of | balance | Measure the active material |
| | Active | | particle before the active |
| | Material | | material particle type is mixed |
| | Particle in | | in the slurry. |
| | Electrode | | |
| Electrode | Areal | Potentiostat and | Areal capacity loading is the |
| | Capacity | balance | weight of the coated active |
| | Loading (e.g., | | material per unit area (g/cm²) |
| | mAh/cm²) | | multiplied by the gravimetric |
| | | | capacity of the active material |
| | | | (not the electrode, but the |
| | | | active material itself with zero |
| | | | binder and zero electrolyte; |
| | | | mAh/g). |
| Electrode | Coulombic | Potentiostat | The change in charge inserted |
| | Efficiency | | (or extracted) to an electrode |
| | | | divided by the charge |
| | | | extracted (or inserted) from the |
| | | | electrode during a complete |
| | | | electrochemical cycle within |
| | | | given voltage limits. Because |
| | | | the direction of charge flow is |
| | | | opposite for cathodes and |
| | | | anodes, the definition is |
| | | | dependent on the electrode. |
| | | | Coulombic Efficiency is |
| | | | measured for both materials by |
| | | | constructing a so-called half- |
| | | | cell, which is an |
| | | | electrochemical cell consisting |
| | | | of a cathode or anode material |
| | | | of interest as the working |
| | | | electrode and a lithium metal |
| | | | foil which functions as both |
| | | | the counter and reference |
| | | | electrode. Then, charge is |
| | | | either inserted or removed |
| | | | from the material of interest |
| | | | until the cell voltage reaches |
| | | | an appropriate limit. Then, the |
| | | | process is reversed until a |
| | | | second voltage limit is |
| | | | reached, and the charge passed |
| | | | in both steps is used to |
| | | | calculate the Coulombic |
| | | | Efficiency, as described above. |
| Battery Cell | Rate | Potentiostat | This is the time it takes to |
| | Performance | | charge or discharge a battery |
| | | | between a given state of |
| | | | charge. It is measured by |
| | | | charging or discharging a |
| | | | battery and measuring the time |
| | | | until a specified amount of |
| | | | charge is passed, or until the |
| | | | battery operating voltage |
| | | | reaches a specified value. |
| Battery Cell | Cell | Potentiostat | A battery consisting of a |
| | Discharge | | relevant anode and cathode is |
| | Voltage (e.g., | | charged and discharged within |
| | V) | | certain voltage limits and the |
| | | | charge-weighted cell voltage |
| | | | during discharge is computed. |
| Battery Cell | Operating | Potentiostat and | Average temperature of |
| | Temperature | thermocouples | battery cell as measured at the |
| | | | positive/negative terminal/ |
| | | | cell shaft/etc. while |
| | | | charging/discharging, or at a |
| | | | certain voltage level, or while |
| | | | a load is applied, etc. |
| Battery Half- | Anode | Potentiostat | An electrode containing an |
| Cell | Discharge (de- | | active anode material (or a |
| | lithiation) | | mixture of active materials) of |
| | Potential | | interest is charged and |
| | (e.g., V) | | discharged (by passing |
| | | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell potential |
| | | | upon discharge (corresponding |
| | | | to de-lithiation of the anode) is |
| | | | computed. |
| Battery Half- | Cathode | Potentiostat | An electrode containing an |
| Cell | Discharge | | active cathode material (or a |
| | (lithiation) | | mixture of active materials) of |
| | Potential | | interest is charged and |
| | (e.g., V) | | discharged (by passing |
| | | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell potential |
| | | | upon discharge (corresponding |
| | | | to lithiation of the cathode) is |
| | | | computed. |
| Battery Cell | Volumetric | Potentiostat | The VED is calculated by first |
| | Energy | | calculating the energy per unit |
| | Density | | area of the battery, and then |
| | (VED) | | dividing the energy per unit |
| | | | area by the sum of the |
| | | | illustrative anode, cathode, |
| | | | separator, and current collector |
| | | | thicknesses |
| Battery Cell | Internal | Potentiostat | The internal resistance (also |
| | Resistance | | known as impedance in many |
| | (impedance) | | contexts) is measured by |
| | | | applying small pulses of |
| | | | current to the battery cell and |
| | | | recording the instantaneous |
| | | | change in cell voltage. |

In some embodiments described below, certain parameters (e.g., temperature, state-of-charge (SOC), etc.) are defined in terms of relative terminology such as low, reduced, high, increased, elevated, and so on. With regard to temperature, unless otherwise stated, this relative terminology may be characterized relative to battery cell storage temperature or battery cell operating temperature, depending on the context of the relevant example. With regard to SOC, unless otherwise stated, a high SOC may be defined as higher than about 70% SOC (e.g., in some designs, about 70-80% SOC; in some designs, about 80-90% SOC; in some designs, about 90-100% SOC).

Reference below is made to various battery electrode compositions. Such battery electrode compositions may be in the form of a “dry” powder (e.g., before being mixed into or suspended in a slurry), in the slurry itself (e.g., in a suspended state), or in a casted electrode (e.g., casted onto and/or into a current collector to form an electrode, bound together with a suitable binder, dried, and optionally coated and/or calendered).

While the description below may describe certain examples in the context of Si—C composite (e.g. nanocomposite) anode active materials (e.g., nanocomposite particles which comprise silicon (Si) and carbon (C) (e.g., mostly graphitic, sp²-bonded carbon) and may comprise other elements, such as nitrogen (N), phosphorus (P), boron (B), oxygen (O), hydrogen (H), sulfur(S), to name a few and where a total mass of the Si and the C atoms may contribute from about 75 wt. % to about 100 wt. % of the total mass of the composite particles), it will be appreciated that various aspects may be applicable to other types of high-capacity silicon-comprising anode active materials (including but not limited to, for example, various silicon-comprising or silicon oxide-comprising or silicon nitride-comprising or silicon oxy-nitride comprising or silicon phosphide-comprising particles or particles comprising a mixture or alloy or other combinations of such active materials, various other types of Si-comprising composites including, but not limited to core-shell or hierarchical or nanocomposite particles, etc.).

While the description below may describe certain examples in the context of some specific alloying-type and conversion-type chemistries of anode and cathode active materials for Li-ion batteries (such as silicon-comprising anodes or metal fluoride-comprising or lithium sulfide-comprising cathodes), it will be appreciated that various aspects may be applicable to other chemistries for Li-ion batteries (other conversion-type and alloying-type electrodes as well as various intercalation-type anodes and cathodes) as well as to other battery chemistries. In the case of metal-ion batteries (such as Li-ion batteries), examples of other suitable conversion-type electrodes include, but are not limited to, metal fluorides, metal chlorides, metal iodides, metal bromides, sulfur, metal sulfides (including, but not limited to lithium sulfide), selenium, metal selenide (including, but not limited to lithium sulfide), metal oxides, metal nitrides, metal phosphides, metal hydrides, their various various mixtures, composites (including nanocomposites) and alloys and others.

While the description below may describe certain examples in the context of jagged (e.g., Si-comprising, such as Si—C, etc.) nanocomposite particles having a relatively small range of aspect ratios, it will be appreciated that various aspects may be applicable to other shapes of (e.g., Si-comprising, such as Si—C, etc.) nanocomposite particles, including, but not limited to cylindrical or fiber-shaped (e.g., Si-comprising, such as Si—C, etc.) nanocomposite particles (e.g., with aspect ratios in the range from about 1 to about 200; in some designs, from about 1 to about 5; in other designs from about 5 to about 10; in other designs, from about 10 to about 200), spherical or spheroidal particles, to provide a few illustrative examples.

During battery (such as a Li-ion battery) operation, conversion materials change (convert) from one crystal structure to another (hence the name “conversion”-type). This process is also accompanied by breaking chemical bonds and forming new ones. During (e.g., Li-ion) battery operation, Li ions are inserted into alloying type materials forming lithium alloys (hence the name “alloying”-type). Sometimes, “alloying”-type electrode materials are considered to be a subclass of “conversion”-type electrode materials.

In one or more embodiments of the present disclosure, a preferred anode for a battery cell may comprise a mixture of Si—C nanocomposite (e.g., particles) and graphite (e.g., particles) as the anode active material, a so-called blended anode. In addition to the anode active material particles, an anode may comprise inactive material, such as binder(s) (e.g., polymer binder) and other functional additives (e.g., surfactants, electrically conductive additives). In some implementations, the anode active material may be in a range of about 90 wt. % to about 98 wt. % of the anode. For example, the anode active material particles may be about 95.5 wt. % of the anode. In some implementations, blended anodes may comprise Si—C nanocomposites (e.g., particles) ranging from about 7 wt. % to about 75 wt. % of the anode and the graphite (e.g., particles) making up the remainder of the mass (the weight) of the anode active material particles. In some implementations in which the anode active material particles are about 95.5 wt. % of the blended anode, the blended anode (including active material particles and inactive material) may comprise about 7 wt. % of Si—C nanocomposite (e.g., particles) and about 88.5 wt. % of graphite particles. In some implementations in which the anode active material particles are about 95.5 wt. % of the blended anode, the blended anode (including active material particles and inactive material) may comprise about 19 wt. % of Si—C nanocomposite (e.g., particles) and about 76.5 wt. % of graphite particles. In some implementations in which the anode active material particles are about 95.5 wt. % of the blended anode, the blended anode (including active material particles and inactive material) may comprise about 35 wt. % of Si—C nanocomposite (e.g., particles) and about 60.5 wt. % of graphite particles. In some implementations in which the anode active material particles are about 94.5 wt. % of the blended anode, the blended anode (including active material particles and inactive material) may comprise about 50 wt. % of Si—C nanocomposite (e.g., particles) and about 44.5 wt. % of graphite particles. In some implementations in which the anode active material particles are about 92.5 wt. % of the blended anode, the blended anode (including active material particles and inactive material) may comprise about 69.4 wt. % of Si—C nanocomposite (e.g., particles) and about 23.1 wt. % of graphite particles. In some designs, a higher fraction of Si—C composite particles in the blended anode may benefit from a higher fraction of inactive material to attain superior cycle stability and other performance characteristics.

While the descriptions below may also describe certain examples of the blended anode formulations expressed as mass (wt. %) of Si—C nanocomposite (e.g., particles), it will be appreciated that various aspects of this disclosure may be applicable to blended anode formulations expressed as wt. % of Si in the anode. In some implementations, a blended anode composition of about 7 wt. % of Si—C nanocomposite (e.g., particles) may correspond, for example, to about 3-3.5 wt. % of Si in the blended anode. In some implementations, a blended anode composition of about 19 wt. % of Si—C nanocomposite corresponds to about 8-9.5 wt. % of Si in the blended anode. In some implementations, a blended anode composition of about 35 wt. % of Si—C nanocomposite (e.g., particles) corresponds to about 15-18 wt. % of Si in the blended anode. In some implementations, a blended anode composition of about 50 wt. % of Si—C nanocomposite (e.g., particles) corresponds to about 21-30 wt. % of Si in the blended anode. In respective implementations, blended anodes may be obtained in which the mass (weight) of the silicon is in a range of about 3 wt. % to about 30 wt. % of a total mass of the anode.

While the descriptions below may also describe certain examples of the blended anode formulations expressed as mass (wt. %) of Si—C nanocomposite (e.g., particles) relative to all active material in the anode, it will be appreciated that various aspects of this disclosure may be applicable to blended anode formulations attributing a fraction (e.g., %) of the total capacity of the blended anode to the capacity of the Si. In some implementations, about 25% of the total capacity of the blended anode is obtained from the Si—C nanocomposite (e.g., particles) in a blended anode composition of about 7 wt. % of Si—C nanocomposite (e.g., particles) and about 93 wt. % of graphite (e.g., particles). In some other implementations, about 50% of the total capacity of the blended anode is obtained from the Si—C nanocomposite (e.g., particles) in a blended anode composition of about 19 wt. % of Si—C nanocomposite (e.g., particles) and about 81 wt. % of graphite (e.g., particles). In some other implementations, about 70% of the total capacity of the blended anode is obtained from the Si—C nanocomposite in a blended anode composition of about 35 wt. % of Si—C nanocomposite (e.g., particles) and about 65 wt. % of graphite (e.g., particles). In some other implementations, about 80% of the total capacity of the blended anode is obtained from the Si—C nanocomposite (e.g., particles) in a blended anode composition of about 50 wt. % of Si—C nanocomposite (e.g., particles) and about 50 wt. % of graphite (e.g., particles). Note that the % of the total capacity of the blended anode provided by the Si—C nanocomposite (e.g., particles) depends on both the wt. % of such particles (e.g., relative to all active material in the anode) and the Si—C nanocomposite specific capacity. Higher specific capacity Si—C nanocomposite particles, for example, will provide higher % of the total capacity for the same wt. %.

While the description below may describe certain examples of suitable intercalation-type graphites to be used in combination with Si—C nanocomposite (e.g., particles) in a blend, it will be appreciated that various aspects of this disclosure may be applicable to soft-type synthetic graphite (or soft carbon, broadly), hard-type synthetic graphite (or hard carbon, broadly), and natural graphite (which may, for example, be pitch carbon coated); including but not limited to those which exhibit discharge capacity from about 320 to about 372 mAh/g (e.g., in some designs, from about 320 to about 350 mAh/g; or in other designs, from about 350 to about 362 mAh/g; or in other designs, from about 362 to about 372 mAh/g); including but not limited to those which exhibit low, moderate and high swelling; including but not limited to those which exhibit good and poor compression, including but not limited to those which exhibit Brunauer-Emmett-Teller (BET) specific surface area of about 1 to about 4 m²/g; including but not limited to those which exhibit lithiation efficiency of about 90% and more; including but not limited to those which exhibit average particle sizes from about 8 μm to about 18 μm; including but not limited to those which exhibit true densities ranging from about 1.5 g/cm³ to about 2.3 g/cm³ (e.g., in some designs, from about 1.5 to about 1.8 g/cm³, in other designs, from about 1.8 to about 2.3 g/cm³); including but not limited to those which exhibit poor, moderate, or good cycle life when used in Li-ion battery anodes on their own (e.g., without Si—C composites or other active particles); including but not limited to those which are coated and comprise coatings with coating thickness to appreciably improve compression and springing during cycling.

While the description below may describe certain examples of suitable intercalation-type cathodes (including high voltage cathodes) in the context of lithium nickel cobalt aluminum oxides (NCA), lithium nickel cobalt manganese aluminum oxides (NCMA), lithium nickel oxides (LNO), lithium manganese oxides (LMO), lithium nickel manganese cobalt oxides (NCM), lithium cobalt oxide (LCO), lithium cobalt aluminum oxides (LCAO), lithium iron phosphate (LFP), lithium cobalt phosphate (LCP), lithium manganese phosphate (LMP), lithium manganese iron phosphate (LMFP), lithium nickel phosphate (LiNiPO₄), lithium vanadium fluoro phosphate (LiVFPO₄), lithium iron fluoro sulfate (LiFeSO₄F), various Li excess materials (e.g., lithium excess (rocksalt) transition metal oxides and oxy-fluorides such as Li_{1.211}Mo_{0.467}Cr_{0.3}O₂, Li_{1.3}Mn_{0.4}Nb_{0.3}O₂, Li_{1.2}Mn_{0.4}Ti_{0.4}O₂, Li_{1.2}Mn_{0.8}O₂, Li_{1.2}Mn_{0.7}W_{0.07}O₂, Li_{1.2}Mn_{0.8}O_{1.95}F_{0.1}, Li_{1.2}Mn_{0.75}Zr_{0.05}O_{1.95}F_{0.1}, Li_{1.2}Mn_{0.7}Zr_{0.05}W_{0.035}O_{1.95}F_{0.1}, Li_{1.2}Ni_{0.333} Ti_{0.333}MO_{0.133}O₂ and many others), various high capacity Li-ion based materials with partial substitution of oxygen for fluorine or iodine (e.g., rocksalt Li₂Mn_{2/3}Nb_{1/3}O₂F, Li₂Mn₁₂Ti₁₂O₂F, Li_{1.5}Na_{0.5}MnO_{2.85}I_{0.12}, among others) and many other types of Li-comprising disordered, layered, tavorite, olivine, or spinel type active materials or their mixtures comprising at least oxygen or fluorine or sulfur and at least one transition metal and other lithium transition metal (TM) oxides or phosphates or sulfates (or mixed) cathode or anode active materials that rely on the intercalation of lithium (Li) and changes in the TM oxidation state (including, but not limited to those that may be doped or heavily doped; including, but not limited to those that have gradient in composition or core-shell morphology; including, but not limited to those that may be partially fluorinated or comprise some meaningful fraction of fluorine (e.g., about 0.001-10 at. %) in their composition, etc.), it will be appreciated that various aspects may be applicable to high-voltage lithium transition metal oxide (or phosphate or sulfate or mixed or other) cathodes where TMs and oxygen (O) are covalently bonded and both TM and O take part in electrochemical reduction-oxidation (redox) reactions during charge and discharge (including, but not limited to, those oxides or phosphate or sulfate or mixed cathodes that may comprise at least about 0.25 at. % of Mn, Fe, Ni, Co, Nb, Mg, Cr, Mo, Zr, W, Ta, Ti, Hf, Y, La, Sb, V, Sn, Si, or Ge).

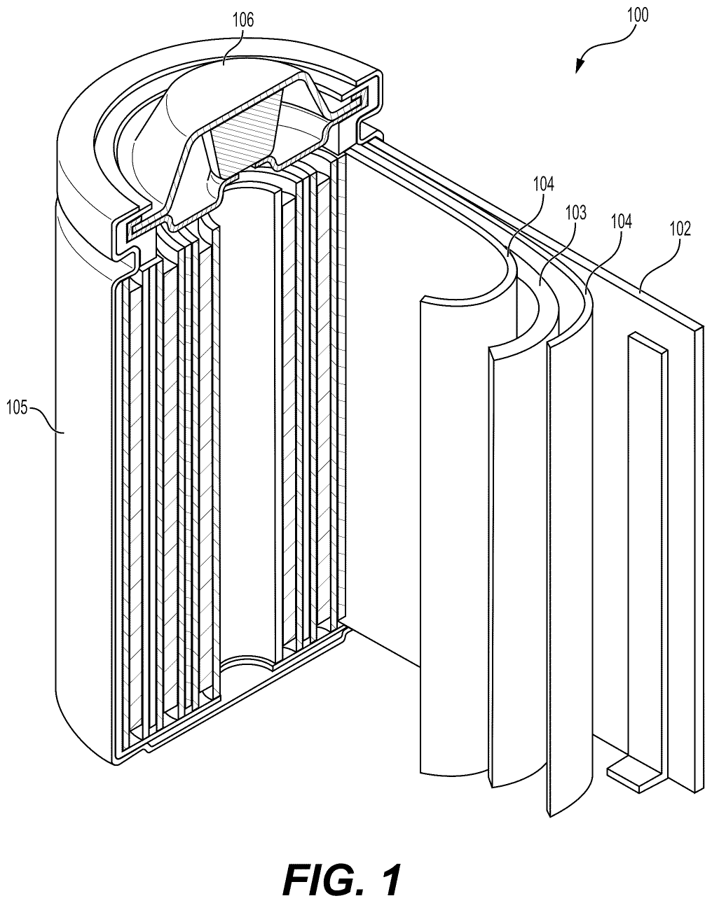

FIG. 1 illustrates an example metal-ion (e.g., Li-ion) battery in which the electrode particles, components, materials, processes, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative electrode (anode electrode or anode) 102, a positive electrode (cathode electrode or cathode) 103, a separator 104 interposed between the anode 102 and the cathode 103, an electrolyte (shown implicitly) impregnating the separator 104, a battery case 105, and a sealing member 106 sealing the battery case 105. The electrolyte ionically couples the anode (negative electrode) and the cathode (positive electrode). The electrolyte is interposed between the anode electrode and the cathode electrode. In some implementations, battery 100 also includes an anode current collector and a cathode current collector. The anode is disposed on or in the anode current collector and the cathode is disposed on or in the cathode current collector.

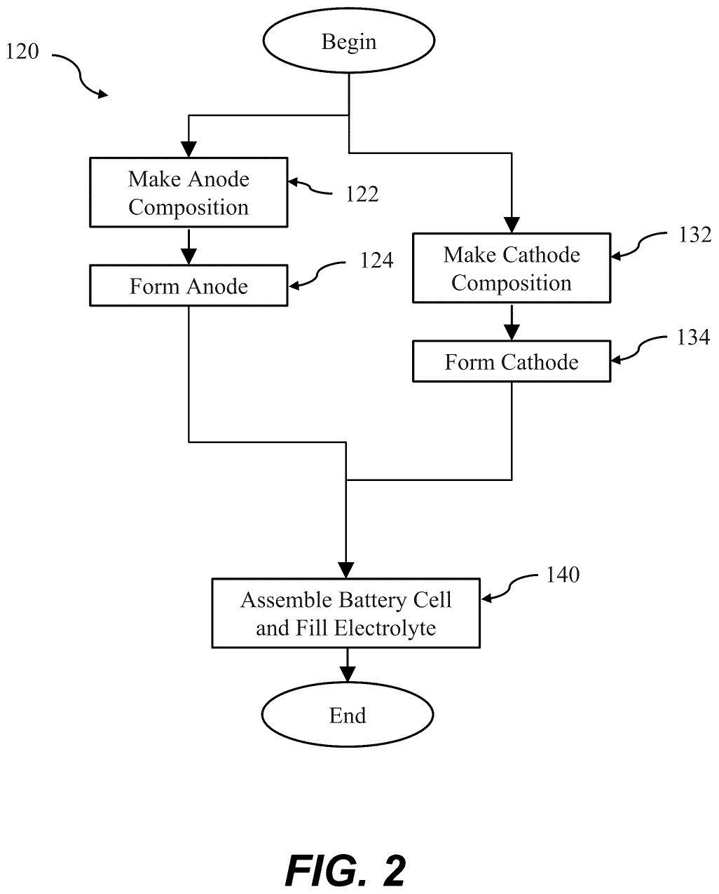

FIG. 2 shows a flow diagram of a process 120 for making a Li-ion battery, such as the example battery 100 of FIG. 1. In the example shown, process 120 includes operations 122, 124, 132, 134, and 140. The flow diagram includes an anode branch (left branch) that includes operations 122 and 124, and a cathode branch (right branch) includes operation 132 and 134. At operation 122, anode particles (e.g., conventional anode particles or core-shell anode particles or composite anode particles, including but not limited to Si-comprising composite (e.g., nanocomposite) particles whereby Si-comprising active material is deposited within pore(s) of a particle core) are made, and at operation 124, an anode is formed. Similarly, at operation 132, cathode particles (e.g., conventional cathode particles or core-shell cathode particles or composite cathode particles, including but not limited to conversion-type cathode material-comprising composite particles whereby conversion-type cathode material active material is deposited within pore(s) of a particle core) are made, and at operation 134, a cathode is formed.

Electrodes utilized in Li-ion batteries are typically produced by (i) formation of a slurry comprising active materials, conductive additives, binder solutions and, in some cases, surfactant or other functional additives; (ii) casting the slurry onto a metal foil (e.g., Cu or Cu-alloy foil for most anodes and Al or Al-alloy foil for most cathodes); and (iii) drying the casted electrodes to completely evaporate the solvent. In some implementations, the stage (iii) may also include densifying the battery electrode to a desired value. Note that a metal mesh, metal foam or very rough metal foil (e.g., comprising metal nanowires or metal nanosheets on its surface) may be used in some designs (e.g., for higher areal capacity loadings or for achieving faster charge, etc.). Also note that a metal coated thin polymer sheets may also be used in some designs (e.g., to achieve improved safety or lower current collector weight, etc.). Also note that a porous metal foil or composite (e.g., nanocomposite) metal foils may be used in some designs (e.g., for improved properties, lower weight, etc.).

Operation 124 includes making an anode electrode, with the anode electrode including the anode particles made at operation 122. For example, this operation 124 can include (1) making an anode slurry that includes the anode particles (e.g., from operation 122) and other anode slurry components and (2) casting the anode slurry on an anode current collector (e.g., copper foil or copper-alloy foil current collector). In some designs, this stage may often include evaporating the slurry solvent and/or densifying the battery electrode to a desired value. For example, other anode slurry components can include: other electrochemically-active anode active materials (e.g., natural or synthetic graphite, soft carbon or hard carbon), electrically conductive additives (e.g., carbon nanotubes or carbon black or branched carbon or carbon nanofibers or graphite flakes or exfoliated graphite or graphene (e.g., single-walled graphene, multi-walled graphene) or graphene oxide (e.g., single-walled graphene oxide, multi-walled graphene oxide) or soft graphite or their various combinations, to name a few), binders (e.g., polymer binders), and solvents (e.g., water or a suitable organic solvent).

Operation 134 includes making a cathode electrode, with the cathode electrode including the cathode particles made at operation 132. For example, this operation 134 can include (1) making a cathode slurry that includes the cathode particles (e.g., from operation 132) and other cathode slurry components and (2) casting the cathode slurry on a cathode current collector (e.g., aluminum foil or aluminum-alloy foil current collector). In some designs, this stage may often include evaporating the slurry solvent and/or densifying the battery electrode to a desired value. For example, other cathode slurry components can include: other electrochemically-active cathode active materials, electrically conductive additives (e.g., carbon nanotubes or carbon black or branched carbon or carbon nanofibers or graphite flakes or graphene (e.g., single-walled graphene, multi-walled graphene) or graphene oxide (e.g., single-walled graphene oxide, multi-walled graphene oxide) or soft graphite or their various combinations, to name a few), binders (e.g., polymer binders), and solvents (e.g., water or a suitable organic solvent).

At operation 140, the Li-ion rechargeable battery cell is assembled from at least the anode electrode and the cathode electrode with an electrolyte interposed between the anode electrode and the cathode electrode. The electrolyte provides ionic conduction between the anode and the cathode. The electrolyte ionically couples the anode and the cathode. The electrolyte may comprise a liquid electrolyte or a solid electrolyte (or a mixture of liquid and solid electrolyte) at battery operating temperatures (e.g., in some designs, the solid electrolyte may be molten or semi-molten during melt-infiltration and may subsequently solidify). In some implementations, e.g., implementations in which a liquid electrolyte is used, a separator may be used to maintain a space between the anode and the cathode electrodes.

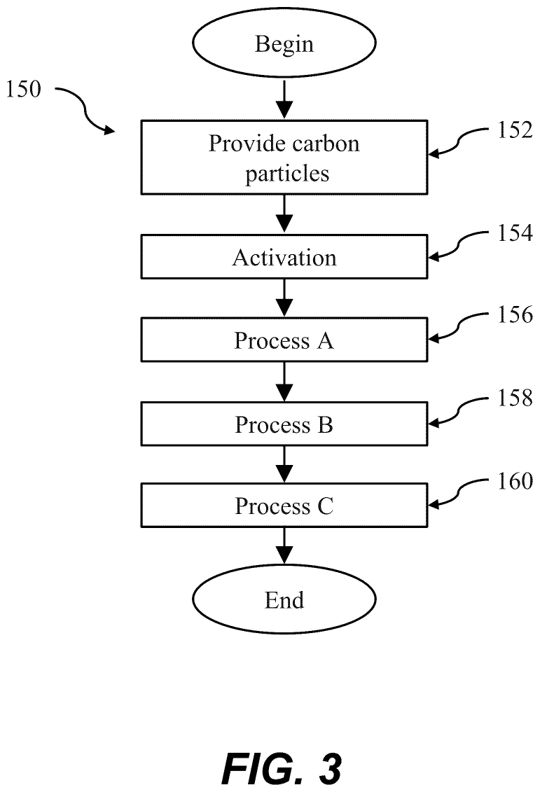

FIG. 3 is a flow diagram of a process 150 of making anode particles and illustrates operation 122 in greater detail. Process 150 includes operations 152, 154, 156, 158, and 160. In some designs, the processes and systems as described herein may be particularly useful when implemented as part of operation 122 and/or operation 132. In some implementations, electrode particles are made using porous carbon or porous carbon-containing particles (e.g., mostly using graphitic, sp²-bonded carbon or porous graphitic, sp²-bonded carbon-containing particles), with nanostructured or nano-sized active material particles (e.g., with average diameter or linear dimensions in the range from about 1 nm to about 200 nm (in some designs, from about 1 nm to about 10 nm; in other designs, from about 10 nm to about 30 nm; in yet other designs, from about 30 nm to about 100 nm; in yet other designs, from about 100 nm to about 200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques) being formed in the pores of the porous carbon or porous carbon-containing particles. In the case of anode particles for use in Li-ion batteries, the active material particles may be silicon-comprising particles.

At operation 152, carbon particles are provided. In some designs, carbon (e.g., mostly graphitic, sp²-bonded carbon) particles may be obtained from pyrolysis or carbonization (e.g., by heat treatment or hydrothermal treatment) of a suitable precursor particle, such as a polymer particle or a biomass-derived particle. In some designs, carbon particles may be obtained from carbon-comprising inorganic precursor particles (e.g., carbides or oxy-carbides, etc.).

In some designs, inorganic sacrificial templates (including, but not limited to various oxides or hydroxides or oxyhydroxides of various metals and semi-metals—e.g., Zn, Mg, Si, Al, Ti, Ca, Mg, Sc, etc. and their various combinations) or soft (organic) templates may be used for the formation of porous carbon particles.

In some designs, it may be preferable that the porosity of the carbon or carbon-containing particles (e.g., specific surface area and specific pore volume) be quite high before the formation of the nanostructured or nano-sized active material particles therein. In some implementations, it is preferable that the carbon or carbon-containing particles exhibit a Brunauer-Emmett-Teller (BET) specific surface area (SSA) (e.g., obtained from the data of nitrogen sorption-desorption at cryogenic temperatures, such as about 77K) of about 500 m²/g or more, before formation of the active material particles therein. In some implementations, it is preferable that the carbon particles exhibit a BET specific surface area in a range of about 500 m²/g to about 4500 m²/g or about 4800 m²/g (in some designs, from around 500 to about 1000 m²/g; in other designs, from around 1000 to about 2000 m²/g; in other designs, from around 2000 to about 3000 m²/g; in other designs, from around 3000 to about 3800 m²/g; in yet other designs, from around 3800 to about 4800 m²/g), before formation of the active material particles therein. In some implementations, it is preferable that the carbon particles exhibit a total micro- and meso-pore volume (not counting macropores, above 50 nm) in a range of about 0.5 cc/g to about 5 cc/g (in some designs, from around 0.5 to about 1 cc/g; in other designs, from around 1 to about 2 cc/g; in other designs, from around 2 to about 3.5 cc/g; in other designs, from around 3.5 to about 5 cc/g;), before formation of the active material particles therein. In some designs, such high surface areas can be obtained by carrying out physical or chemical activation of carbon or carbon-containing precursor particles, or by rapid annealing of carbon or carbon-containing precursor particles or by using temporary template materials or by other known suitable means. In some cases, the precursor particles themselves may be highly porous (e.g., aerogel particles). Nevertheless, in some designs, it may be preferable to produce or enhance porosity in carbon or carbon precursor particles (e.g., by carrying out activation on the carbon or carbon-containing particles or by leaching out non-carbon components of carbon-containing particles) before formation of the active material particles therein to tune the porosity characteristics. Accordingly, operation 154 includes carrying out a porosity enhancing (e.g., an activation) process on the carbon particles (e.g., from operation 152).

After the activation operation (operation 154), other process operations, such as process A at operation 156, process B at operation 158, and process C at operation 160, are carried out. In the example shown, there are three process operations after porosity enhancing (e.g., an activation) process (operation 154) but in other implementations there may be less than or more than three process operations after activation. For illustration, process 150 is described with respect to the formation of certain electrode (e.g., anode) particles. The concepts of process 150 including porosity enhancing (e.g., an activation) of carbon particles can be applied to other anode particles or with cathode particles that require activation of carbon particles.

In the example illustrated in FIG. 3, nanostructured or nano-sized silicon (Si) or silicon oxide (SiOₓ) or silicon nitride (SiN_{y}) or silicon oxy-nitride (SiOₓN_{y}) or silicon phosphide (SiP_{z}) particles (0<x<2; 0<y<1.3; 0<<<1) or their various combinations, alloys and mixtures are formed within the pores (and/or on the surface) of porous carbon or porous carbon-containing particles (e.g., mostly graphitic, sp²-bonded porous carbon or mostly graphitic, sp²-bonded carbon-containing particles). For example, process A (operation 156) includes the formation of silicon-based active material particles at least in some of the pores of the porous carbon particles. The formation (e.g., by deposition or infiltration or deposition/infiltration of a Si-comprising precursor with the subsequent conversion to the final Si or Si-based material) of silicon-based active material particles in the porous carbon particles can be accomplished by solution-based or vapor-based deposition processes, in some examples, or by other suitable means. For brevity, the particles upon completion of process A are sometimes referred to as silicon-carbon composite particles (with an understanding that elements other than Si and C may be present within such composite particles in some designs). In some embodiments, such composite particles comprise nano-sized or nanostructured elements (e.g., nano-sized or nanostructured Si, nano-sized or nanostructured C), which may be referred to as nanocomposite particles. In some implementations, the Si or Si-comprising material present in such nanocomposites may be in the form of nanoparticles. In some implementations, the mass-average size of Si or Si-comprising material nanoparticles may range from about 1 nm to about 200 nm (in some designs, from about 1 nm to about 10 nm; in other designs, from about 10 nm to about 30 nm; in yet other designs, from about 30 nm to about 100 nm; in yet other designs, from about 100 nm to about 200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques.

In the example shown, process B is carried out at operation 158. For example, process B includes the formation of a protective coating on and in the silicon-carbon (Si—C) composite particles (from operation 156). In some designs, the suitable average thickness of the protective coating may range from about 0.2 nm to about 50 nm (in some designs, from about 0.2 nm to about 2 nm; in other designs, from about 2 nm to about 5 nm; in other designs, from about 5 nm to about 10 nm; in yet other designs, from about 10 nm to about 50 nm). In some designs, the true density of the protective coating may range from about 0.8 g/cc to about 4.8 g/cc or about 5.8 g/cc (in some designs, from about 0.8 g/cc to about 1.6 g/cc; in other designs, from about 1.6 g/cc to about 3 g/cc; in other designs, from about 3 g/cc to about 4.5 g/cc; in yet other designs, from about 4.5 g/cc to about 4.8 g/cc or about 5.8 g/cc).

In some designs, the protective coating may comprise or be based on electronically conductive material such as carbon. In some designs, such a carbon coating may be doped (e.g., with B, P, N, O and/or other elements). In some designs, the atomic fraction of individual dopants may range from about 0.01 at. % to about 10.01 at. % (in some designs, from about 0.01 at. % to about 0.1 at. %; in other designs, from about 0.1 at. % to about 1 at. %; in other designs, from about 1 at. % to about 5 at. %; in yet other designs, from about 5 at. % to about 10.01 at. %). In some designs, the protective coating may be largely impermeable to electrolyte solvent.

During operation of a Li-ion battery cell (e.g., 100 in FIG. 1), the protective coating may prevent direct contact between the silicon nanoparticles and an electrolyte solvent composition. In some designs, direct contact between the electrolyte solvent composition and the silicon nanoparticles may undesirably accelerate degradation of the Li-ion battery cell.

In the example shown, process C is carried out at operation 160. For example, process C includes making changes to the particle size distribution (PSD). Process C may include carrying out comminution on the protected silicon-carbon composite particles (from operation 158). Comminution may be carried out when the particle sizes are larger (on average) than a final desired (e.g., for a slurry and electrode processing) particle size distribution. Various processes of carrying out comminution are known in the art. For example, the comminution can be carried out by one or more of: ball milling, jet milling, attrition milling, pin milling, and hammer milling. In some implementations, it may be preferable to carry out particle size selection during process operation C. In some cases, process C can include particle size selection (e.g., by sieving or by screening or by centrifugation or by other aerodynamic size classification or by other means) in addition to comminution (e.g., particle size selection after comminution). In some cases, process C can include particle size selection without comminution. For example, it may be preferable to retain some of the larger particle sizes and discard the finer particle sizes. The particle size selection may be carried out by any one of suitable processes known to those skilled in the art, such as screening, sieving, and aerodynamic size classification.

The foregoing process operation C (160) includes examples, such as comminution and particle size selection, of making changes to a particle size distribution (PSD) of a population of particles. In some cases, it may be preferable to employ additional or alternative processes for changing or adjusting a PSD, such as mixing two or more populations of particles wherein each of the populations has a PSD different from others of the populations. For example, particle populations of different PSDs may be obtained (e.g., obtained from a supplier or made to different PSDs including employing the aforementioned processes of comminution and/or particle size selection under different processing conditions).

The particle size distribution (PSD) that characterizes a particle population may be determined by laser particle size distribution analysis (LPSA), image analysis of electron microscopy images, or other suitable techniques. The particle size distribution (PSD) may be determined by laser particle size distribution analysis (LPSA) on well-dispersed particle suspensions in one example. Note that other types of particle size distribution (e.g., by SEM image analysis) could also be utilized (and may even lead to more precise measurements, in some experiments). While there are diverse processes of measuring PSDs, laser particle size distribution analysis (LPSA) is quite efficient for some applications. Using LPSA, particle size parameters of a population's PSD can be measured, such as: a tenth-percentile volume-weighted particle size parameter (e.g., abbreviated as D₁₀), a fiftieth-percentile volume-weighted particle size parameter (e.g., abbreviated as D₅₀), a ninetieth-percentile volume-weighted particle size parameter (e.g., abbreviated as D₉₀), and a ninety-ninth-percentile volume-weighted particle size parameter (e.g., abbreviated as D₉₉). Additionally, parameters relating to characteristic widths of the PSD may be derived from these particle size parameters, such as D₅₀−D₁₀ (sometimes referred to herein as a left width), D₉₀−D₅₀ (sometimes referred to herein as a right width), D₉₀−D₁₀ (sometimes referred to herein as a full width), and (D₉₀−D₁₀)/D₅₀ (sometimes referred to herein as a span). A cumulative volume fraction, defined as a cumulative volume of the composite particles with particle sizes of a threshold particle size or less, divided by a total volume of all of the composite particles, may be estimated by LPSA. In some embodiments, a fiftieth-percentile volume-weighted particle size parameter (D₅₀) of the PSD is in a range of about 2.0 μm to about 16.0 μm, or in a range of about 2.0 to about 4.0 μm, or in a range of about 4.0 to about 6.0 μm, or in a range of about 6.0 to about 8.0 μm or in a range of about 8.0 to about 16.0 μm.

Upon completion of the operations in process 150 (e.g., operations 152, 154, 156, 158, 160), the composite particles may be characterized by a Brunauer-Emmett-Teller (BET) specific surface area (SSA) (e.g., obtained from the data of nitrogen sorption-desorption at cryogenic temperatures, such as about 77K). In some embodiments, the BET-SSA of the composite particles is in a range of about 1 m²/g to about 50 m²/g (in some designs, from about 1 to about 3 m²/g; in other designs, from about 3 m²/g to about 12 m²/g; in yet other designs, from about 12 m²/g to about 18 m²/g; in yet other designs, from about 18 m²/g to about 30 m²/g; in yet other designs, from about 30 m²/g to about 50 m²/g).

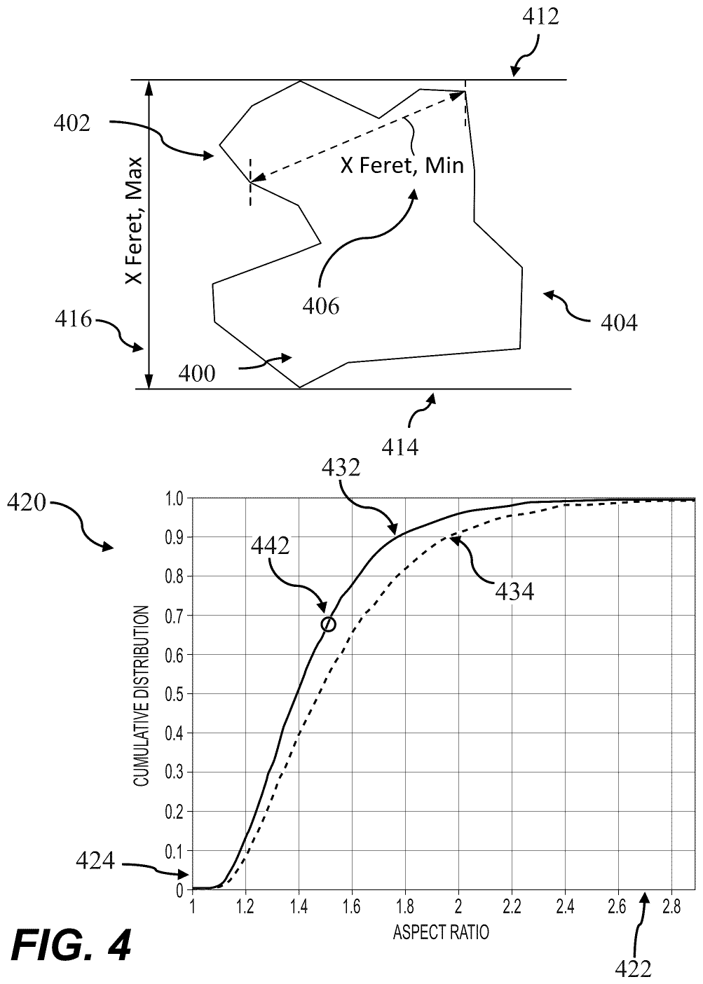

FIG. 4 (top) shows a schematic illustration of a jagged particle (e.g., jagged composite particle) 400, as may be observed under an optical microscope, for example. Two parallel lines 402, 404 are tangent to respective portions of the jagged particle 400. A distance 406 between the parallel lines 402, 404 is sometimes referred to as a minimum Feret diameter, because this distance 406 is the shortest distance among the distances between all the possible pairs of parallel lines that may be drawn tangent to respective portions of the jagged particle 400. Similarly, two parallel lines 412, 414 are tangent to respective portions of the jagged particle 400. A distance 416 between the parallel lines 412, 414 is sometimes referred to as a maximum Feret diameter, because this distance 416 is the longest distance among the distances between all the possible pairs of parallel lines that may be drawn tangent to respective portions of the jagged particle 400. An aspect ratio of a particle may be defined as a maximum Feret diameter of the particle divided by a minimum Feret diameter of the particle. Aspect ratios may be estimated by carrying out image analysis (e.g., running image analysis software) on populations of particles viewed under an optical microscope. The example jagged composite particles described herein were obtained by following the process 150 of FIG. 3, starting with obtaining carbon particles (152).

FIG. 4 (bottom) shows a graphical plot 420 of a dependence of cumulative distributions (expressed as a fraction of the number of particles in the entire respective population) of two selected populations of jagged particles. Image analysis was carried out on each population of jagged particles to estimate an aspect ratio for each particle in the population. The population represented by plot line 432 contained about 2192 particles and the population was characterized by a D₅₀ of about 4.5 μm. The population represented by plot line 434 contained about 7485 particles and the population was characterized by a D₅₀ of about 5.5 μm. The cumulative distribution of a particle population expresses, as a function of a specified aspect ratio, a fraction of the number of particles in the respective population that have aspect ratios smaller than or equal to the specified aspect ratio. The x-axis 422 shows the aspect ratios and the y-axis 424 shows the cumulative distribution of the particle population. For example, consider one of the data points 442, along the plot line 432, corresponding to an aspect ratio of about 1.5 and a cumulative distribution fraction of about 0.68. This means that about 68% of the number of particles in this population has an aspect ratio of about 1.5 or less.

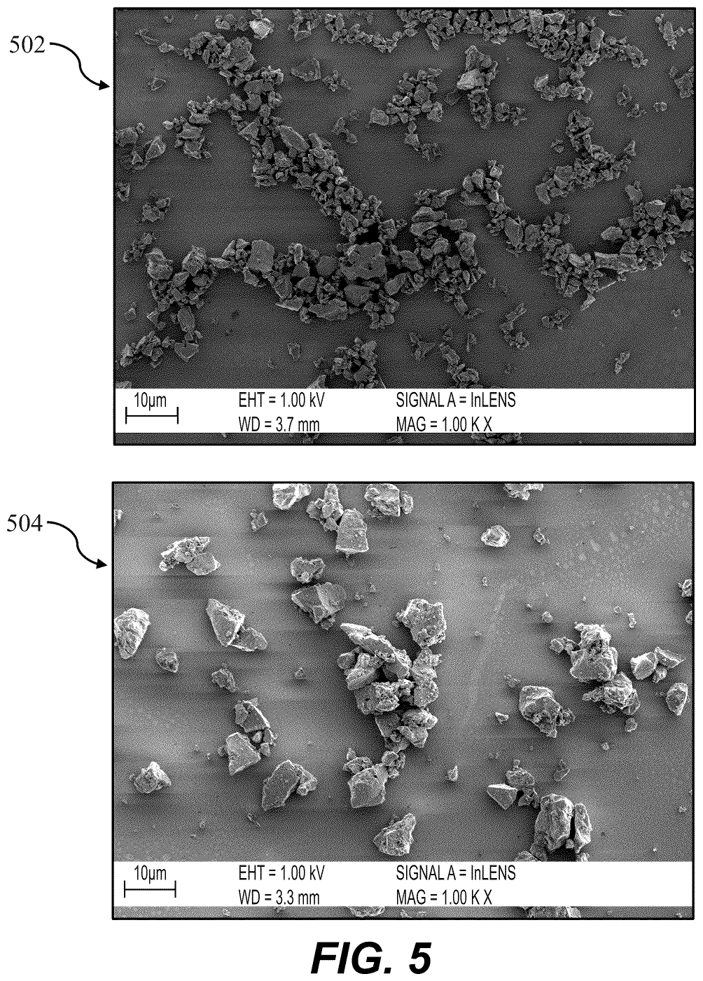

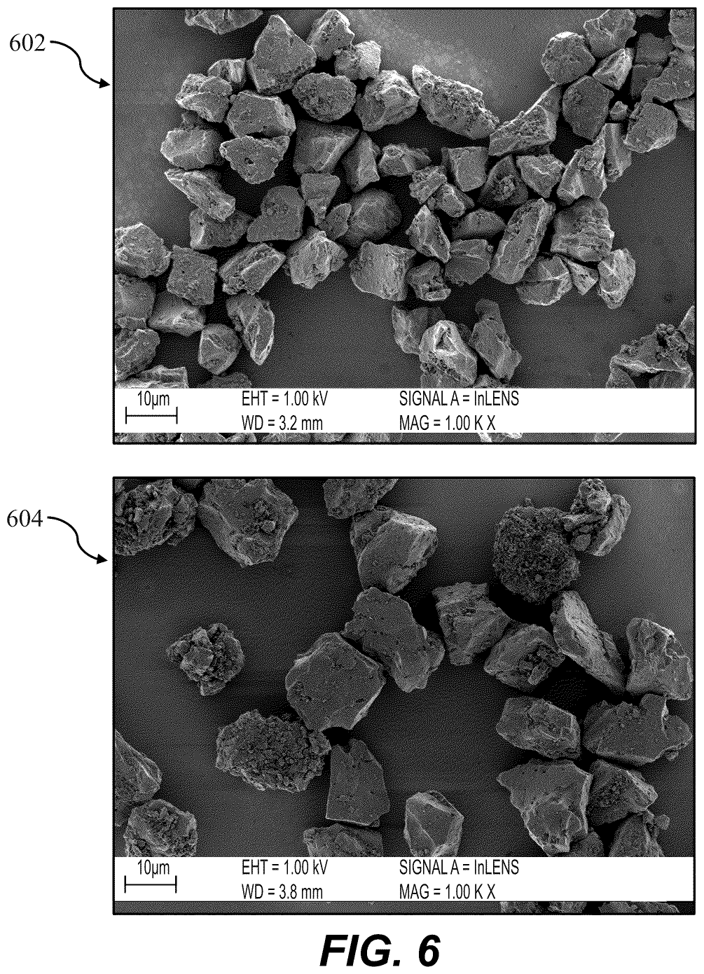

Scanning electron microscope (SEM) images of illustrative example jagged composite particles (or their agglomerates) are shown in FIGS. 5 and 6. FIG. 5 shows an SEM image 502 of jagged composite particles taken from a population with D₅₀ of about 2.5 μm and an SEM image 504 of jagged composite particles taken from a population with D₅₀ of about 7 μm. FIG. 6 shows an SEM image 602 of jagged composite particles taken from a population with D₅₀ of about 9 μm and an SEM image 604 of jagged composite particles taken from a population with D₅₀ of about 14 μm. In the examples shown, the composite particles are jagged and are not round (e.g., are not spherical, are not spheroidal, etc.). Many of the composite particles have aspect ratios that are quite low, such as lower than about 10, lower than about 5, or lower than about 3. On the other hand, many of the composite particles have aspect ratios greater than about 1. In some implementations, the aspect ratios of populations of jagged composite particles (including the examples populations illustrated in graphical plot 420 of FIG. 4) may be characterized by one or more of the following: (1) about 90% or more of the jagged composite particles in the population are characterized by aspect ratios of about 2.3 or less, or about 2.2 or less, or about 2.1 or less; (2) about 50% or more of the jagged composite particles in the population are characterized by aspect ratios of about 1.25 or more, or about 1.3 or more, or about 1.35 or more; and (3) about 10% or more of the jagged composite particles in the population are characterized by aspect ratios of about 1.3 or less, or about 1.25 or less, or about 1.2 or less.

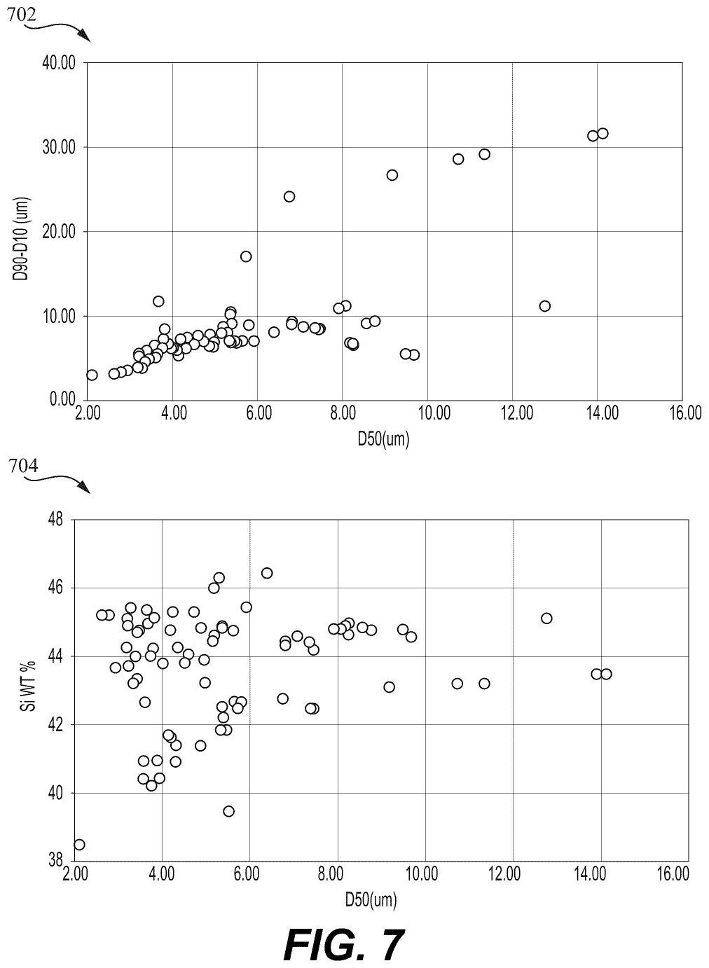

FIG. 7 shows a graphical plot 702 of a dependence of a full width D₉₀−D₁₀ on D₅₀ of each of the example particle populations and a graphical plot 704 of a dependence of mass fraction of silicon in the composite particles on D₅₀ of each of the example particle populations. The example populations ranged in D₅₀ between about 2.1 μm and about 14.1 μm. In the example populations shown, the full width D₉₀−D₁₀ ranged between about 3.0 μm and about 31.7 μm. The silicon (Si) mass fraction was estimated by thermogravimetric analysis (TGA) of a powder sample in a crucible that was heated to about 900° C. (ramp rate of about 40° C./min) in air and held for about 60 minutes. The sample was then allowed to cool to room temperature and the resulting mass was assumed to be entirely silicon oxide. Under this assumption, the amount of silicon that would have been present in the original powder sample was calculated. In the illustrative examples shown, the Si mass fractions ranged between about 38.5 wt. % and about 46.4 wt. %. In some implementations, the Si mass fractions in the composite particles may be in a range of about 35 wt. % to about 50 wt. %. In some implementations, the silicon mass fraction in the composite particles may be in a range of about 3 wt. % to about 80 wt. % (e.g., about 3-about 20 wt. %, about 20-about 35 wt. %, about 35-about 50 wt. %, about 50-about 80 wt. %, etc.).

Electrode coatings for the illustrative examples were prepared using each of the battery electrode compositions comprising a respective population of jagged composite particles. In addition to the composite particles, a battery electrode composition may include functional additives (e.g., additives that enhance electrical conductivity or rate performance of mechanical properties of the electrode), such as carbon-comprising functional additives. Examples of suitable carbon-comprising functional additives are carbon nanotubes (single-walled carbon nanotubes, abbreviated as SWCNTs, multi-walled carbon nanotubes, abbreviated as MWCNTs), carbon nanofibers, carbon black, graphite, exfoliated graphite, graphene oxide and graphene. Slurries were prepared by thoroughly mixing the jagged nanocomposite particles (or a mixture of jagged nanocomposite particles and graphite in case of a blended anodes) (e.g., at a mass fraction in a range of about 87 wt. % to about 94 wt. %, or in a range of about 89 wt. % to about 92 wt. %, of the solids content of the slurry), a binder composition (e.g., at a mass fraction in a range of about 6 wt. % to about 13 wt. %, or in a range of 8 wt. % to about 10 wt. %, of the solids content of the slurry), functional additives (e.g., at a mass fraction in a range of about 0 wt. % to about 0.1 wt. % of the solids content of the slurry), and a solvent composition (e.g., at a mass fraction of 10 wt. % to about 40 wt. % of the slurry). The illustrative example anode slurries were then casted onto a copper foil and dried at room temperature to form an electrode coating. Subsequently, dried electrode coatings were calendered (in our illustrative examples, by using a constant force) to obtain a coating density in a specific range, e.g., in a range of about 0.75 g/cm³ to about 1.00 g/cm³ (e.g., in case of anodes comprising solely Si—C nanocomposite particles as active material without any graphite) or in a range of about 0.80 g/cm³ to about 1.00 g/cm³ or in a range of about 0.85 g/cm³ to about 1.00 g/cm³, or in a range of about 0.90 g/cm³ to about 1.00 g/cm³. Note that higher density (e.g., designs with about 1.0 to about 1.2 g/cm³, designs with about 1.2 to about 1.5 g/cm³ or more) may preferably be attained for blended anodes comprising small-to-large fractions of soft or hard graphite (broadly, soft or hard carbon) or their various mixtures (e.g., about 5-80% of capacity provided by graphite and about 20-95% capacity provided by Si—C nanocomposite or other Si-comprising particles).

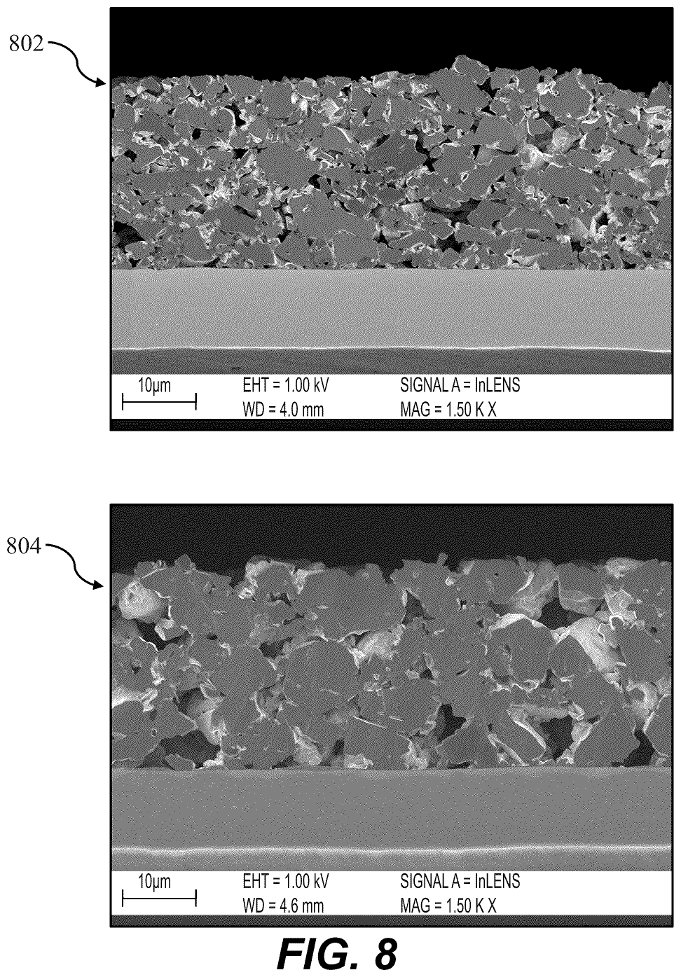

FIG. 8 shows SEM images 802, 804 of cross sections of electrode coatings. SEM image 802 is a cross-sectional view of an electrode coating comprising a population sample of D₅₀ of about 4 μm and SEM image 804 is a cross-sectional view of an electrode coating comprising a population sample of D₅₀ of about 14 μm. Comparing these two examples, the coating of larger particles (804) exhibits pores that are larger than the coating of smaller particles (802). Accordingly, the coating porosity tends to decrease, and the coating density tends to increase, as the particle size decreases (e.g., D₅₀ decreases from about 14 μm to about 4 μm). Electrode coatings comprising the respective example particle populations (i.e., the populations characterized in graphical plots 702, 704 in FIG. 7) were coated on copper foils. The electrode coating thicknesses ranged between about 24.3 μm and about 43.5 μm.

Conventional anode active materials utilized in Li-ion batteries are of an intercalation-type. Metal ions are intercalated into and occupy interstitial positions of such materials during the charge or discharge of a battery. Such anodes experience small or very small volume changes (e.g., less than about 8 vol. %) when used in electrodes. Polyvinylidene fluoride (also referred to as polyvinylidene difluoride (PVDF)), polyacrylic acid (PAA) (or its salts, derivatives, and copolymers) (sometimes mixed with styrene butadiene rubber, SBR), and carboxymethyl cellulose (CMC) (often mixed with styrene butadiene rubber, SBR) are the three most common binders used in these electrodes. Carbon black is the most common conductive additive used in these electrodes. However, such anodes exhibit relatively small gravimetric and volumetric capacities (typically less than about 370 mAh/g rechargeable specific capacity in the case of graphite- or hard carbon-based anodes and less than about 600 mAh/cm³ rechargeable volumetric capacity at the electrode level without considering the volume of the current collector foils).

Alloying-type (or, more broadly, conversion-type) anode active materials for use in Li-ion batteries offer higher gravimetric and volumetric capacities compared to intercalation-type anodes. For example, Earth-abundant silicon (Si) offers approximately 10 times higher gravimetric capacity and approximately 3 times higher volumetric capacity compared to an intercalation-type graphite (or graphite-like) anode. However, Si suffers from significant volume expansion during Li insertion (up to approximately 300 vol. %) and thus may induce thickness changes and mechanical failure of Si-comprising anodes. In addition, Si (and some Li—Si alloy compounds that may form during lithiation of Si) suffer from relatively low electrical conductivity and relatively low ionic (Li-ion) conductivity. Electronic and ionic conductivity of Si is lower than that of graphite. Formation of (nano) composite Si-comprising particles (including, but not limited to Si-carbon composites, Si-metal composites, Si-polymer composites, Si-ceramic composites, composites comprising various combinations of nanostructured Si, carbon, polymer, ceramic and metal or other types of porous composites comprising nanostructured Si or nanostructured or nano-sized Si particles of various shapes and forms) may reduce volume changes during Li-ion insertion and extraction, which, in turn, may lead to better cycle stability in rechargeable Li-ion cells. In some designs, Si may be doped or heavily doped with nitrogen (N), phosphorus (P), boron (B) or other elements or be allowed with metals. In addition to Si-based composites, silicon oxides (SiOₓ) or oxynitrides (SiOₓN_{y}) or nitrides (SiN_{y}) or phosphides (SiP_{y}) or other Si element-comprising particles (including those that are partially reduced by Li or Mg) may reduce volume changes and improve cycle stability, although commonly at the expense of higher first cycle losses or faster degradation or both. In some designs, Si-comprising anode particles may exhibit high gravimetric lithiation capacities in the range from about 800 mAh/g to about 3000 mAh/g (per mass of Si-comprising anode particles in a Li-free state; in some designs—from about 800 mAh/g to about 1400 mAh/g; in other designs—from about 1400 mAh/g to about 2200 mAh/g; in other designs—from about 2200 mAh/g to about 2600 mAh/g; in other designs—from about 2600 mAh/g to about 3000 mAh/g), as measured in lithium half cells in the potential range for first cycle lithiation from its open circuit potential down to 0.01 V vs. Li/Li⁺ at about C/10 constant current rate with a potential hold at 0.01 V till the current drops to about C/100 and first cycle delithiation from 0.01V to about 1.5V vs. Li/Li⁺ at a C/10 constant current rate). Such high specific capacity is advantageous for attaining lighter batteries. However, Li-ion battery cells with anodes comprising high capacity anode particles of unoptimized particle size distribution (PSD) may exhibit undesirably fast degradation in conventional electrolytes (especially when processed with conventional binders and conductive additives at typical areal capacity loadings), particularly at elevated temperatures or when charged to high voltages (e.g., above about 4-4.3 V). A subset of anodes with Si-comprising anode particles includes anodes with the electrode layer exhibiting capacity in the range from about 400 mAh/g to about 2800 mAh/g (per mass of the electrode layer, not counting the mass of the current collector, in a Li-free state; in some designs—from about 400 mAh/g to about 500 mAh/g; in other designs—from about 500 mAh/g to about 700 mAh/g; in other designs—from about 700 mAh/g to about 1000 mAh/g; in other designs—from about 1000 mAh/g to about 1200 mAh/g; in other designs—from about 1200 mAh/g to about 1500 mAh/g; in other designs—from about 1500 mAh/g to about 2000 mAh/g; in other designs—from about 2000 mAh/g to about 2800 mAh/g). Such a class of charge-storing anodes offer great potential for increasing gravimetric and volumetric energy of rechargeable batteries. However, Li-ion battery cells with anodes comprising high capacity anode particles of unoptimized PSD may exhibit undesirably fast degradation in conventional electrolytes and when processed with conventional binders and conductive additives at typical areal capacity loadings, particularly at elevated temperatures (e.g., battery operating temperatures, e.g., about 50-80° C. or higher) or when charged to high voltages (e.g., above about 4-4.3 V). In addition to Si-comprising anodes, other examples of such high capacity (e.g., nanocomposite) anodes comprising alloying-type (or, more broadly, conversion-type) active materials include, but are not limited to, those that comprise germanium, antimony, aluminum, magnesium, zinc, gallium, arsenic, phosphorus, silver, cadmium, indium, tin, lead, bismuth, their alloys, and others. In addition to anodes comprising active materials in the metallic form, other interesting types of high capacity (including nanocomposite) anodes may comprise metal oxides (including silicon oxide, lithium oxide, etc.), metal nitrides (including silicon nitride, etc.), metal oxy-nitrides (including silicon oxy-nitride, etc.), metal phosphides (including lithium phosphide), metal hydrides, and others.

Li-ion cells with alloying-type (or, more broadly, conversion-type) anode active materials may exhibit undesirably fast degradation in conventional electrolytes, particularly at elevated temperatures or when charged to high voltages (e.g., above about 4-4.3 V) and stored at such voltages at elevated temperatures (e.g., above about 50-80° C.). In some designs, degradation of Li-ion cells with alloying-type (or, more broadly, conversion-type) anode active materials may become particularly undesirably fast for large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more). However, large, or ultra-large or gigantic cells may be particularly attractive for use in some electric transportation or grid storage applications. In some designs, degradation of Li-ion cells with alloying-type (or, more broadly, conversion-type) anode active materials may become particularly undesirably fast for cells comprising medium (e.g., about 3-4 g/Ah) or small (e.g., about 2-3 g/Ah) amount of electrolyte when normalized by total cell capacity. However, using a medium or a small amount of electrolyte may be particularly attractive for reducing cell fabrication costs or certain side reactions and for maximizing energy density of cells. One or more aspects of the present disclosure enables one to mitigate or overcome some or all of such limitations and substantially enhance performance of such Li-ion cells by using certain disclosed electrolyte compositions. One or more aspects of the present disclosure enables one to mitigate or overcome some or all of such limitations and substantially enhance performance of such Li-ion cells by using certain disclosed compositions and certain disclosed properties of active materials. One or more aspects of the present disclosure enables one to mitigate or overcome some or all of such limitations and substantially enhance performance of such Li-ion cells by using certain disclosed PSD of the anode active material particles (e.g., active material particles comprising alloying or conversion-type active materials).

High-capacity (nano) composite anode powders (including, but not limited to those that comprise Si), which exhibit moderately high volume changes (e.g., about 8-about 180 vol. %) during the first charge-discharge cycle, moderate volume changes (e.g., about 5-about 50 vol. %) during the subsequent charge-discharge cycles and an average size in the range from about 0.2 to about 40 μm (for some applications, more preferably from about 0.4 to about 20 μm) may be particularly attractive for battery applications in terms of manufacturability and performance characteristics. In particular, a subclass of such anode powders with specific surface area in the range from about 0.5 m²/g to about 50 m²/g (in some designs, from about 0.5 m²/g to about 2 m²/g; in other designs, from about 2 m²/g to about 12 m²/g; in yet other designs, from about 12 m²/g to about 50 m²/g) performed particularly well in some embodiments. In some designs, electrodes with electrode areal capacity loading from moderate (e.g., from about 2 to about 4 mAh/cm²) to high (e.g., from about 4 to about 12 mAh/cm²) and ultra-high (above about 12 mAh/cm²) are also particularly attractive for use in cells. In some designs, a spheroidal (including near-spherical or spherical) or an ellipsoid (including oblate spheroid) shape of these composite particles may additionally be very attractive for increasing rate performance and volumetric capacity (density) of the electrodes. In other designs, jagged composite particles, cylindrical shaped composite particles or fiber-shaped composite particles or irregularly shaped composite particles may still be used effectively. Unfortunately, unoptimized PSD of such particles may lead to poor performance in batteries.

Higher electrode density and lower binder content, however, are advantageous for increasing cell energy density and reducing cost in certain applications. Lower binder content may also be advantageous for increasing cell rate performance. Larger volume changes lead to inferior performance in some designs, which may be related to damages in the solid electrolyte interphase (SEI) layer formed on the anode, to the non-uniform lithiation and delithiation of the electrode particles within the electrodes, and other factors. Unfortunately, Li and Li-ion battery cells with such anodes having unoptimized PSD of active (e.g., Si-comprising) materials and conventional electrolytes often require the use of such large amounts of conventional SEI-building additives to maintain acceptable cycle stability that prevents their use at elevated or low temperatures or undesirably limits their calendar life or does not allow such cells to be charged to high voltages (e.g., above about 4.1-4.3 V). Performance of such battery cells may become particularly poor when the cells are charged to above about 4.3-4.4 V and even more so when the cells are charged to above about 4.5 V.

Higher cell voltage, broader operational temperature window and longer cycle life, however, are advantageous for most applications. Such cells may suffer from excessive capacity degradation (e.g., above about 5%), large volume expansion (e.g., above about 10%) and significant gassing when exposed to high temperatures (e.g., above about 50-90° C.) in a fully charged state (e.g., about 90-100% state-of-charge, SOC) for a prolonged time (e.g., about 12-168 hours). Passing such elevated temperature charging tests is often required for most applications. In some designs, degradation of Li-ion cells comprising high-capacity (nano) composite anode powders having unoptimized PSD, which exhibit moderately high volume changes during the first charge-discharge cycle, moderate volume changes during the subsequent charge-discharge cycles and an average size in the range from about 0.2 to about 40 μm may become particularly undesirably fast for large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more). In some designs, Li-ion cells with such volume changing anode particles may degrade particularly undesirably fast for cells comprising medium (e.g., about 3-4 g/Ah) or small (e.g., about 2-3 g/Ah) amount of electrolyte when normalized by total cell capacity. One or more embodiments of the present disclosure enables one to mitigate or overcome some or all of such limitations and substantially enhance performance of such Li-ion cells by using certain disclosed electrolyte compositions.

One or more embodiments of the present disclosure overcome some or all of the above-discussed challenges of various types of metal-ion (e.g., Li-ion) cells comprising high-capacity nanocomposite anode active materials (for example, materials comprising conversion-type or alloying-type active materials) that may comprise Si in their composition, may experience certain volume changes during cycling (for example, moderately high volume changes (e.g., about 8-about 160 or about 180 vol. %) during the first charge-discharge cycle and moderate volume changes (e.g., about 5-about 50 vol. %) during the subsequent charge-discharge cycles), may exhibit an average particle size in the range from about 0.2 to about 40 μm and a specific surface area in the range from about 0.5 to about 50 m²/g (in some designs, from about 0.5 to about 2 m²/g; in other designs, from about 2 to about 12 m²/g; in yet other designs, from about 12 to about 50 m²/g), may be formulated with such electrodes in moderate (e.g., about 2-about 4 mAh/cm²) and high areal capacity loadings (e.g., about 4-about 12 mAh/cm²) with high packing density (electrode porosity filled with electrolyte in the range from about 5 to about 35 vol. % after the first charge-discharge cycle) and relatively low binder content (e.g., about 0.5-about 14 wt. %), may comprise moderate or small amount of electrolyte per cell capacity (e.g., less than about 4 g/mAh), may be charged to moderately high (e.g., above about 4.1-4.3 V) or high (e.g., above about 4.3-4.4 V) or very high (e.g., above about 4.5-4.8 V) voltages, may be exposed to temperatures above about 40° C. at high state of charge (e.g., about 70-100% SOC) during testing or operation, may be produced as large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more).

In some designs, swelling of binders in electrolytes depends not just on the binder composition, but may also depend on the electrolyte compositions. Furthermore, in some designs, such swelling (and the resulting performance reduction) often correlates with the reduction in clastic modulus upon exposure of binders to electrolytes. In this sense, the smaller the reduction in modulus in certain electrolytes, the more stable the binder-linked (nano) composite active particles/conductive additives interface becomes. In some designs, the reduction in binder modulus by over about 15-20% may result in a noticeable reduction in performance. In an example, the reduction in the binder modulus by about two times (2×) may result in a substantial performance reduction. In a further example, the reduction in modulus by about five or more times (e.g., about 5×-500×) may result in a very significant performance reduction. Therefore, selecting an electrolyte composition that does not induce significant binder swelling may be highly preferential for certain applications. In some examples, it may be preferred to select an electrolyte composition that reduces the binder modulus by less than about 30% (more preferably, by no more than about 10%) when exposed to electrolyte. In anodes which comprise more than one binder composition, in some designs, it may be preferred to select an electrolyte composition where at least one binder does not reduce the modulus by over about 30% (more preferably, by no more than about 10%) when exposed to electrolyte.

In one or more embodiments of the present disclosure, a preferred battery cell includes a lithium cobalt oxide (LCO) as a cathode active material. In another one or more embodiments of the present disclosure, a preferred battery cell includes a lithium nickel cobalt manganese oxide (NCM) as a cathode active material. In another one or more embodiments of the present disclosure, a preferred battery cell includes a lithium nickel cobalt manganese aluminum oxide (NCMA) as a cathode active material. In another one or more embodiments of the present disclosure, a preferred battery cell includes a lithium nickel cobalt aluminum oxide (NCA) as a cathode active material. In another one or more embodiments of the present disclosure, a preferred battery cell includes a high voltage spinel (e.g., lithium nickel manganese oxide (LNMO) or lithium manganese oxide (LMO)) as a cathode active material. In some designs, LCO, NCM, NCMA, NCA, LNMO or LMO cathode active materials may include the majority (e.g., over 50 wt. %) of single-crystalline powder (or a powder with grain size above around 500 nm; in some designs, above around 1 μm). In some of the preferred examples a surface of LCO, NCM, NCMA, NCA, LMO or LMNO may be coated with a layer of ceramic material. Illustrative examples of a preferred coating material for such cathodes include, but are not limited to, titanium oxide (e.g., TiO₂), aluminum oxide (e.g., Al₂O₃), tungsten oxide (e.g., WO), chromium oxide (e.g., Cr₂O₃), niobium oxide (e.g., NbO or NbO₂) and zirconium oxide (e.g., ZrO₂) and their various mixtures. In some designs, such ceramic materials may additionally comprise lithium (Li)—e.g., as lithium titanium oxide, lithium aluminum oxide, lithium tungsten oxide, lithium chromium oxide, lithium niobium oxide, lithium zirconium oxide and their various alloys, mixtures and combinations. In other preferred examples, LCO, NCM, NCMA, NCA, LMFP, LMP, LMO or LMNO may be doped with Al, Ti, Mg, Nb, Zr, Cr, Hf, Ta, W, Mo or La. In some designs, a preferred cathode current collector material is aluminum or aluminum alloy. In some designs, a preferred battery cell includes a polymer separator. In some of the preferred examples, a polymer separator is made of or comprises polyethylene, polypropylene or a mixture thereof. In some of the preferred examples, a surface of a polymer separator is coated with a layer of ceramic material. Examples of a preferred coating material for polymer separators may include, but not limited to titanium oxide (TiO₂), aluminum oxide (Al₂O₃), aluminum hydroxide or oxyhydroxide, zirconium oxide (ZrO₂), magnesium oxide (MgO) or magnesium hydroxide or oxyhydroxide. In some designs, a preferred battery cell may include a silicon- and carbon-comprising nanocomposite (e.g., as used herein, a nanocomposite or (nano) composite is at least partially comprised of active material nanomaterials or nanostructures or nanoparticles, irrespective of whether the nanocomposite or (nano) composite itself is a nanomaterial) or silicon (SiOₓ, x≥0) or natural or synthetic graphite or soft carbon or hard carbon or their various mixtures and combinations in its anode composition. In some of the preferred examples, the anode active material includes a mixture of silicon- and carbon-comprising nanocomposite (sometimes abbreviated herein as Si—C nanocomposite) and graphite (e.g., the graphite being distinct from the C-part of the Si—C nanocomposite). In some implementations, a Si—C nanocomposite comprises composite particles, which may include Si nanoparticles embedded in pores (e.g., surface pores or internal pores such as closed internal pores or open internal pores) of a porous carbon scaffold particle. Such a porous carbon scaffold particle may comprise (e.g., curved or defective) graphene material and/or graphite material. In some designs, a preferred anode current collector may comprise copper or copper alloy.

In one or more embodiments of the present disclosure, a preferred anode for a battery cell may comprise a mixture of Si—C nanocomposite (particles) and graphite (particles) as the anode active material, a so-called blended anode. In addition to the anode active material, an anode may comprise inactive material, such as binder(s) (e.g., polymer binder) and other functional additives (e.g., surfactants, electrically conductive additives). In some implementations, the anode active material (particles) may be in a range of about 90 wt. % to about 98 wt. % of the anode. For example, the anode active material (particles) may be about 95.5 wt. % of the anode, in some designs.

In some designs, a blended anode may comprise from about 7 wt. % of Si—C nanocomposite to about 97 wt. % of the Si—C nanocomposite (e.g., particles). While the descriptions below may also describe certain examples of the blended anode formulations expressed as mass (wt. %) of Si—C nanocomposite (e.g., particles) relative to the total weight of Si—C composite and graphite (e.g., particles) in a blend, it will be appreciated that various aspects of this disclosure may be applicable to blended anode formulations expressed as wt. % of Si in the anode (e.g., including the weight of conductive and other additives, binder, Si-comprising composites such as Si—C nanocomposites, and graphite). For example, in some implementations, a blended anode composition of about 7 wt. % of Si—C nanocomposite (e.g., particles) corresponds to about 3-3.5 wt. % of Si in the blended anode. In some implementations, a blended anode composition of about 19 wt. % of Si—C nanocomposite (e.g., particles) corresponds to about 8-10 wt. % of Si in the blended anode. In some implementations, a blended anode composition of about 35 wt. % of Si—C nanocomposite (e.g., particles) may correspond to about 15-18 wt. % of Si in the blended anode. In some implementations, a blended anode composition of about 50 wt. % of Si—C nanocomposite (e.g., particles) may correspond to about 21-30 wt. % of Si in the blended anode. In respective implementations, blended anodes may be obtained in which the mass (weight) of the silicon is in a range of about 3 wt. % to about 30 wt. % of a total mass of the anode. Herein, the term “total mass of the anode” is used to refer to the mass of the anode only, excluding any anode current collector foil or separator. The masses of the current collector and the separator are excluded from the mass of the anode even if the current collector and the separator are attached to the anode.

In some designs, a blended anode may comprise Si—C nanocomposite (e.g., particles) that provides from about 25% of to about 99.5% of the total anode capacity. While the descriptions below may also describe certain examples of the blended anode formulations expressed as mass (wt. %) of Si—C nanocomposite (e.g., particles), it will be appreciated that various aspects of this disclosure may be applicable to blended anode formulations attributing a fraction (e.g., %) of the total capacity of the blended anode to the capacity of the Si. For example, in some implementations, about 25% of the total capacity of the blended anode may be obtained from the Si—C nanocomposite (e.g., particles) in a blended anode composition of about 7 wt. % of Si—C nanocomposite (e.g., particles). In some other implementations, about 50% of the total capacity of the blended anode may be obtained from the Si—C nanocomposite (e.g., particles) in a blended anode composition of about 19 wt. % of Si—C nanocomposite (e.g., particles). In some other implementations, about 70% of the total capacity of the blended anode may be obtained from the Si—C nanocomposite (e.g., particles) in a blended anode composition of about 35 wt. % of Si—C nanocomposite (e.g., particles). In some other implementations, about 80% of the total capacity of the blended anode may be obtained from the Si—C nanocomposite (e.g., particles) in a blended anode composition of about 50 wt. % of Si—C nanocomposite (e.g., particles).

In some implementations, blended anodes may comprise Si—C nanocomposites (e.g., particles) ranging from about 7 wt. % to about 99 wt. % of the anode active material particles and the graphite particles making up the remainder of the mass (the weight) of the anode active material particles. In some implementations in which the anode active material particles are about 95.5 wt. % of the blended anode, the blended anode (including active material particles and inactive material) may comprise about 7 wt. % of Si—C nanocomposite (e.g., particles) and about 88.5 wt. % of graphite (e.g., particles), about 19 wt. % of Si—C nanocomposite (e.g., particles) and about 76.5 wt. % of graphite (e.g., particles), about 35 wt. % of Si—C nanocomposite (e.g., particles) and about 60.5 wt. % of graphite (e.g., particles), or about 50 wt. % of Si—C nanocomposite (e.g., particles) and about 45.5 wt. % of graphite (e.g., particles, with the graphite particles being separate from the C-part of the Si—C nanocomposite in all cases). In some of the preferred examples in which the anode active material particles are about 90 wt. % or more of the blended anode, the anode active material composition may comprise a small (e.g., about 1-20 wt. %, preferably about 1-10 wt. %, and even more preferably about 1-5 wt. %) fraction of graphite (e.g., particles, with the graphite particles being distinct from the C-part of the Si—C nanocomposite).

In some of the illustrative examples in which the anode active material particles are about 90 wt. % of the anode, the anode active material particle composition may consist almost entirely of Si—C nanocomposite (e.g., particles) and is substantially free of graphite particles (e.g., <about 1 wt. %) (e.g., the graphite particles being distinct from the C-part of the Si—C nanocomposite).

In some of the illustrative examples in which the anode active material particles are about 96.5 wt. % of the anode, the anode active material particle composition may consist almost entirely of graphite and is substantially free of Si—C nanocomposite (e.g., <about 1 wt. %).

In one or more embodiments of the present disclosure, an electrolyte comprising esters and/or carbonates (e.g., cyclic carbonates, linear carbonates) may be employed in a lithium-ion battery cell. The lithium-ion battery comprises an anode current collector (e.g., a foil of copper or copper alloy), a cathode current collector (e.g., a foil of aluminum or aluminum alloy), an anode disposed on or in the anode current collector, a cathode disposed on or in the cathode current collector, and any of the foregoing electrolytes ionically coupling the anode and the cathode. In some examples, a separator (e.g., a separator film or coating) may be disposed between the anode and the cathode, with at least some of the electrolyte infiltrating or impregnating the separator. The anode may comprise any suitable anode material(s) as described herein. For example, the anode may comprise silicon-carbon composite particles comprising silicon and carbon (e.g., mostly graphitic, sp²-bonded carbon). In some implementations, a mass of the silicon may be in a range of about 3 wt. % to about 80 wt. % of a total mass of the anode. In some cases, at least some of the silicon may be present in the silicon-carbon composite particles as nanosized or nanostructured silicon. For example, the anode may comprise graphitic carbon particles comprising carbon. In some cases, the graphitic carbon particles may be substantially free of silicon. In some cases, the silicon-carbon composite particles and the graphitic carbon particles may both be present in an anode.

In one illustrative example, Li-ion battery cell with capacity of about 0.028 Ah may comprise: (i) an anode with about 100% by capacity Si—C nanocomposite active material (e.g., particles) (with specific reversible capacity of about 1600 to about 1700 mAh/g when normalized by the weight of active materials in the anode), which corresponds to about 40 to about 44 wt. % of silicon mass fraction in the Si—C composite particles casted on Cu current collector foil from a water-based suspension comprising a polyacrylic acid (PAA) salt copolymer-based binder and about 0.1% carbon black conductive additive, (ii) a cathode with high-voltage lithium cobalt oxide (LCO) active material (with specific reversible capacity of about 170 mAh/g when normalized by the weight of active materials in the cathode) casted on A1 current collector foil from an organic solvent suspension comprising a polyacrylic acid (PAA)-based binder and a carbon black conductive additive, anode: cathode areal capacity ratio of about 1.15:1 and areal reversible capacity loading of about 3.5 mAh/cm², charge voltage of about 4.4V, (iii) a polymer-ceramic separator, and (iv) an electrolyte ELY #1 comprising: about 15 mol. % of FEC, about 44 mol. % of ethyl propionate (EP) (linear ester), about 7 mol. % of LiPF₆, about 24 mol. % of non-fluorinated cyclic carbonates, about 7 mol. % of diethyl carbonate (DEC), and about 3 mol. % of other compounds.

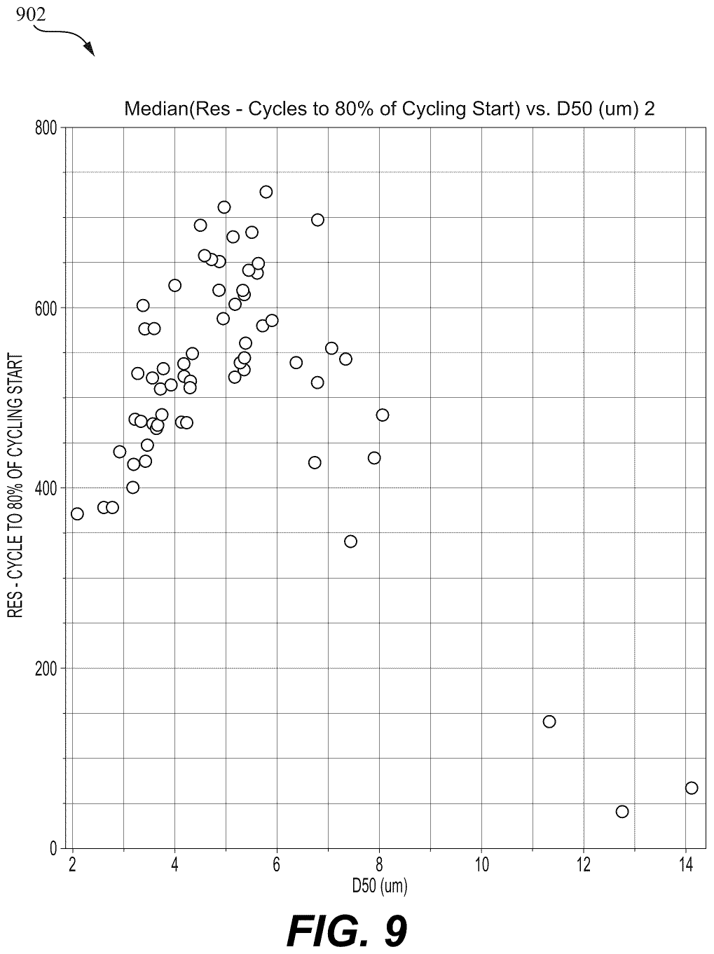

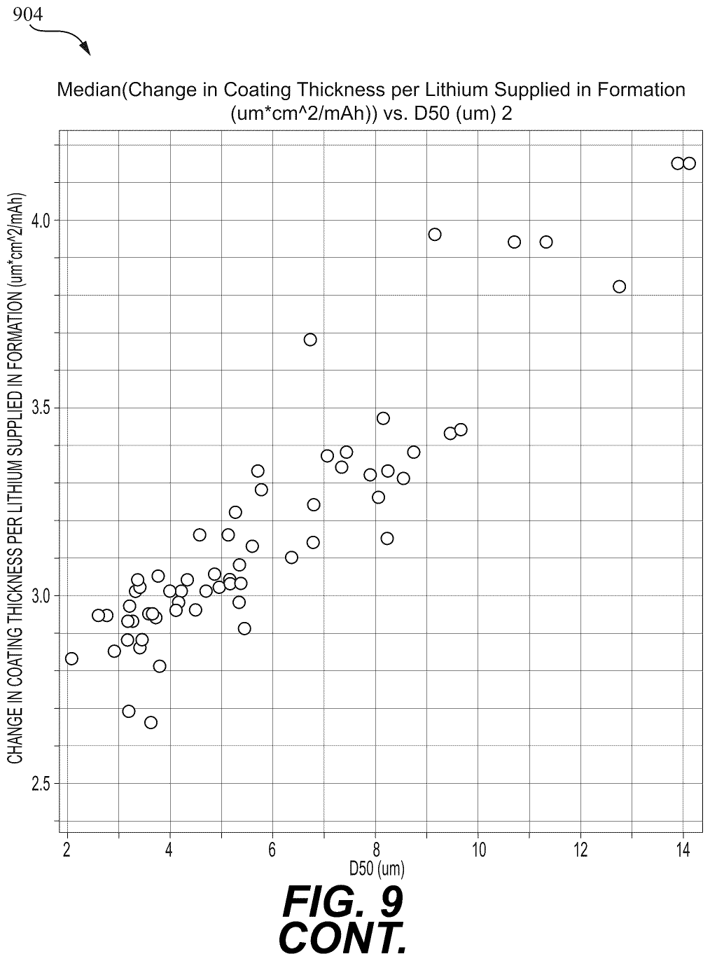

Li-ion battery test cells (with LCO cathodes, as described above) comprising the example nanocomposite particles (where all anode capacity was provided by Si—C nanocomposite particles) were tested in a cycle life test. The test cells were fabricated, and an initial formation procedure was carried out on the test cells. Charge/discharge test conditions comprise constant current, constant potential (CCCP) at 2 C charge to 4.0V and taper to 1 C, followed by the CCCP at 1 C charge to 4.2V and taper to 0.05C, followed by 1 C discharge. Graphical plot 902 (FIG. 9) shows the number of cycles to reach 80% of cycling start capacity (during cycling at 25° C.), also sometimes referred to as cycle life (also referred to as “N80”), as a function of D₅₀ of each respective population of jagged composite particles. The cycling start capacity is defined as the capacity upon completion of the third cycle. Some test cells with larger particles (e.g., D₅₀ greater than about 10 μm) exhibited poor cycle life values (e.g., less than about 200 cycles). On the other hand, test cells with smaller particles (e.g., D₅₀ in a range of about 2.0 μm to about 8.0 μm) exhibited better cycle life values (e.g., greater than 340 cycles or in a range of about 340 cycles to about 729 cycles). Accordingly, in some implementations (e.g., where all or nearly all capacity is provided by Si—C composite particles), there may be beneficial effects (e.g., better cycle life) in adopting jagged composite particle populations with D₅₀ values in a range of about 2.0 μm to about 8.0 μm (particularly when cell charging rates are comparable or faster). For larger particles (e.g., D₅₀ greater than about 10 μm), one potential degradation pathway may be that there is a mechanical failure of the electrode coating after multiple charge/discharge cycles attributable in part to a poor packing of the jagged composite particles in the coating (e.g., consider the large interstitial pores in between particles in SEM image 804 of FIG. 8). In addition, larger particles may exhibit higher charge transfer resistance and may, in some cases (e.g., when tested in cold climates or low temperatures and/or when anodes are constructed to exhibit moderate to high areal capacity loadings (e.g., about 2-12 mAh/cm²), etc.), induce Li plating when cells are charged at fast rates. For smaller particles (e.g., D₅₀ in a range of about 2.0 μm to about 8.0 μm), one possible degradation pathway may be that the surface area (of the particles) exposed to the electrolyte increases with decreasing particle size, leading to greater occurrence of unwanted side reactions between the electrolyte and the particles (e.g., excessive SEI growth).

Graphical plot 904 (FIG. 9) shows a dependence of a normalized coating thickness change of anodes of test cells on D₅₀ of each of the example particle populations. The normalized coating thickness change is defined as the coating thickness change (expressed in μm), divided by the quantity of lithium ions per unit area of electrode inserted into the electrode (anode) in going from the discharged state to the charged state (expressed in mAh/cm²) (e.g., during the so-called “formation” cycle). The coating thickness change is the difference in coating thickness between the charged state at cycle 4 and the as-prepared electrode coating. The coating thickness is measured, using a high-accuracy digital contact sensor (with approximately 0.1 μm resolution), on test cells after undergoing four charge/discharge cycles. The normalized coating thickness change may be regarded as a quantitative measurement of the degree of swell of an electrode coating, particularly the degree of swell in the thickness direction. Graphical plot 904 shows that the normalized thickness change (i.e., degree of swell in the electrode thickness direction, or z-swell) tends to decrease as D₅₀ decreases. Accordingly, the normalized thickness change can be reduced by adopting jagged composite particle populations with D₅₀ values in a range of about 2.0 μm to about 8.0 μm, or in a range of about 2.0 μm to about 6.0 μm, or in a range of about 2.0 μm to about 5.0 μm, or in a range of about 2.0 μm to about 4.0 μm. The normalized thickness change may be in a range of about 2.5 to about 3.0 μm/(mAh/cm²) for populations with D₅₀ values in a range of about 2.0 μm to about 4.0 μm. In addition to the particle D₅₀ size, the swell may also depend on the binder properties, particle size distribution, active particles' capacity and the fraction of Si, particle density, particles' shape and aspect ratio and overall slurry composition (including, for example, the fraction and type of graphite if used in a blended anode; the fraction and type of conductive additives; the fraction and type of the binder, etc.). However, the general trends of smaller swell for smaller Si-comprising composite particles D₅₀ were found to be consistent and thus has to be chosen accordingly. The maximum allowed thickness change depends on the cell construction. In general, however, smaller swell may be beneficial to attaining improved cell stability. In some cell designs, the anode swell may preferably be smaller than 4.5 μm per mAh/cm² (<about 4.5 cm² μm/mAh). In other designs, the anode swell may preferably be smaller than 3.5 μm per mAh/cm² (<about 3.5 cm² μm/mAh). In other designs, the anode swell may preferably be smaller than 3.0 μm per mAh/cm² (<about 3.0 cm² μm/mAh). In other designs, the anode swell may preferably be smaller than about 2.75 μm per mAh/cm² (<about 2.75 cm² μm/mAh). In yet other designs, the anode swell may preferably be smaller than about 2.5 μm per mAh/cm² (<2.5 cm² μm/mAh).

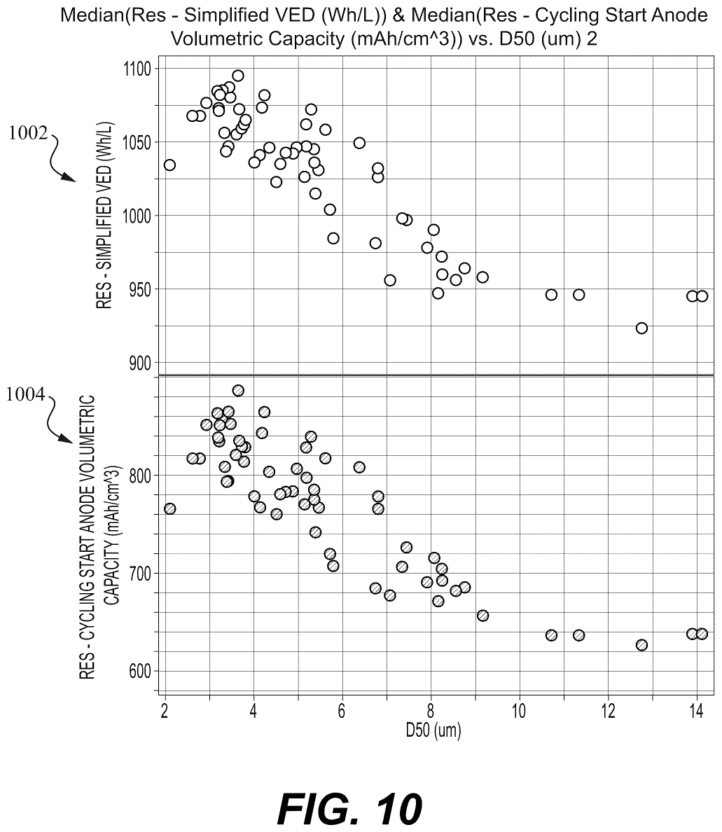

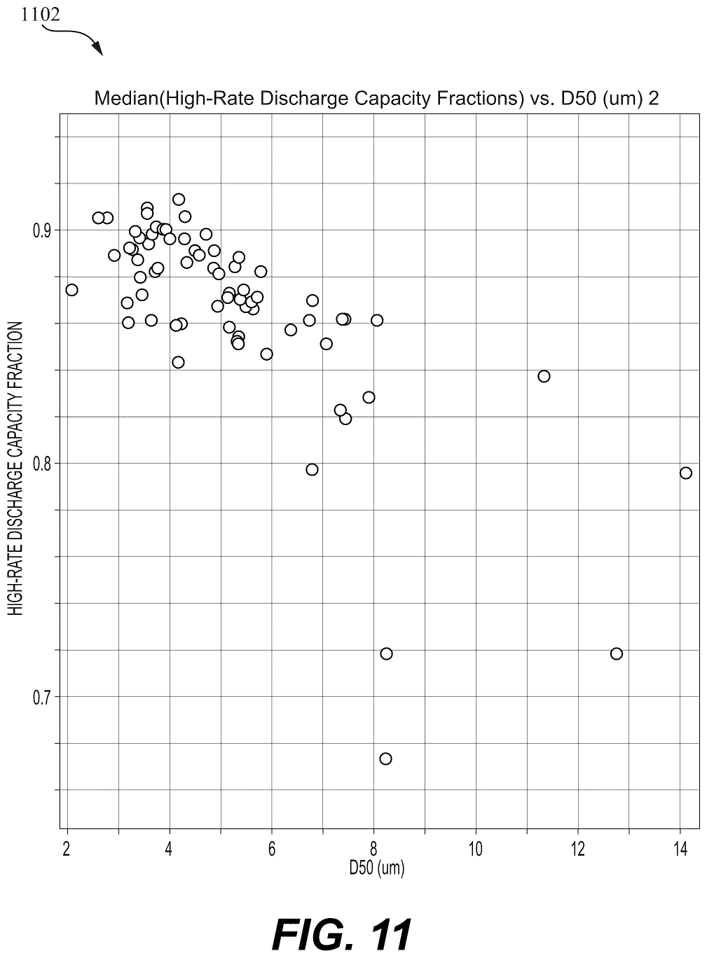

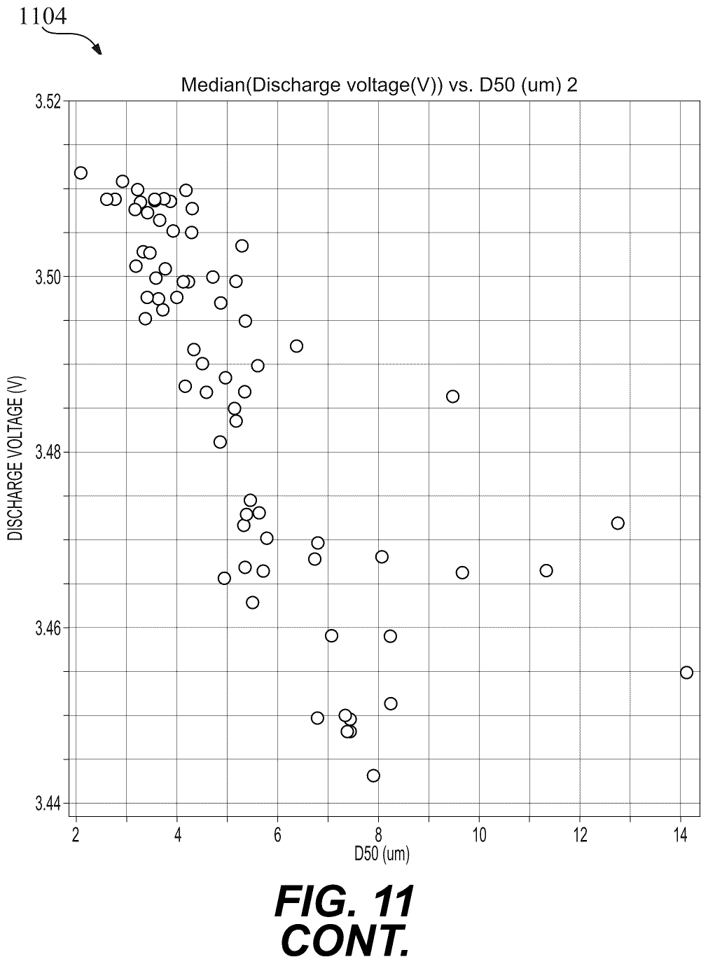

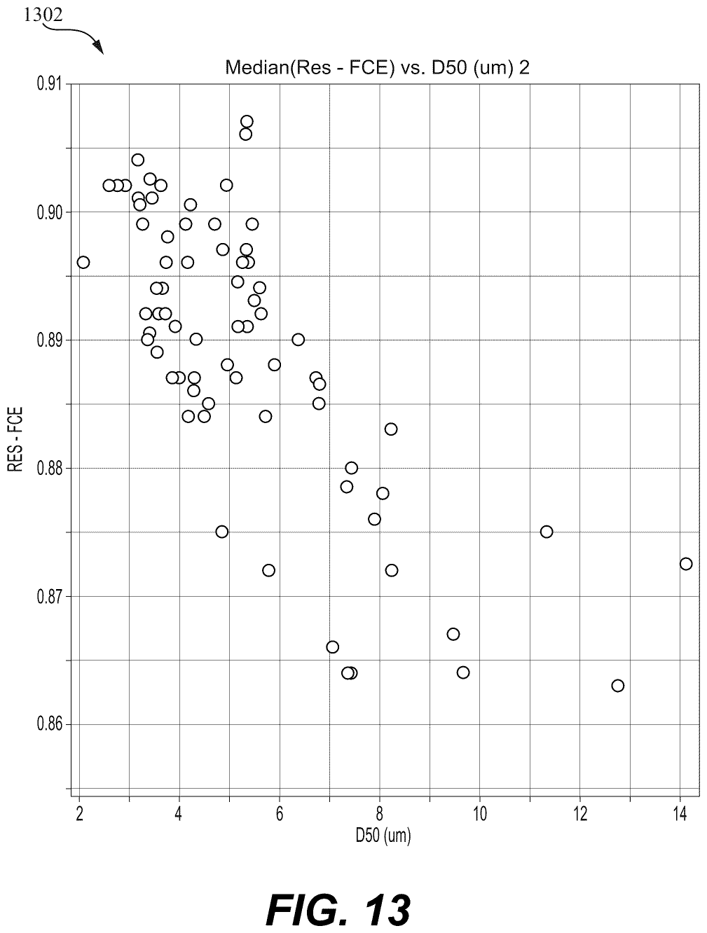

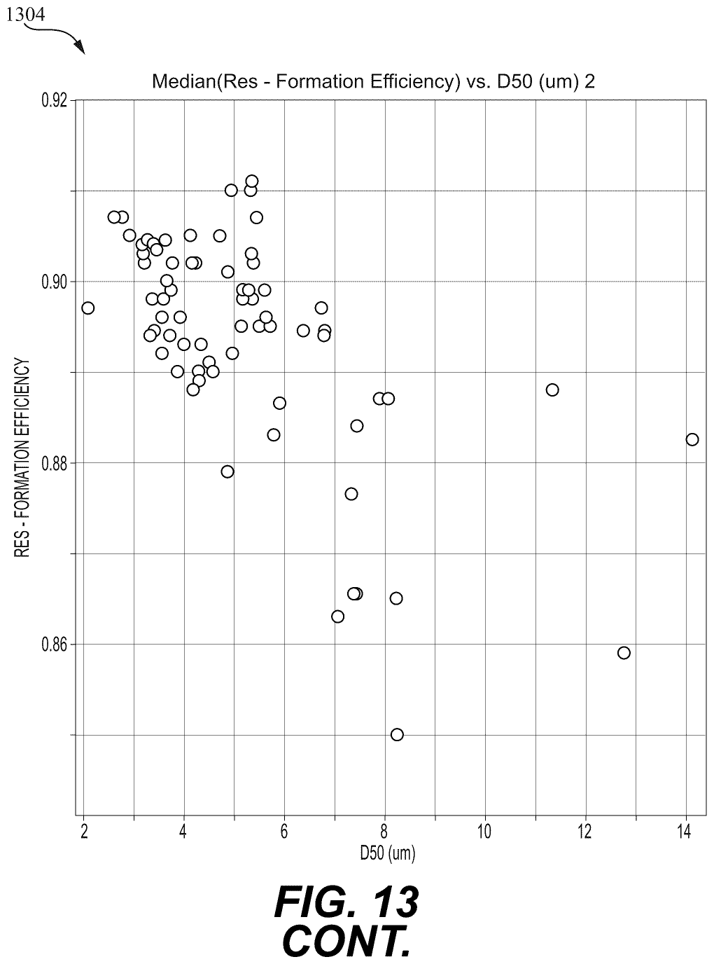

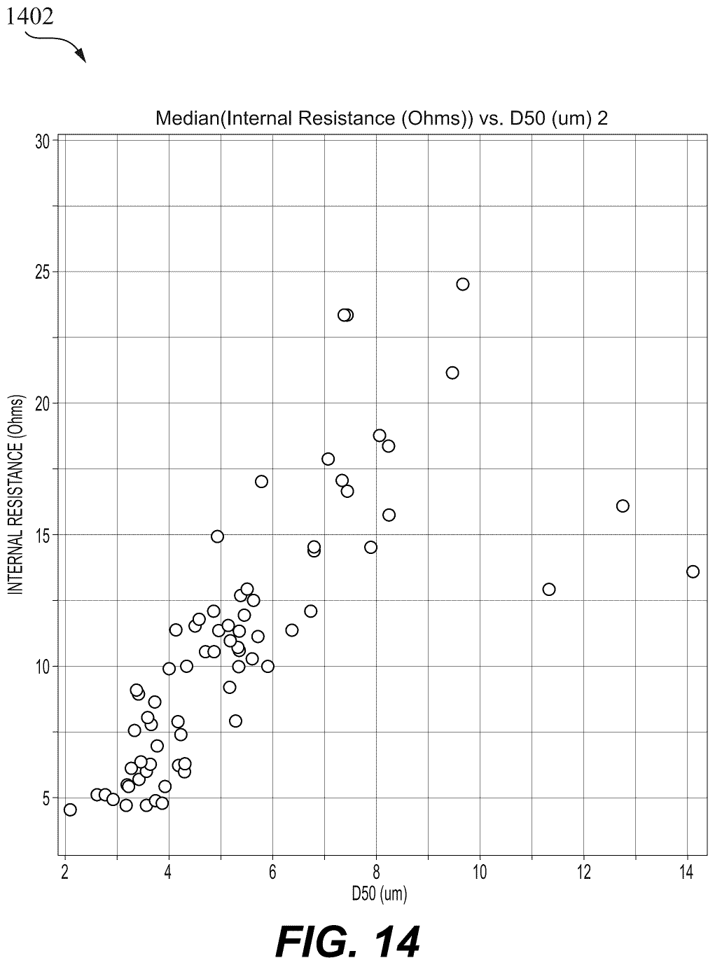

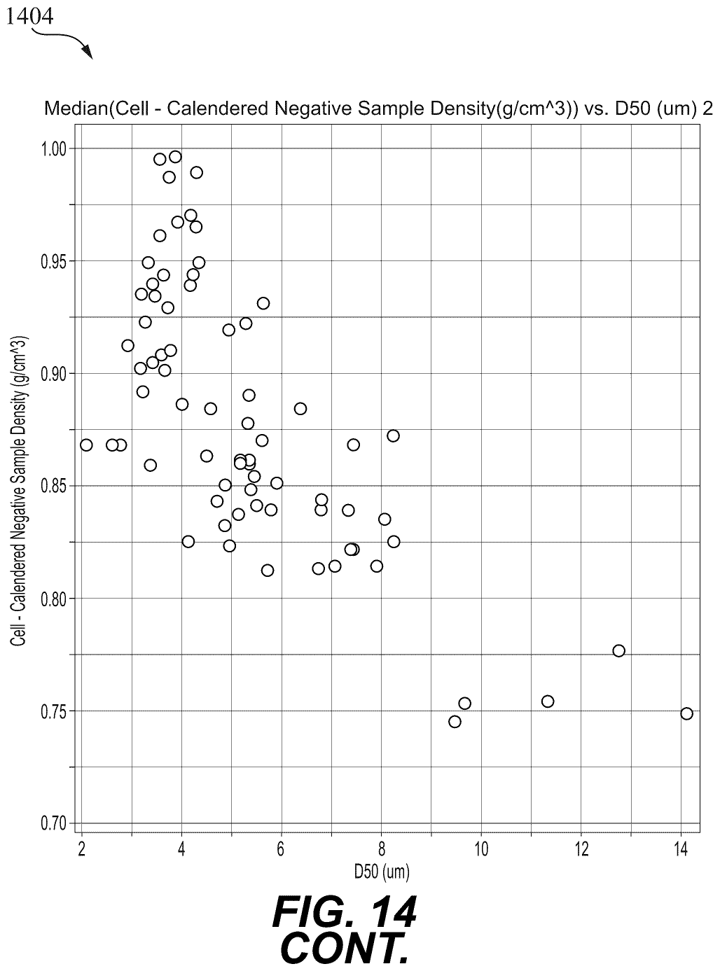

FIG. 10 shows a graphical plot 1002 of a dependence of a volumetric energy density (sometimes abbreviated as VED) of test cells on D₅₀ of each of the example particle populations and a graphical plot 1004 of a dependence of a volumetric charge density (sometimes abbreviated as VQD) of test cells on D₅₀ of each of the example particle populations (note that in these test cells all or nearly all anode capacity was provided by Si—C composite particles and no graphite was added into the anode). VQD is defined as the anode capacity (after the fourth cycle) (expressed in mAh) divided by anode volume (expressed in cm³). VED is defined as the cell energy (after the fourth cycle) (expressed in Wh) divided by the cell's external volume (expressed in liters). Test cells with smaller particles tend to exhibit higher VED and VQD values. For example, a test cell with jagged composite particle population of D₅₀ values of about 3.6 μm exhibited a VED of about 1095 Wh/l and VQD of about 886 mAh/cm³. Accordingly, the VED and/or the VQD may be increased by adopting jagged composite particle population with D₅₀ values in a range of about 2.0 μm to about 8.0 μm, or in a range of about 2.0 μm to about 6.0 μm, or in a range of about 2.0 μm to about 5.0 μm, or in a range of about 2.0 μm to about 4.0 μm. Several factors may be contributing to the higher VED and VQD values exhibited by test cells with smaller jagged composite particles. For example, one factor may be the reduced z-swell in the test cells with smaller particles (e.g., see plot 904 of FIG. 9). For example, another factor may be the higher first-cycle efficiency in test cells with smaller particles (e.g., see plot 1302 in FIG. 13). For example, yet another factor may be the higher formation efficiency in test cells with smaller particles (e.g., see plot 1304 in FIG. 13). For example, yet another factor may be the lower internal resistance in test cells with smaller particles (e.g., see plot 1402 in FIG. 14). For example, yet another factor may be the higher electrode (anode) coating density in test cells with smaller particles (e.g., see plot 1404 in FIG. 14). For example, yet another factor may be the higher discharge voltage in test cells with smaller particles (e.g., see plot 1104 in FIG. 11). In addition to the particle D₅₀ size, the VED may also depend on the binder properties, particle size distribution (PSD), active particles' capacity and the fraction of Si, particle density, particles' shapes and aspect ratios, and/or overall slurry composition (including, for example, the fraction and type of graphite; the fraction and type of conductive additives; the fraction and type of the binder, etc.), among other factors. However, the general trends of VED dependence on Si-comprising composite particles D₅₀ were found to be consistent and thus, in some designs, the D₅₀ has to be chosen accordingly.

FIG. 11 shows a graphical plot 1102 of a dependence of a normalized high-rate discharge capacity of test cells on D₅₀ of each of the example particle populations and a graphical plot 1104 of a dependence of a discharge voltage of test cells on D₅₀ of each of the example particle populations (note that in these test cells all or nearly all anode capacity was provided by Si—C composite particles and no graphite was added into the anode). Normalized high-rate discharge (in this case, 2C discharge) capacity is defined as the discharge capacity of the cell measured after 2C discharge divided by the discharge capacity of the cell measured after 0.5C discharge, with the measurements being carried out after 20 cycles. Some test cells with jagged composite particle populations with D₅₀ values in a range of about 2.0 μm to about 5.0 μm exhibited normalized high-rate discharge capacity greater than about 90%. A higher normalized high-rate discharge capacity (e.g., about 90% or higher) may be attributable to better impedance metrics (e.g., lower impedance) and/or better ion diffusion metrics due to thinner electrode coatings and/or reduced diffusion lengths at the particle (e.g., a smaller particle with ion diffusivity similar to a larger particle may have reduced diffusion length scales). Discharge voltage is defined as the discharge energy (Wh) divided by discharge capacity (Ah). Some test cells with jagged nanocomposite particle populations with D₅₀ values in a range of about 2.0 μm to about 5.0 μm exhibited discharge voltages greater than about 3.5 V. Accordingly, the normalized high-rate discharge capacity and/or the discharge voltage may be increased by adopting jagged composite particle populations with D₅₀ values in a range of about 2.0 μm to about 8.0 μm, or in a range of about 2.0 μm to about 6.0 μm, or in a range of about 2.0 μm to about 5.0 μm. In addition to the particle D₅₀ size, the discharge voltage and the high-rate discharge capacity may also depend on the binder properties, particle size distribution (PSD), active particles' capacity and the fraction of Si, particle density, design of Si-comprising nanocomposite particles, particles' shapes and aspect ratios, the BET-SSA of the particles, and the overall slurry composition (including, for example, the fraction and type of graphite; the fraction and type of conductive additives; the fraction and type of the binder, etc.), among other factors. However, the general trends of discharge voltage and the high-rate capacity dependence on Si-comprising nanocomposite particles D₅₀ were found to be consistent and thus, in some designs, the D₅₀ has to be chosen accordingly to meet the required cell design specifications.

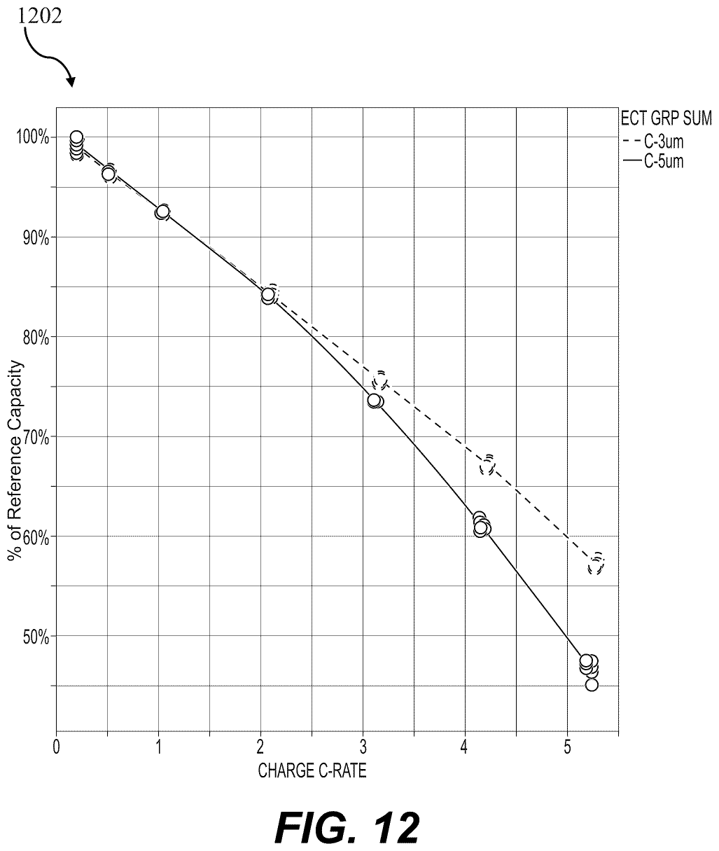

FIG. 12 shows a graphical plot 1202 of a dependence of a normalized capacity (also referred to as % of reference capacity) for lithium-ion battery test cells (with LCO cathodes, as described above) comprising jagged nanocomposite particle populations of D₅₀ of about 3 μm and about 5 μm (note that in these test cells all or nearly all anode capacity was provided by Si—C composite particles and no graphite was added into the anode). The normalized capacity is defined as the charge capacity obtained for a given charge rate (expressed in mAh) normalized to cycling start capacity (capacity upon completion of cycle 3) (expressed in mAh). For each respective charging condition, the cell was cycled for a minimum of 5 cycles to obtain an average capacity. Accordingly, the normalized capacity at faster charge rates (e.g., charge rates of more than about 2C, or more than about 3C, or more than about 4C, or more than about 5C) may be increased by adoption of a jagged composite particle population with D₅₀ values in a range of about 2.0 μm to 4.0 μm. A higher normalized capacity may be attributable to better impedance metrics (e.g., lower impedance) and/or better ion diffusion metrics (e.g., higher ion diffusivity).

FIG. 13 shows a graphical plot 1302 of a dependence of a first-cycle efficiency of test cells on D₅₀ of each of the example particle populations and a graphical plot 1304 of a dependence of a formation efficiency of test cells on D₅₀ of each of the example particle populations (note that in these test cells all or nearly all anode capacity was provided by Si—C composite particles and no graphite was added into the anode). First-cycle efficiency is defined as the first-cycle discharge capacity divided by the first-cycle charge capacity. Some test cells with jagged nanocomposite particle populations with D₅₀ values in a range of about 2.0 μm to about 6.0 μm exhibited first-cycle efficiencies greater than about 90%. Formation efficiency is defined as cycling start discharge capacity (discharge capacity upon completion of cycle 3) divided by the first cycle charge capacity. Some test cells with jagged nanocomposite particle populations with D₅₀ values in a range of about 2.0 μm to about 6.0 μm exhibited formation efficiencies greater than about 90%. Accordingly, the first-cycle efficiency and/or the formation efficiency may be increased by adopting jagged composite particle populations with D₅₀ values in a range of about 2.0 μm to about 6.0 μm. A higher first-cycle efficiency (e.g., greater than about 90%) and/or a higher formation efficiency (e.g., greater than about 90%) may be attributable to better impedance metrics (e.g., lower impedance) and/or better ion diffusion metrics (e.g., higher ion diffusivity) which result in reduction of losses.

In addition to the particle D₅₀ size, the first cycle efficiency, formation efficiency, and normalized capacity may also depend on the binder properties, particle size distribution (PSD), active particles' capacity and the fraction of Si, particle density, design of Si-comprising nanocomposite particles, the presence of Li-trapping sites or (e.g., electronegative) elements in the Si-comprising composite particles' composition, particles' shapes and aspect ratios, the BET-SSA of the particles, and/or the overall slurry composition (including, for example, the fraction and type of graphite, if used in blended anodes; the fraction and type of conductive additives; the fraction and type of the binder, etc.), among other factors. However, the general trends of the dependence of normalized capacity (capacity retention), first cycle efficiency, and formation efficiency on Si-comprising nanocomposite particles D₅₀ were found to be generally consistent and thus, in some designs, the D₅₀ has to be chosen accordingly to meet the required cell design specifications.

FIG. 14 shows a graphical plot 1402 of a dependence of an internal resistance of test cells on D₅₀ of each of the example particle populations and a graphical plot 1404 of a dependence of a coating density of electrode coatings on D₅₀ of each of the example particle populations. Internal resistance is determined as follows: A series of millisecond-long current pulses are applied to the cell at a 0% state-of-charge, and the resulting voltages are measured. An average voltage is determined by averaging over the respective voltages that are measured for each of the current pulses. The internal resistance is the average voltage divided by the applied current. Test cells with smaller particles tended to exhibit lower internal resistance. For example, some test cells with jagged nanocomposite particle populations with D₅₀ values in a range of about 2.0 μm to about 6.0 μm exhibited internal resistance values of less than about 10Ω. For example, some test cells with jagged nanocomposite particle populations with D₅₀ values in a range of about 2.0 μm to about 4.0 μm exhibited internal resistance values in a range of about 4Ω to about 6Ω. The coating density includes the jagged nanocomposite particles, the binder, and any additives in the electrode but excludes the current collector. The coating density is defined as the mass of the electrode divided by the volume of the electrode. Electrode coatings with smaller particles tended to exhibit higher coating density. For example, some electrode coatings with jagged nanocomposite particle populations with D₅₀ values in a range of about 2.8 μm to about 6.0 μm exhibited electrode coating density values in a range of about 0.9 g/cm³ to about 1.0 g/cm³. For example, some electrode coatings with jagged nanocomposite particle populations with D₅₀ values in a range of about 3.0 μm to about 5.0 μm exhibited electrode coating density values in a range of about 0.95 g/cm³ to about 1.0 g/cm³.

Note that in addition to the particle D₅₀ size, the coating density and internal resistance may also depend on the binder properties, particle size distribution (PSD), active particles' capacity and the fraction of Si, particle density, design and composition of Si-comprising nanocomposite particles, the conductivity of Si-comprising composite particles' surface, the fraction of binder coating the external surface area of the particles, particles' shapes and aspect ratios, the BET-SSA of the particles, the overall slurry composition (including, for example, the fraction and type of graphite, if used in blended anodes; the fraction and type of conductive additives; the fraction and type of the binder, etc.), among other factors. However, the general trends of coating density and internal resistance dependence on Si-comprising nanocomposite particles D₅₀ were found to be generally consistent and thus, in some designs, the D₅₀ may be chosen accordingly to meet the required cell design specifications.

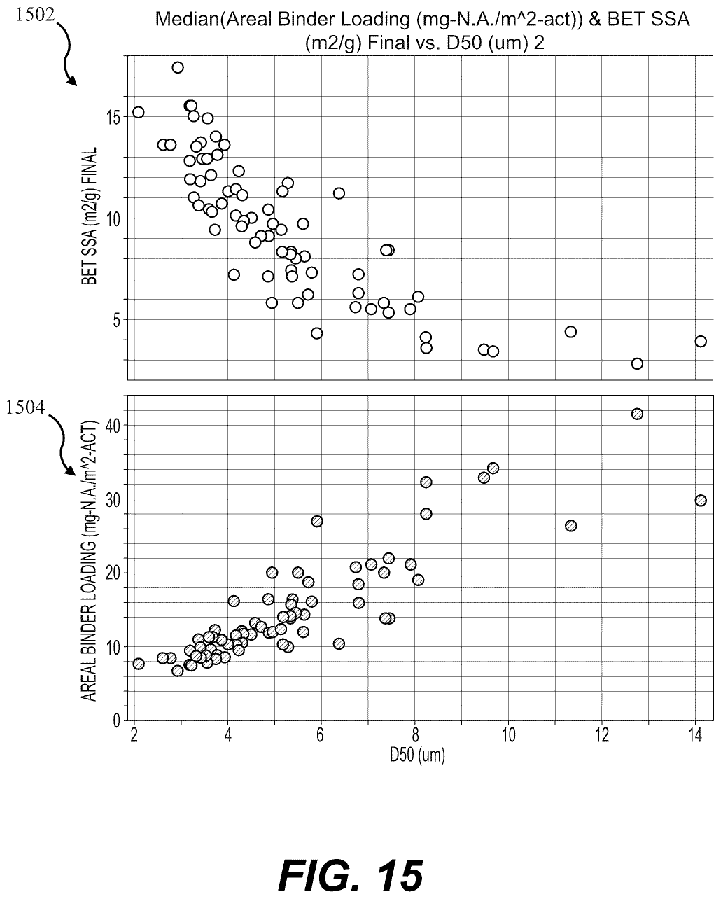

FIG. 15 shows a graphical plot 1502 of a dependence of a Brunauer-Emmett-Teller specific surface area (BET-SSA), as measured by analyzing N₂ sorption-desorption isotherms at 77K, on D₅₀ of each of the example particle populations and a graphical plot 1504 of a dependence of an areal binder loading on D₅₀ of each of the example particle populations. The BET-SSA of each example population of jagged nanocomposite particles was measured by nitrogen gas physisorption (around 77 K) of powder samples that had been degassed at 300° C. for 10 hours under vacuum. The BET-SSA tends to increase as the particle size (e.g., D₅₀) decreases. For example, some jagged nanocomposite particle populations with D₅₀ values in a range of about 2.0 μm to about 4.0 μm exhibit BET-SSA values in a range of about 8 to about 18 m²/g. For example, some jagged nanocomposite particle populations with D₅₀ values in a range of about 4.0 μm to about 6.0 μm exhibit BET-SSA values in a range of about 3 to about 14 m²/g. For example, some jagged nanocomposite particle populations with D₅₀ values in a range of about 6.0 μm to about 8.0 μm exhibit BET-SSA values in a range of about 3 to about 12 m²/g. The areal binder loading of an electrode coating is defined as the mass fraction of the binder in the electrode coating, divided by a product of (1) the mass fraction of the jagged composite particles in the electrode coating, and (2) the BET-SSA value of the respective jagged composite particle population. In the graphical plot 1504, the areal binder loading is expressed in units of mg/m². In the examples shown, the areal binder loading tends to decrease as the particle size (e.g., D₅₀) decreases. In smaller particles (e.g., D₅₀ ranging between about 2.0 μm to about 4.0 μm), there is a tendency for less binder per unit surface area of composite particles due to their high BET-SSAs. For example, some jagged composite particle populations with D₅₀ values in a range of about 2.0 μm to about 4.0 μm result in areal binder loading values for the corresponding electrode coatings in a range of about 5 to about 14 mg/m². For example, some jagged composite particle populations with D₅₀ values in a range of about 4.0 μm to about 6.0 μm result in areal binder loading values for the corresponding electrode coatings in a range of about 6 to about 22 mg/m². For example, some jagged composite particle populations with D₅₀ values in a range of about 6.0 μm to about 8.0 μm result in areal binder loading values for the corresponding electrode coatings in a range of about 8 to about 24 mg/m². There may be beneficial effects resulting from the lower areal binder loading on impedance metrics and/or ion diffusion metrics. In some embodiments, an areal binder loading of the battery electrode (e.g., anode comprising Si—C nanocomposite particles) is in a range of about 2.0 mg/m² to about 15.0 mg/m² (e.g. in some designs, from about 2.0 mg/m² to about 5.0 mg/m²; in other designs, from about 5.0 mg/m² to about 9.0 mg/m²; in yet other designs, from about 9.0 mg/m² to about 13.0 mg/m²).

In some implementations, lithium-ion battery cells comprising anodes comprising smaller jagged composite particles with D₅₀ values in a range of about 2.0 μm to about 4.0 μm exhibit favorable characteristics such as smaller z-swelling (e.g., plot 904), higher VED (e.g., plot 1002), higher VQD (e.g., plot 1004), faster discharge (e.g., plot 1102), faster charge (e.g., plot 1202), higher discharge voltage (e.g., plot 1104), and lower internal resistance (e.g., plot 1402). However, in some implementations, some lithium-ion battery cells comprising anodes comprising larger jagged composite particles with D₅₀ values in a range of about 4.0 μm to about 7.0 μm or in a range of about 4.0 μm to about 6.0 μm exhibit better cycle life than some lithium-ion battery cells comprising anodes comprising smaller jagged composite particles with D₅₀ values in a range of about 2.0 μm to about 4.0 μm.

An additional characteristic that may be determined from a particle size distribution (PSD) of a particle population is a cumulative volume fraction, defined as a cumulative volume of particles with D₅₀ values of a threshold D₅₀ value or less, divided by a total volume of all the particles. In some of the examples considered herein, the threshold D₅₀ value was set at 4.6 μm. Particle populations were prepared with D₅₀ values in a range of about 2.0 μm to about 4.0 μm, with the corresponding cumulative volume fractions (D₅₀ threshold of 4.6 μm) ranging between about 58% and about 96%. Lithium-ion battery test cells were prepared with anodes comprising each of these particle populations and the cycle life was measured for each test. The results are shown in graphical plot 1602 of FIG. 16. Graphical plot 1602 shows a dependence of the cycle life (in Si—C composite anode/LCO cathode cells) on the respective cumulative volume fractions (D₅₀ threshold of about 4.6 μm). Some examples with higher cumulative volume fractions (e.g., higher than about 80 vol. %, or higher than about 85 vol. %, or higher than about 90 vol. %) exhibited shorter cycle life (e.g., less than about 500 cycles, or less than about 450 cycles, or less than about 400 cycles). Higher cumulative volume fractions may indicate the presence of large amounts of finer particles (e.g., particle sizes less than about 2.0 μm, or less than about 1.0 μm, or less than about 0.5 μm), possibly resulting in more frequent occurrences of unwanted side reactions between the composite particles and the electrolyte. In some implementations, cycle life values of greater than about 500 cycles, or greater than about 550 cycles, or greater than about 600 cycles may be achieved by adjustment of the PSDs of jagged composite particle populations. In some implementations, the PSDs may be adjusted to obtain a cumulative volume fraction (4.6 μm threshold) of less than about 90%, or less than about 85%, or less than about 80%, or in a range of about 60% to about 85%, or in a range of about 60% to about 80%, or in a range of about 70% to about 85%, or in a range of about 70% to about 80%, or in a range of about 65% to about 85%, or in a range of about 65% to about 80%.

In the foregoing examples described with respect to FIG. 16, composite particle populations with D₅₀ values in a range of about 2.0 μm to about 4.0 μm, with the corresponding cumulative volume fractions (D₅₀ threshold of about 4.6 μm) ranging between about 58% and about 96%, were tested for lithium-ion battery cell performance characteristics (in Si—C composite anode/LCO cathode cells). In some embodiments, a fiftieth-percentile volume-weighted particle size parameter (D₅₀) of the PSD is in a range of about 1.0 μm to about 12.0 μm (in some designs, from about 1.0 μm to about 2.0 μm; in other designs, from about 2.0 μm to about 4.0 μm; in yet other designs, from about 4.0 μm to about 6.0 μm; in yet other designs, from about 6.0 μm to about 12.0 μm). In some embodiments (e.g., when the D₅₀ is in a range from about 2.0 μm to about 4.0 μm), the cumulative volume fraction, with the threshold particle size at about 4.6 μm, is about 90 vol. % or less, or about 85 vol. % or less, or about 80 vol. % or less. In other embodiments (e.g., when the D₅₀ is in a range from about 4.0 μm to about 6.0 μm), the cumulative volume fraction, with the threshold particle size at about 7 μm, is about 90 vol. % or less, or about 85 vol. % or less, or about 80 vol. % or less. In yet other embodiments (e.g., when the D₅₀ is in a range from about 6.0 μm to about 12.0 μm), the cumulative volume fraction, with the threshold particle size at about 15 μm, is about 90 vol. % or less, or about 85 vol. % or less, or about 80 vol. % or less. Note that the presence of excessively large particles may reduce cell performance characteristics (e.g., reduce cell stability, increase its impedance, reduce rate performance, etc.). In some embodiments (e.g., when the D₅₀ is in a range from about 2.0 μm to about 4.0 μm), the cumulative volume fraction, with the threshold particle size at about 10 μm, is about 80 vol. % or more. In some embodiments (e.g., when the D₅₀ is in a range from about 2.0 μm to about 4.0 μm), the cumulative volume fraction, with the threshold particle size at about 12 μm, is about 90 vol. % or more. In other embodiments (e.g., when the D₅₀ is in a range from about 4.0 μm to about 6.0 μm), the cumulative volume fraction, with the threshold particle size at about 15 μm, is about 80 vol. % or more. In other embodiments (e.g., when the D₅₀ is in a range from about 4.0 μm to about 6.0 μm), the cumulative volume fraction, with the threshold particle size at about 22 μm, is about 90 vol. % or more. In other embodiments (e.g., when the D₅₀ is in a range from about 6.0 μm to about 12.0 μm), the cumulative volume fraction, with the threshold particle size at about 28 μm, is about 80 vol. % or more. In yet other embodiments (e.g., when the D₅₀ is in a range from about 6.0 μm to about 12.0 μm), the cumulative volume fraction, with the threshold particle size at about 32 μm, is about 90 vol. % or more.

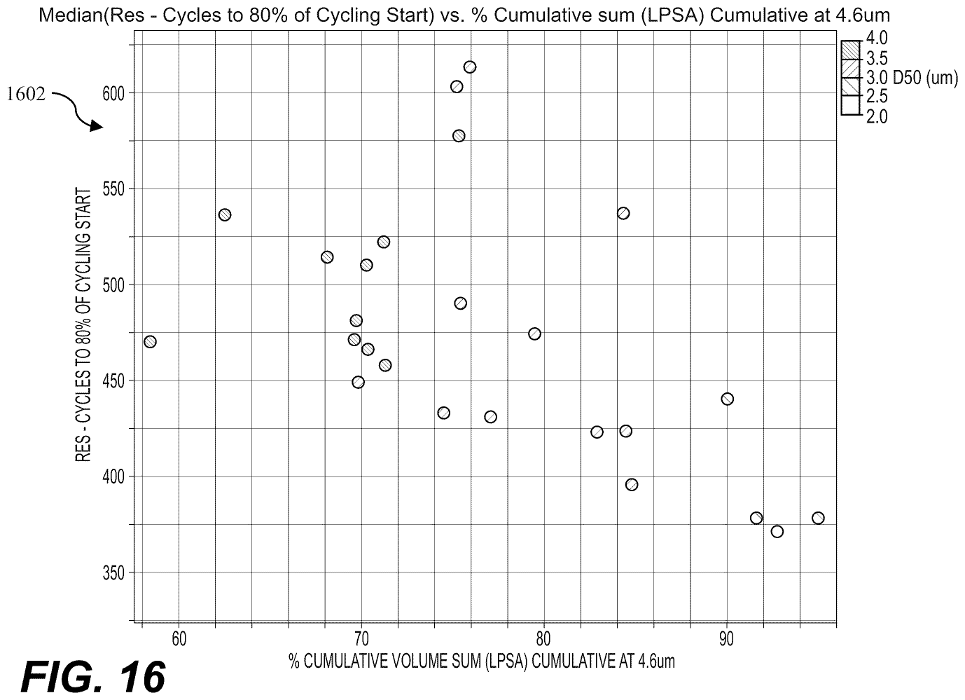

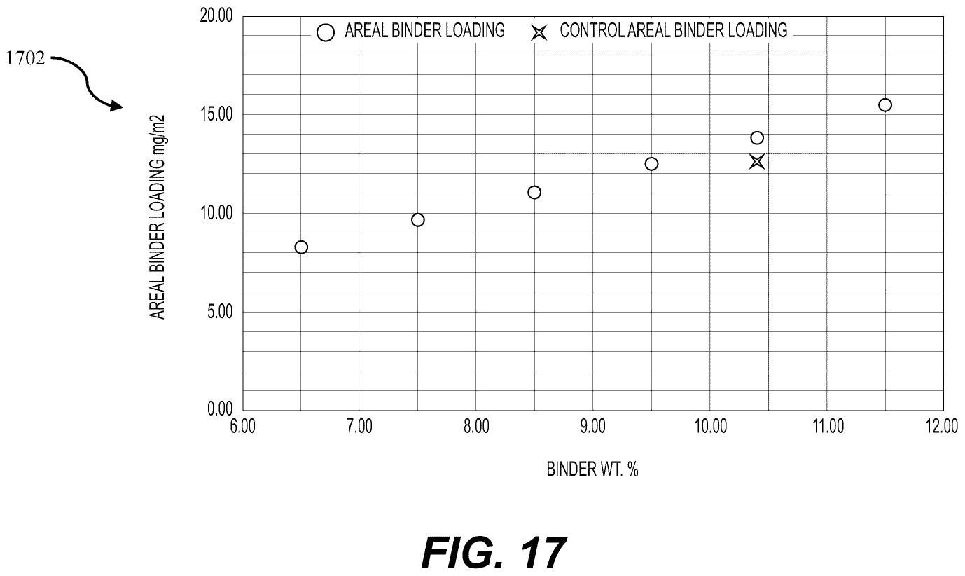

As shown in graphical plot 1502, the BET-SSA values exhibit a dependence on the D₅₀ values of the jagged composite particle populations. Accordingly, as shown in 1504, the areal binder loading also exhibits a dependence on the D₅₀ values if the binder mass fraction in the electrode coating is kept in a range of about 6.5 to about 11.5 wt. %. Several lithium-ion battery cells comprising anodes comprising a jagged nanocomposite particle population with D₅₀ of about 7.42 μm were prepared with varying binder mass fractions in the electrode (anode) coating and compared to a lithium-ion battery cell comprising an anode comprising a jagged nanocomposite particle population with D₅₀ of about 5.35 μm. FIG. 17 shows a graphical plot 1702 which shows a dependence of an areal binder loading on binder mass fraction of each of the selected particle populations. The binder mass fraction of the test cells with the D₅₀ of about 7.42 μm was varied between about 6.5 wt. % and about 11.5 wt. %. In the example shown, a binder mass fraction of about 6.5 wt. % corresponds to a mass fraction of the jagged composite particles in the electrode of about 93.4 wt. %. In the example shown, a binder mass fraction of about 11.5 wt. % corresponds to a mass fraction of the jagged composite particles in the electrode of about 88.4 wt. %. The binder mass fraction of the control sample test cell with D₅₀ of about 5.35 μm was about 10.4 wt. %. The areal binder loading was in a range of about 8 mg/m² to about 16 mg/m².

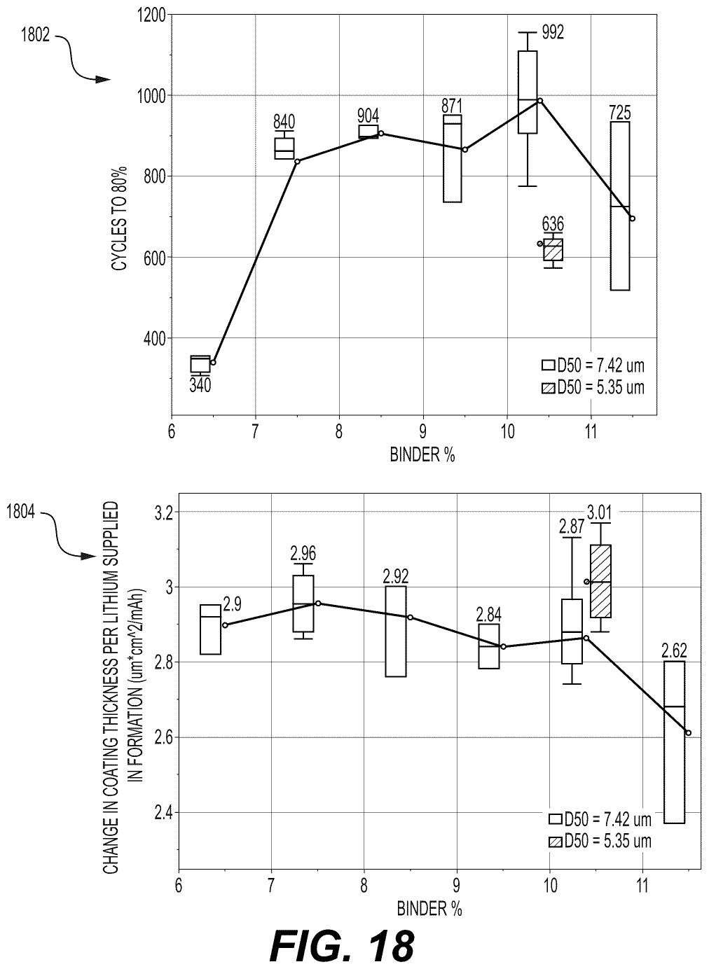

FIG. 18 shows a graphical plot 1802 of a dependence of a cycle life on binder mass fraction of each of the test cells of FIG. 17. The test cells (D₅₀ of about 7.42 μm) with binder mass fractions of about 10.4 wt. % and about 11.5 wt. % exhibited lithium plating during charging, indicating that at least some of the measured capacity is attributable to lithium plating on the copper current collectors. In some designs, the lithium plating is preferably avoided for safety. In some implementations, the areal binder loading (e.g., greater than about 13 mg/m²) corresponding to these binder mass fractions (e.g., about 10.4 wt. %, about 11.5 wt. %) may be too high. No lithium plating was observed in the other test cells (D₅₀ of about 7.42 μm, binder mass fractions of about 6.5 wt. %, about 7.5 wt. %, about 8.5 wt. %, and about 9.5 wt. %) and in the control sample test cell (D₅₀ of about 5.35 μm, binder mass fraction of about 10.4 wt. %). The test cell (D₅₀ of about 7.42 μm) with a binder mass fraction of about 6.5 wt. % exhibited adhesion failure of the coating to the current collector resulting in a short cycle life, possibly indicating that the amount of binder was insufficient in this example. Test cells with intermediate binder mass fraction values (e.g., about 7.5 wt. %, about 8.5 wt. %, about 9.5 wt. %), with corresponding areal binder loading values (e.g., in a range of about 9.0 mg/m² to about 13 mg/m²) exhibited cycle life values of greater than 800 cycles. Accordingly, in some implementations (e.g., D₅₀ in a range of about 6.0 μm to about 8.0 μm), binder mass fractions greater than about 6.6 wt. %, or greater than about 7.0 wt. %, or less than about 10.3 wt. %, or less than about 10.0 wt. %, or in a range of about 6.6 wt. % to about 10.3 wt. %, or in a range of about 6.6 wt. % to about 10.0 wt. %, or in a range of about 7.0 wt. % to about 10.3 wt. %, or in a range of about 7.0 wt. % to about 10.0 wt. %, or in a range of about 7.0 wt. % to about 8.0 wt. %, or in a range of about 8.0 wt. % to about 9.0 wt. %, or in a range of about 9.0 wt. % to about 10.0 wt. % may be preferred. In some implementations (e.g., D₅₀ in a range of about 6.0 μm to about 8.0 μm), areal binder loading values greater than about 9.0 mg/m², or less than about 13.0 mg/m², or in a range of about 9.0 mg/m² to about 13.0 mg/m², or in a range of about 9.0 mg/m² to about 10.0 mg/m², or in a range of about 10.0 mg/m² to about 11.0 mg/m², or in a range of about 11.0 mg/m², to about 12.0 mg/m², or in a range of about 12.0 mg/m² to about 13.0 mg/m² may be preferred.

FIG. 18 shows a graphical plot 1804 of a dependence of a normalized coating thickness change on binder mass fraction of each of the test cells of FIG. 17. The normalized thickness change data are indicative of swelling of the electrode coating in the thickness direction (z-swell). In the test cells shown (D₅₀ of about 7.42 μm), the normalized coating thickness changes are kept at less than about 3.0 μm (cm²/mAh) for binder mass fractions of about 7.0 wt. % to about 10.0 wt. %, comparable to other lithium-ion battery cells with jagged composite particle populations of D₅₀ in a range of about 2.0 μm to about 4.0 μm (e.g., graphical plot 904).

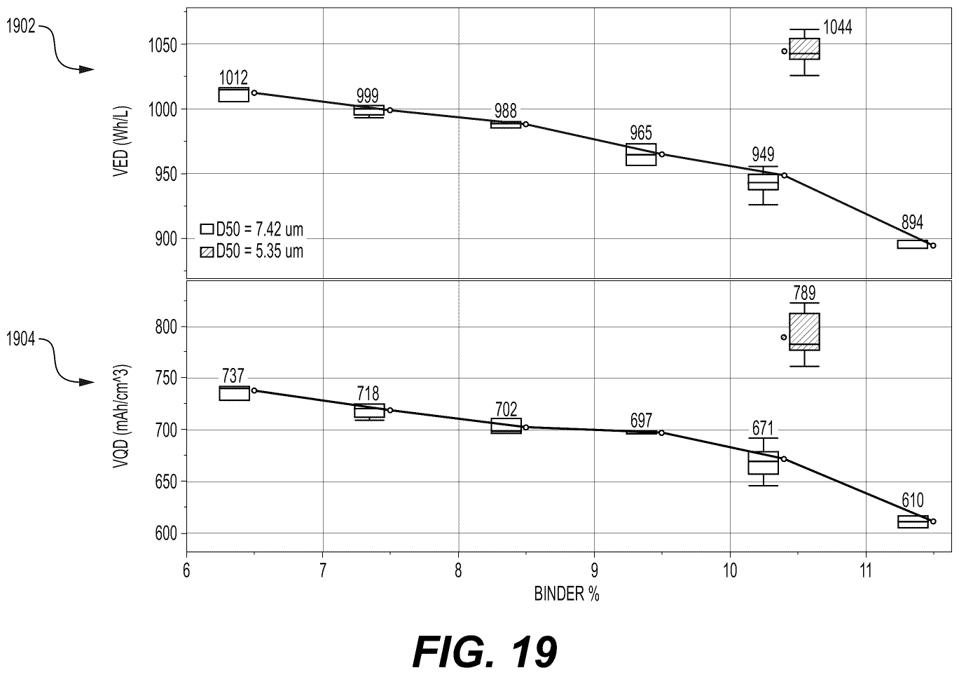

FIG. 19 shows a graphical plot 1902 of a dependence of a volumetric energy density (VED) on binder mass fraction of each of the test cells of FIG. 17 and a graphical plot 1904 of a dependence of volumetric charge density (VQD) on binder mass fraction of each of the test cells of FIG. 17. VQD values greater than about 650 mAh/cm³ and VED values greater than about 950 Wh/l were observed in test cells (D₅₀ of about 7.42 μm with binder mass fractions of about 7.0 wt. % to about 10.0 wt. %.

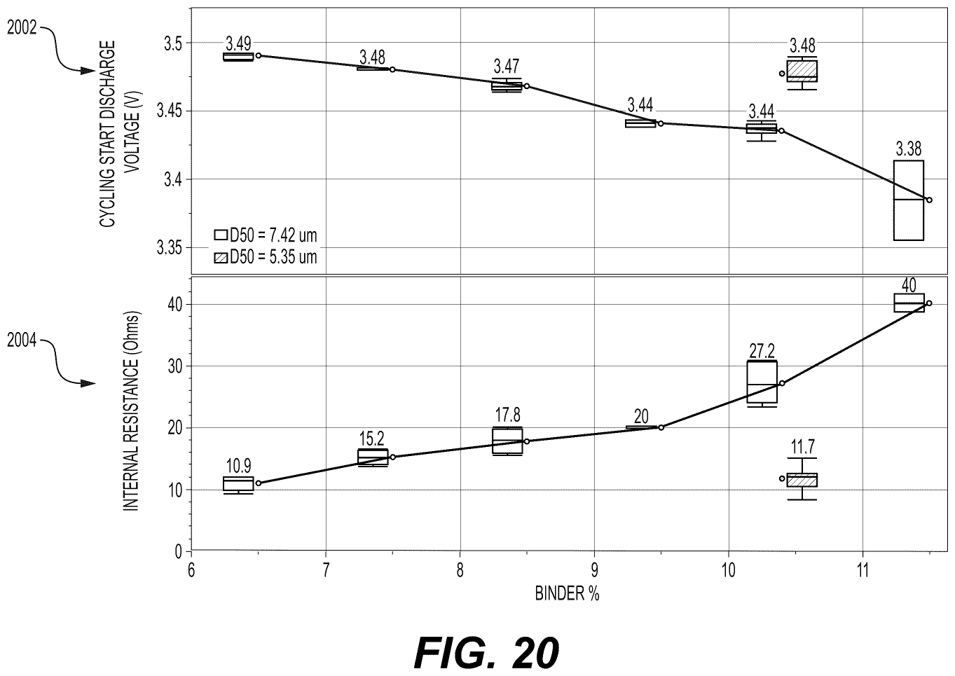

FIG. 20 shows a graphical plot 2002 of a dependence of a discharge voltage on binder mass fraction of each of the test cells of FIG. 17 and a graphical plot 2004 of a dependence of an internal resistance on binder mass fraction of each of the test cells of FIG. 17. Discharge voltage values greater than about 3.5 V and internal resistance values in a range of about 15Ω to about 25Ω were observed in test cells (D₅₀ of about 7.42 μm) with binder mass fractions of about 7.0 wt. % to about 10.0 wt. %.

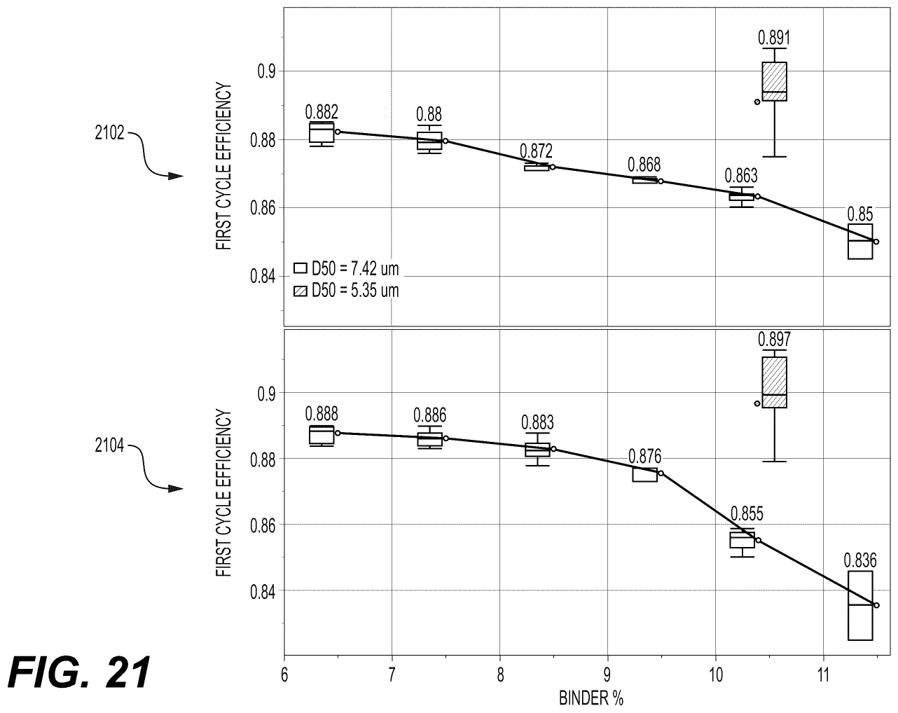

FIG. 21 shows a graphical plot 2102 of a dependence of a first-cycle efficiency on binder mass fraction of each of the test cells of FIG. 17 and a graphical plot 2104 of a dependence of a formation efficiency on binder mass fraction of each of the test cells of FIG. 17. Formation efficiency values greater than about 83% and first-cycle efficiency values greater than about 83% were observed in test cells (D₅₀ of about 7.42 μm) with binder mass fractions of about 7.0 wt. % to about 10.0 wt. %.

In some designs (e.g., in blended anodes with anode capacity ranging from about 450 mAh/g to about 1600 mAh/g when normalized by the mass of active materials, such as graphite and Si—C composites or other Si-comprising anode materials; in some designs for the blended anodes with the capacity in the range from about 500 mAh/g to about 1400 mAh/g when normalized by the mass of active materials; in some designs for the blended anodes with the capacity in the range from about 600 mAh/g to about 1200 mAh/g when normalized by the mass of active materials), it may be advantageous to have a narrow particle size distribution (PSD) of Si-comprising composite (e.g., Si—C nanocomposite) particles. The high fraction of fines (undesirably small particles) in Si—C composite powder were found to increase outer surface area of such particles, the BET-SSA of such particles and the surface area of these particles exposed to electrolyte during cycling and were found to lead to a larger volume fraction of the SEI formed during formation and storage, faster degradation during cycling, faster degradation during battery storage at room temperature and at elevated temperatures, excessive gassing during formation and other undesirable outcomes. In particular, in some designs, it was found that it may be advantageous for the D₁₀ (as measured using laser scattering or other suitable technique) of the Si—C nanocomposites (for use in a blended anodes) to be in excess of about 1 μm for spheroidal (e.g., spherical or near-spherical) particles and in excess of about 2 μm for jagged (or cylindrical) particles. In some designs, it may be preferable for the D₁₀ of the jagged (or cylindrical) particles to be in the range of about 2 to about 7 μm (in some designs, from about 2 to about 3 μm; in other designs from about 3 to about 4 μm; in other designs, from about 4 to about 5 μm; in other designs, from about 5 to about 6 μm; in yet other designs from about 5 to about 6 μm). In some designs, it was found that it may be advantageous for the BET-SSA of the Si—C nanocomposite powder (for use in a blended anodes) to be in the range of about 1 to about 11 m²/g (in some designs, from about 1 to about 2 m²/g; in other designs, from about 2 to about 4 m²/g; in other designs, from about 4 to about 6 m²/g; in other designs, from about 6 to about 8 m²/g; in other designs, from about 8 to about 11 m²/g; in other designs, from about 3 to about 7 m²/g).

Interestingly, in some designs, it was found that the optimal PSD and optimal D₅₀, D₉₀, and D₉₉ of the Si—C composite particles may be different for the blended anodes relative to the anode comprising only Si—C composite as active materials.

In order to attain good performance in batteries, Si—C nanocomposites (in blended anodes) were found to need to exhibit moderately small volume changes during cycling and thus comprise internal pores (e.g., exhibit a total pore volume in the range from about 5 vol. % to about 50 vol. %, as estimated using powder density measurements or argon gas pycnometry or other suitable technique). Blended anodes, however, need to be densified (calendered) in order to attain high volumetric capacity and adequate performance in cells. Smaller wt. % of Si—C composites in the blended anode often requires higher calendaring (densification) pressure. Such high pressures may induce cracking of the Si—C composites exposing some of their internal surface area and internal pores to ambient air (and to electrolyte in a battery), which may lead to excessive side reactions with electrolyte. While large Si—C composite exhibit smaller BET, too large Si—C composite particles may suffer from such mechanical damages during calendaring more. In addition, we found that too large Si—C composite particles may increase blended anode roughness (especially for anodes exhibiting smaller areal capacity loadings), may reduce its volumetric capacity, may increase unevenness of the areal capacity distribution, may significantly reduce mechanical stability of the anode during cycling (e.g., lead to delamination from the current collector or separation of the active material), may induce damages to the separator, etc.) and were found to reduce cycle stability.

In particular, in some designs (e.g., in blended anodes with anode capacity ranging from about 450 mAh/g to about 1600 mAh/g when normalized by the mass of active materials, such as graphite and Si—C composites or other Si-comprising anode materials; in some designs for the blended anodes with the capacity in the range from about 500 mAh/g to about 1400 mAh/g when normalized by the mass of active materials; in some designs for the blended anodes with the capacity in the range from about 600 mAh/g to about 1200 mAh/g when normalized by the mass of active materials), it was found that it may be advantageous for the D₉₀ (as measured using laser scattering or other suitable technique) of the Si—C nanocomposite powders (for use in a blended anodes) to be less than about 40 μm for spheroidal (e.g., spherical or near-spherical) particles (in some designs, less than about 30 μm; in other designs less than about 25 μm; in other designs, less than about 20 μm; in other designs, less than about 15 μm), be less than about 40 μm for jagged particles (in some designs, less than about 30 μm; in other designs less than about 25 μm; in other designs, less than about 20 μm; in other designs, less than about 15 μm) and be less than 60 μm for cylindrically shaped particles (in some designs, less than about 50 μm; in other designs less than about 40 μm; in other designs less than about 30 μm; in other designs less than about 25 μm; in other designs, less than about 20 μm; in other designs, less than about 15 μm). In some designs, it was found that it may be advantageous for the D₉₉ (as measured using laser scattering or other suitable technique) of the Si—C nanocomposites (for use in a blended anodes) to be less than about 50 μm for spheroidal (e.g., spherical or near-spherical) particles (in some designs, less than about 40 μm; in other designs less than about 35 μm; in other designs, less than about 30 μm; in other designs, less than about 25 μm; in other designs, less than about 20 μm), be less than about 50 μm for jagged particles (in some designs, less than about 40 μm; in other designs less than about 35 μm; in other designs, less than about 30 μm; in other designs, less than about 25 μm; in other designs, less than about 20 μm) and be less than 80 μm for cylindrically shaped particles (in some designs, less than about 60 μm; in other designs less than about 50 μm; in other designs less than about 40 μm; in other designs less than about 30 μm; in other designs, less than about 20 μm). Note that in automotive applications the Li-ion batteries typically exhibit larger areal capacity loadings and thus the electrodes are commonly thicker relative to that in Li-ion batteries for consumer (e.g., laptops, cell phones, fitness trackers etc.) or consumer drone applications. Thicker electrodes may allow larger D₅₀, D₉₀, or D₉₉ to be acceptable.

In order to attain good performance in Li-ion batteries, in some designs, the full width at half maximum (FWHM) of the particle size distribution of Si—C nanocomposite powders (in blended anodes with anode capacity ranging from about 450 mAh/g to about 1600 mAh/g when normalized by the mass of active materials, such as graphite and Si—C composites or other Si-comprising anode materials; in some designs for the blended anodes with the capacity in the range from about 500 mAh/g to about 1400 mAh/g when normalized by the mass of active materials; in some designs for the blended anodes with the capacity in the range from about 600 mAh/g to about 1200 mAh/g when normalized by the mass of active materials) were found to preferably range from about 3 to about 12 μm (in some designs, from about 4 to about 8 μm; in some designs, from about 5 to about 7 μm; in some designs, from about 3 to about 5 μm; in some designs, from about 7 to about 9 μm; in some designs, from about 9 to about 12 μm).

In order to attain good performance in Li-ion batteries, in some designs, the span ((D₉₀−D₁₀)/D₅₀) of the particle size distribution of Si—C nanocomposite powders (in blended anodes with anode capacity ranging from about 450 mAh/g to about 1600 mAh/g when normalized by the mass of active materials, such as graphite and Si—C composites or other Si-comprising anode materials; in some designs for the blended anodes with the capacity in the range from about 500 mAh/g to about 1400 mAh/g when normalized by the mass of active materials; in some designs for the blended anodes with the capacity in the range from about 600 mAh/g to about 1200 mAh/g when normalized by the mass of active materials) were found to preferably be below about 3 (in some designs, more preferably below about 2; in other designs, more preferably below about 1; in other designs, more preferably below about 0.8). In some designs, the Span of the particle size distribution of Si—C nanocomposite powders (in such blended anodes) may preferably range from about 0.3 to about 3 (in some designs, more preferably from about 0.3 to about 2; in other designs, more preferably from about 0.3 to about 1.0; in other designs, more preferably from about 0.3 to about 0.8; in other designs, more preferably from about 0.4 to about 1.2).

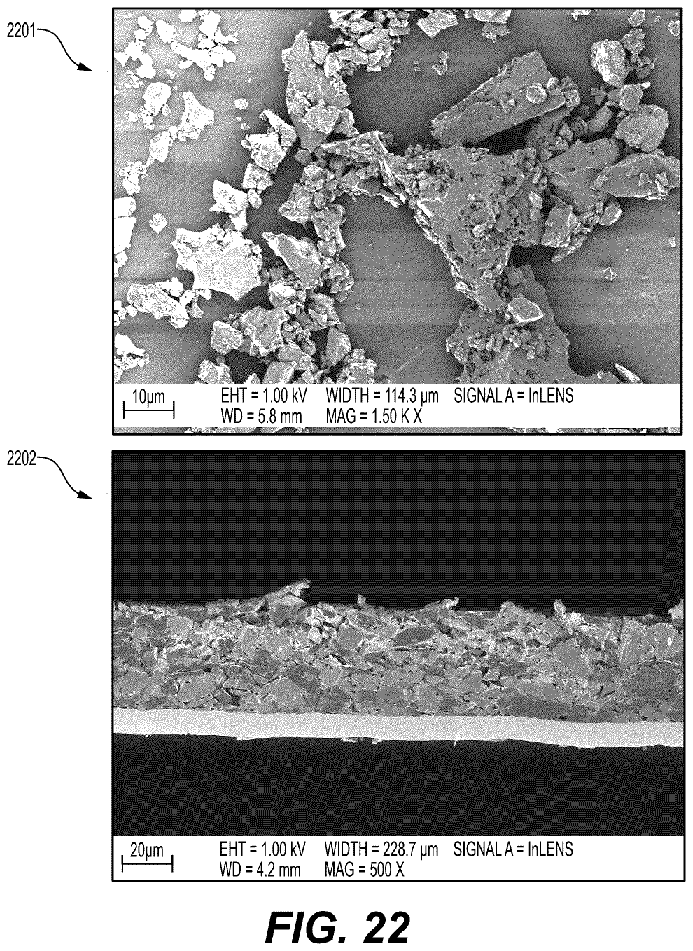

FIG. 22 shows an SEM image (2201) of a population of jagged composite particles (including agglomerates of jagged particles), without any optimization of the population's particle size distribution (PSD). The particles shown in SEM image 2201 include fine particles (so-called “fines”) and coarse particles. Some of the particles may be agglomerates of smaller particles. The definition of fine particles depends on the specific implementation but may be defined as particles with a diameter (e.g., as measured by LPSA) at and below a threshold value (e.g., about 0.5 μm, about 1.0 μm, about 1.5 μm, about 2.0 μm, etc.). The definition of coarse particles depends on the specific implementation but may be defined as particles with a diameter (e.g., as measured by LPSA) at and above a threshold value (e.g., about 5 μm, about 7 μm, about 8 μm, about 10 μm, about 15 μm, about 20 μm, about 30 μm, about 40 μm, about 50 μm, etc.). The composite particles in SEM image 2201 have jagged, irregular shapes and may exhibit a range of aspect ratios. These composite particles are in their as-prepared form and the PSD of the population has not been optimized. The D₅₀ of the population is about 10 μm.

FIG. 22 shows an SEM image (2202) of a cross section of an electrode coating comprising a blended mixture of the population of jagged particles shown in 2201 and graphite particles as the electrode active material. A slurry comprising the electrode active material was casted on a copper current collector and the slurry solvent was dried. The electrode coating was calendered under 14 tons of force. Despite the calendering, the cross-sectional image 2202 shows some of the particles protruding from the electrode coating surface. For example, such an effect may be observed if the population of composite particles includes particles with diameters greater than the thickness of the electrode coating. It has been found that the use of composite particles such as in the example of FIG. 22 frequently lead to suboptimal (often insufficiently good or not acceptable) performance in Li-ion batteries with blended anodes (particularly in automotive and consumer Li-ion batteries). Herein, the term “blended anode” refers to anodes in which the electrode active material comprises a blended mixture of the composite particles and graphite particles.

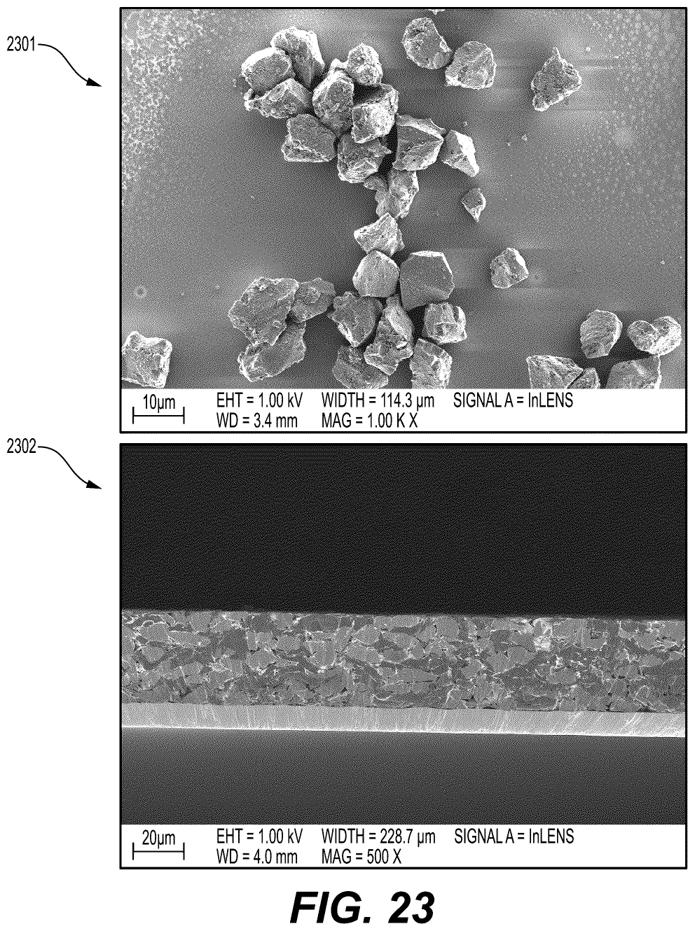

FIG. 23 shows an SEM image (2301) of a population of jagged composite particles, after optimization of the population's particle size distribution (PSD). Before undergoing optimization of its PSD, the population had a D₅₀ of about 10 μm. The PSD optimization process included removal of fine particles (the removed fine particles exhibited a D₅₀ of about 1.5 μm) and removal of coarse particles (the removed coarse particles exhibited a D₅₀ of about 15 μm). For the results shown, the removal of the fines and the removal of the coarse particles was accomplished by sieving. In other implementations, other particle size selection processes (e.g., screening or centrifugation or other aerodynamic size classification or other processes) may be employed. In SEM image 2301, the numbers of fine particles and coarse particles have decreased when compared to the SEM image 2201. The variance in the PSD is smaller in the population of 2301 (after PSD optimization) than in the population of 2201 (without PSD optimization). The population of 2301 appears to be more uniform in size compared to the population of 2201.

FIG. 23 shows an SEM image (2302) of a cross section of an electrode coating comprising a blended mixture of the jagged particles shown in 2301 and graphite particles as the electrode active material. A slurry comprising the electrode active material was casted on a copper current collector and the slurry solvent was dried. The electrode coating was calendered under 14 tons of force. In contrast to the cross-sectional image 2202, no particle protrusions are visible in cross-sectional image 2302. The electrode coating surface appears to be smooth. It has been found that the use of composite particles such as in the example of FIG. 23 frequently lead to superior (often very good, sufficiently good or acceptable) performance in Li-ion batteries with blended anodes (particularly in automotive and consumer Li-ion batteries).

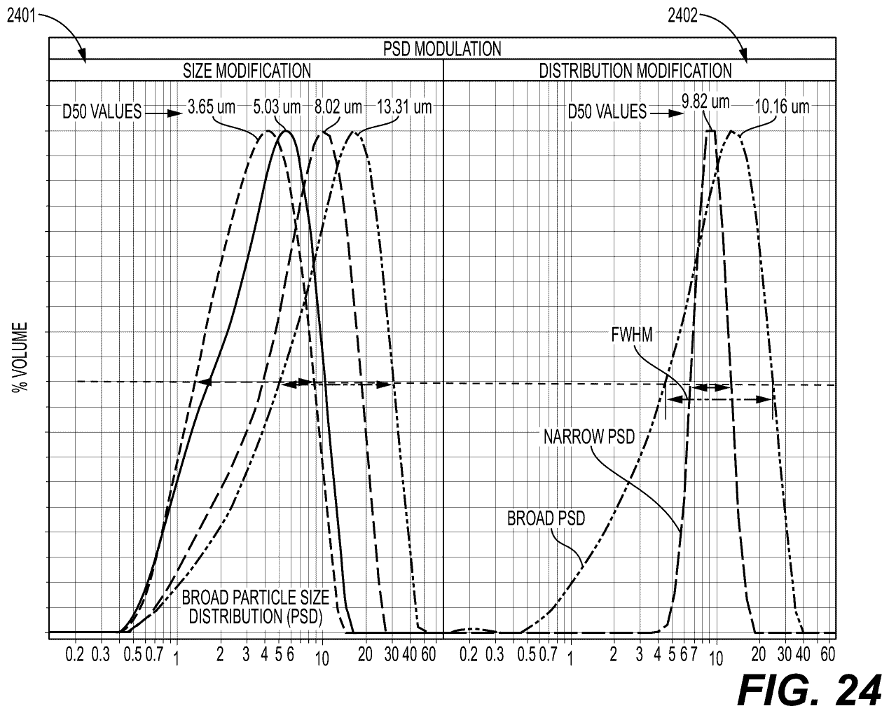

FIG. 24 shows graphical plots 2401 and 2402 of volume-weighted particle size distributions (PSDs) (expressed in volume %) of example populations of jagged composite particles. Graphical plot 2401 shows the PSDs of example populations of respective D₅₀ values exhibiting relatively broad PSDs, before any optimization of the respective PSDs. Graphical plot 2402 shows (1) the PSD of an example population before any optimization of its PSD (D₅₀ of about 10.1 μm) and (2) the PSD of an example population after optimization of its PSD (D₅₀ of about 9.8 μm). The PSD optimization processes include removal of fine particles and removal of coarse particles. As a result of these PSD optimization processes, the PSD has changed from a relatively broader PSD (e.g., greater span, greater FWHM) to a relatively narrower PSD (e.g., smaller span, smaller FWHM). As illustrated in FIG. 24, the FWHM refers to the full-width at half-maximum of the PSD distribution.

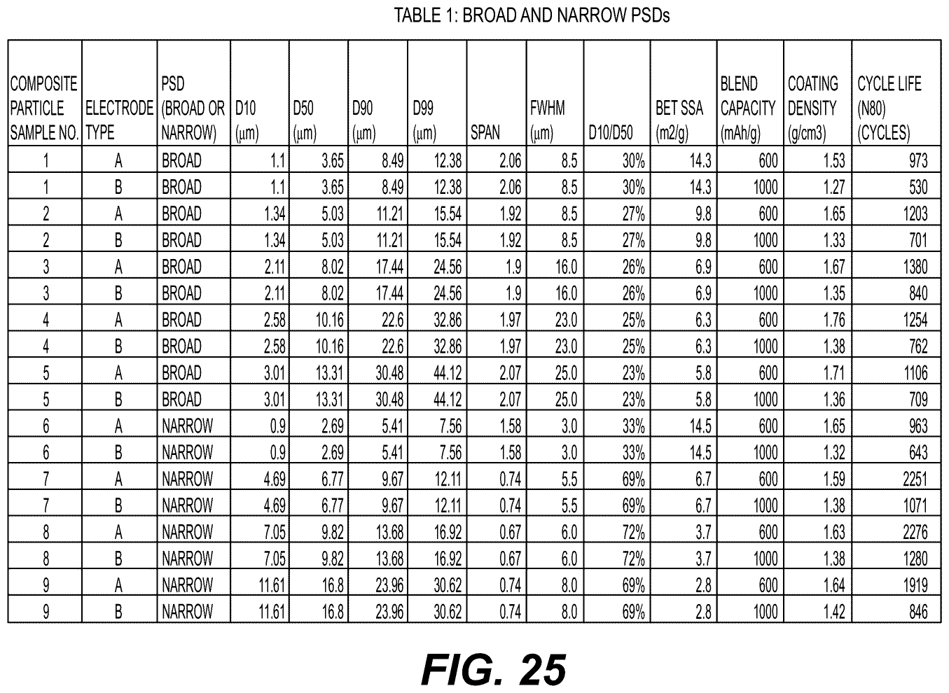

Table 1 (FIG. 25) summarizes selected characteristics (D₁₀, D₅₀, D₉₀, D₉₉, span, FWHM, D₁₀/D₅₀, BET-SSA) of example populations of jagged composite particles. Graphical plot 2401 shows the PSDs of (1) a population with a D₅₀ of about 3.65 μm, corresponding to composite particle sample #1 in Table 1; (2) a population with a D₅₀ of about 5.03 μm, corresponding to composite particle sample #2 in Table 1; (3) a population with a D₅₀ of about 8.02 μm, corresponding to composite particle sample #3 in Table 1; and (4) a population with a D₅₀ of about 13.31 μm, corresponding to composite particle sample #5 in Table 1. As indicated in Table 1, these population samples (#1, #2, #3, and #5) have not undergone any optimization of its PSD (so-called “broad” PSD). Graphical plot 2401 illustrates that populations of jagged composite particles with a range of D₅₀ values (e.g., in the example shown, ranging between about 3.65 to about 13.31 μm) with a relatively broad span (e.g., in a range of about 1.9 to about 2.07) may be obtained by tuning conditions for the synthesis of the composite particles and the comminution of larger particles into smaller particles. Populations that have not undergone PSD optimization (e.g., the samples shown in 2401) may have undergone comminution to obtain a desired average particle size (e.g., D₅₀), but have not undergone removal of fines and coarse particles.

Graphical plot 2402 shows the PSDs of (1) a population with a D₅₀ of about 9.82 μm, corresponding to composite particle sample #8 in Table 1; and (2) a population with a D₅₀ of about 10.16 μm, corresponding to composite particle sample #4 in Table 1. Graphical plot 2402 compares the span of a population of jagged composite particles that has not undergone PSD optimization (sample #4 with a span of about 1.97 and FWHM of about 23.0 μm) and the span of a population of jagged composite particles that has undergone PSD optimization (sample #8 with a span of about 0.67 and a FWHM of about 6.0 μm). Accordingly, graphical plot 2402 illustrates the sizable impact of carrying out PSD optimization (e.g., fines removal, coarse particles removal) on the span and the FWHM of populations of jagged composite particles.

In Table 1 (FIG. 25), population sample #1, #2, #3, #4, and #5 have not undergone PSD optimization processes and are referred to as having “broad” PSDs. Population sample #6, #7, #8, and #9 have undergone PSD optimization processes and are referred to as having “narrow” PSDs. Each population sample was used in making blended anode electrodes of two types: type A and type B. Each population sample of jagged composite Si—C particles exhibited a specific first cycle lithiation capacity of about 1900 mAh/g (corresponding to a Si mass fraction in the Si—C composite particles of about 51 wt. %, with the remainder of the Si—C composite particles including carbon). In the examples shown, a blended anode electrode active material comprises a blended mixture of graphite particles and the respective jagged composite particles. In type A electrodes, the electrode active material exhibited a first cycle lithiation capacity of about 600 mAh and comprised about 16 wt. % of the respective jagged composite particles and about 84 wt. % of graphite particles. In type B electrodes, the electrode active material exhibited a first cycle lithiation capacity of about 1000 mAh and comprised about 42 wt. % of the respective jagged composite particles and about 58 wt. % of graphite particles. For each electrode type (type A, type B) of each population sample, a coating density measured after calendering is reported in Table 1. For each electrode type of each population sample, Li-ion battery cells were fabricated, and performance characteristics were evaluated. A cycle life is reported for Li-ion battery cells of each electrode type and each composite particle population. In some implementations of a blended anode (e.g., a blended mixture of Si—C composite particles and graphite particles), a mass fraction of the Si—C composite particles (e.g., jagged Si—C composite particles) in the battery electrode composition (excluding any binder) may be in a range of about 10 wt. % to about 70 wt. % (e.g., about 10 to about 20 wt. %, about 20 to about 30 wt. %, about 30 to about 40 wt. %, about 40 to about 50 wt. %, about 50 to about 60 wt. %, or about 60 to about 70 wt. %). In some implementations of a blended anode (e.g., a blended mixture of Si—C composite particles and graphite particles), a mass fraction of the graphite particles in the battery electrode composition (excluding any binder) may be in a range of about 30 wt. % to about 90 wt. % (e.g., about 30 to about 40 wt. %, about 40 to about 50 wt. %, about 50 to about 60 wt. %, about 60 to about 70 wt. %, about 70 to about 80 wt. %, or about 80 to about 90 wt. %).

Details of the preparation and testing of electrodes and Li-ion battery cells reported in Table 1 are as follows. For type A (˜ 600 mAh/g) electrodes, a water-based slurry containing a polyacrylic acid (PAA) salt copolymer-based binder (about 4 wt. %), single-walled carbon nanotubes (about 0.05 wt. %), and an anode electrode active material (about 95.95 wt. %) was coated onto a 10 μm-thick copper foil at an areal capacity loading of about 4.1 mAh/cm². The electrode active material (about 100 weight parts) was a blended mixture of Si—C composite particles (about 16 weight parts) and graphite particles (about 84 weight parts). The type A electrodes were calendered with an applied force of 16 tons to attain coating densities in a range of about 1.53 to about 1.76 g/cm³. For type B (˜ 1000 mAh/g) electrodes, a water-based slurry containing a polyacrylic acid (PAA) salt copolymer-based binder (about 6.6 wt. %), single-walled carbon nanotubes (about 0.1 wt. %), and an anode electrode active material (about 93.3 wt. %) was coated onto a 10 μm-thick copper foil at an areal capacity loading of about 4.1 mAh/cm². The electrode active material (about 100 weight parts) was a blended mixture of Si—C composite particles (about 42 weight parts) and graphite particles (about 58 weight parts). The type B electrodes were calendered with an applied force of 14 tons to attain coating densities in a range of about 1.27 to about 1.42 g/cm³. The electrodes were then assembled into single-layer pouch full cells (area of about 6.25 cm²) with a NCM811 (a lithium nickel manganese cobalt oxide (NCM) of approximate composition Li[Ni_{0.8}Co_{0.1}Mn_{0.1}]O₂) cathode, a 10 μm ceramic separator, and an electrolyte formulation comprising 13.92 wt. % of LiPF₆ (as a primary lithium salt), 13.33 wt. % of fluoroethylene carbonate (FEC), 5.04 wt. % of ethylene carbonate (EC), 3.85 wt. % of ethyl methyl carbonate (EMC), 62.49 wt. % of dimethyl carbonate DMC, 0.52 wt. % of vinylene carbonate (VC), and 0.85 wt. % of lithium difluorophosphate (LFO). After the electrolyte formulation was added to the Li-ion battery cell, the cell was cycled under the following charge/discharge test conditions. Charge/discharge test conditions comprise constant current, constant potential (CCCP) at 2 C charge to 4.0V and taper to 1 C, followed by the CCCP at 1 C charge to 4.2V and taper to 0.05C, followed by 1 C discharge.

Table 1 (FIG. 25) reports the cycle life performance of Li-ion battery cells obtained from each composite particle population and electrode type. For each composite particle population, cells with type A (˜600 mAh/g) electrodes exhibited greater cycle life values than cells with type B (˜1000 mAh/g) electrodes. Cycle life values of greater than 1900 cycles were measured in three of the “narrow” PSD samples: (1) population #7, electrode type A, D₁₀ of about 4.69 μm, D₅₀ of about 6.77 μm, a ratio D₁₀/D₅₀ of about 69%, span of about 0.74, BET-SSA of about 6.7 m²/g, 2251 cycles; (2) population #8, electrode type A, D₁₀ of about 7.05 μm, D₅₀ of about 9.82 μm, a ratio D₁₀/D₅₀ of about 72%, span of about 0.67, BET-SSA of about 3.7 m²/g, 2276 cycles; and (3) population #9, electrode type A, D₁₀ of about 11.61 μm, D₅₀ of about 16.8 μm, a ratio D₁₀/D₅₀ of about 69%, span of about 0.74, BET-SSA of about 2.8 m²/g, 1919 cycles. Cycle life values of another “narrow” PSD sample were not as good, e.g., population #6, electrode type A, D₁₀ of about 0.9 μm, D₅₀ of about 2.69 μm, a ratio D₁₀/D₅₀ of about 33%, span of about 1.58, BET-SSA of about 14.5 m²/g, 983 cycles. Population #6 exhibits a smaller D₁₀, a smaller D₅₀, a greater span, and a greater BET-SSA than the other “narrow” PSD populations #7, #8, and #9. For further comparison, the “broad” PSD populations implemented in type A electrodes exhibited cycle life values in a range of about 973 cycles to 1380 cycles. The “broad” PSD populations exhibited a D₁₀ in a range of 1.1 μm to 3.01 μm (corresponding to ratios D₁₀/D₅₀ in a range of 23 to 30%), a span in a range of about 1.9 to about 2.07, and BET-SSA in a range of about 5.8 to 14.3 m²/g. In some implementations, beneficial effects to cycle life (and other battery characteristics) may be observed when the span is less than about 2.1, less than about 1.9, less than about 1.8, less than about 1.5, less than about 1.2, less than about 1.0, or less than about 0.8. Additionally, in some implementations, the span may be greater than about 0.3, greater than about 0.5, or greater than about 0.6. In some implementations, beneficial effects to cycle life (and other battery characteristics) may be observed when the BET-SSA of the composite particles is less than about 15 m²/g, less than about 12 m²/g, less than about 10 m²/g, less than about 8 m²/g, less than about 7 m²/g, less than about 6 m²/g, less than about 5 m²/g, less than about 4 m²/g, or less than about 3 m²/g. Additionally, in some implementations, the BET-SSA may be greater than about 1 m²/g, greater than about 2 m²/g, greater than about 5 m²/g, or greater than about 8 m²/g. In some implementations, beneficial effects to cycle life (and other battery characteristics) may be observed when the D₁₀ is greater than about 0.5 μm, greater than about 1.0 μm, greater than about 1.5 μm, or greater than about 2.0 μm. In some implementations, beneficial effects to cycle life (and other battery characteristics) may be observed when the ratio D₁₀/D₅₀ is greater than about 35%, greater than about 45%, greater than about 55%, or greater than about 65%. Additionally, in some implementations, the ratio D₁₀/D₅₀ may be less than about 80% or less than about 75%.

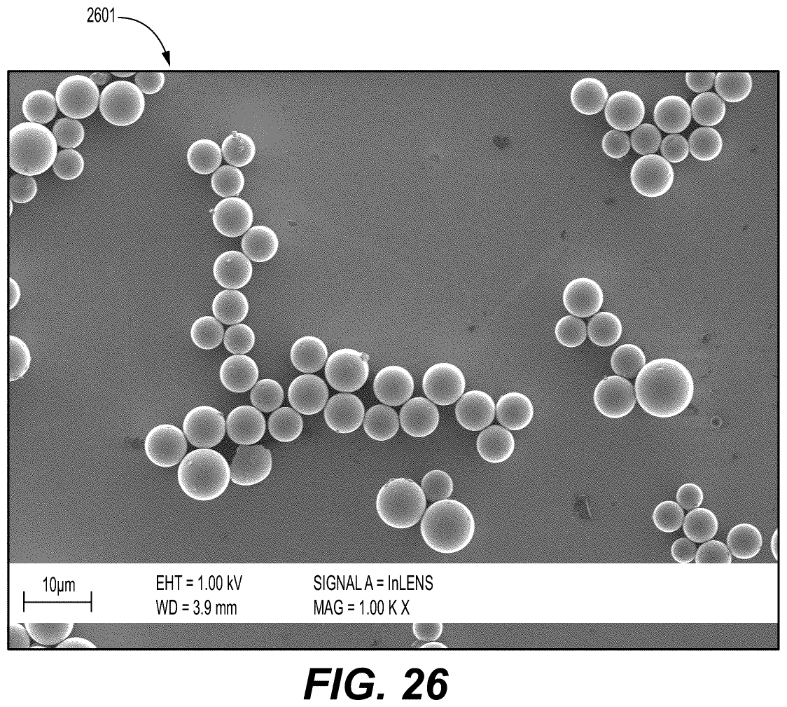

FIG. 26 shows an SEM image (2601) of a population of spheroidal composite particles. In the example shown, the D₅₀ value of the population is in a range of about 5 to about 7 μm. Herein, the term “spheroidal” is employed to refer to a round shape that is near-spherical or spherical, as exemplified in the SEM image 2601.

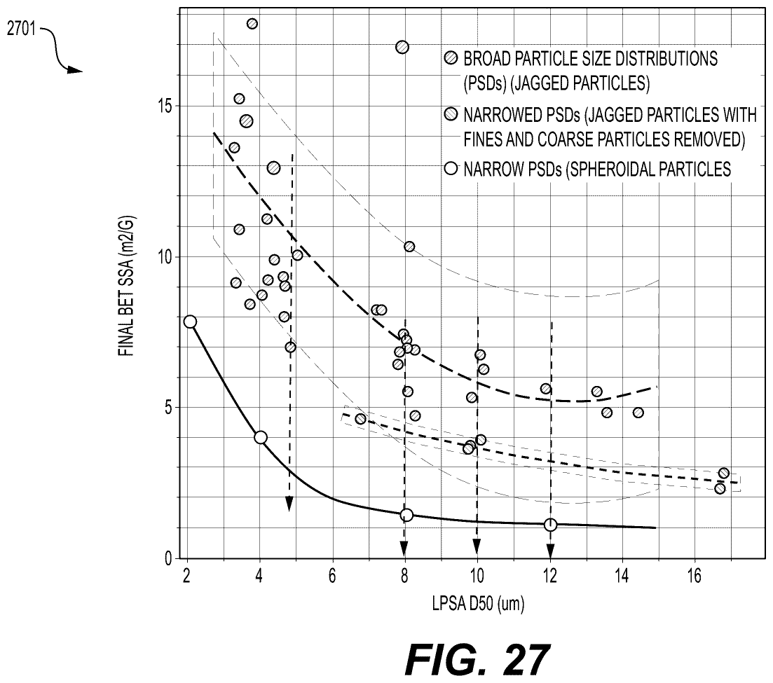

FIG. 27 shows a graphical plot 2701 showing the dependence of the BET-SSA values of example populations of composite particles (jagged composite particles before PSD optimization (exhibiting so-called “broad” PSDs), jagged composite particles after PSD optimization (exhibiting so-called “narrow” PSDs), and spheroidal particles) on their respective D₅₀ values. Examples of spheroidal particles are shown in FIG. 26. In the example shown, the D₅₀ values were measured by LPSA. Graphical plot 2701 illustrates trends among the jagged composite particles with “broad” PSDs, jagged composite particles with “narrow” PSDs, and spheroidal particles that exhibit relatively narrow PSDs. For a particular D₅₀ value (e.g., 8 μm, 10 μm, 12 μm), the spheroidal particles (with relatively narrow PSDs) exhibit the smallest BET-SSA values, followed by jagged particles with “narrow” PSDs that have undergone PSD optimization, and then followed by jagged particles with “broad” PSDs that have not undergone PSD optimization. Smaller BET-SSA values may indicate smaller external surface areas of the Si—C powders (Si—C composite particles). The use of composite particles that have smaller external surface areas may result in superior Li-ion battery performance when used in blended anodes (e.g., longer calendar life and/or longer cycle stability and/or better high temperature stability, etc.). However, when the particle sizes of the Si—C composite particles (e.g., the D₅₀ or more particularly the D₉₀ or the D₉₉ of the Si—C composite particles) become too large, the Li-ion battery performance may drop despite smaller BET-SSA values and/or smaller external surface areas of the Si—C composite particles. In some cases, excessively large D₉₀ and D₉₉ may be more detrimental than excessively large D₅₀ to the performance of Li-ion batteries with blended anodes. In some designs, it may be preferable for the D₅₀ of the jagged (or cylindrical) composite particles to be in a range of about 5 to about 15 μm (in some designs, from about 5 to about 7 μm; in other designs from about 7 to about 9 μm; in other designs, from about 9 to about 11 μm; in other designs, from about 11 to about 13 μm; in other designs from about 13 to about 15 μm; in yet other designs, from about 8 to about 12 μm; in yet other designs, from about 6 to about 10 μm; in yet other designs, from about 6 to about 12 μm; in yet other designs, from about 6 to about 9 μm). In some designs, it may be preferable for the D₅₀ of the jagged (or cylindrical) composite particles to be in a range of about 2 to about 17 μm.

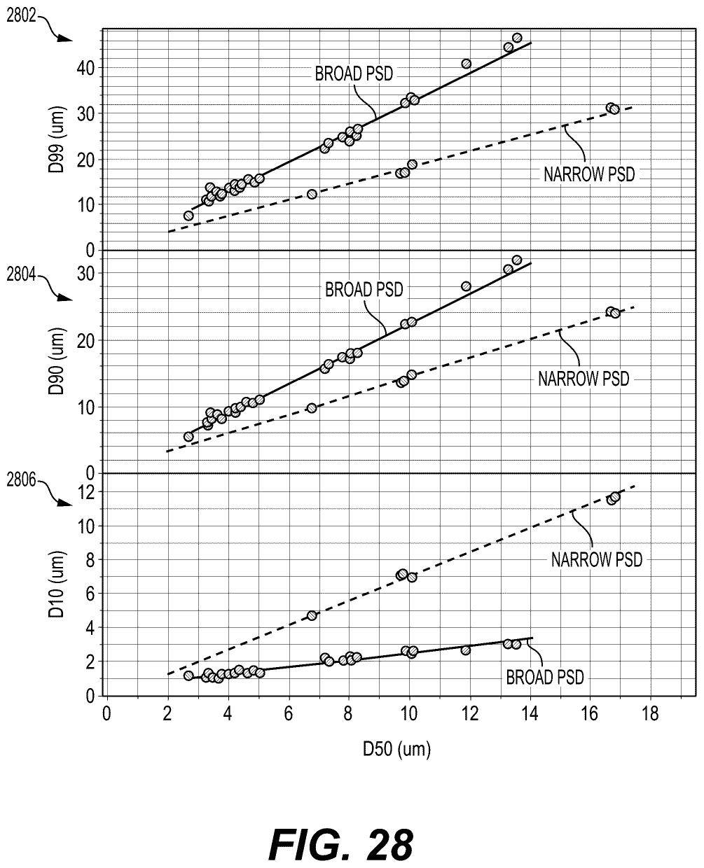

FIG. 28 shows graphical plots 2802, 2804, and 2806 of selected PSD characteristics of example populations of jagged composite particles. Graphical plot 2802 shows the dependence of D₉₉ values on D₅₀ values of respective populations of jagged composite particles, illustrating trends among populations that have not undergone PSD optimization (so-called “broad” PSDs) and populations that have undergone PSD optimization (so-called “narrow” PSDs). Graphical plot 2804 shows the dependence of D₉₀ values on D₅₀ values of respective populations of jagged composite particles, illustrating trends among populations that have not undergone PSD optimization (so-called “broad” PSDs) and populations that have undergone PSD optimization (so-called “narrow” PSDs). Graphical plot 2806 shows the dependence of D₁₀ values on D₅₀ values of respective populations of jagged composite particles, illustrating trends among populations that have not undergone PSD optimization (so-called “broad” PSDs) and populations that have undergone PSD optimization (so-called “narrow” PSDs).

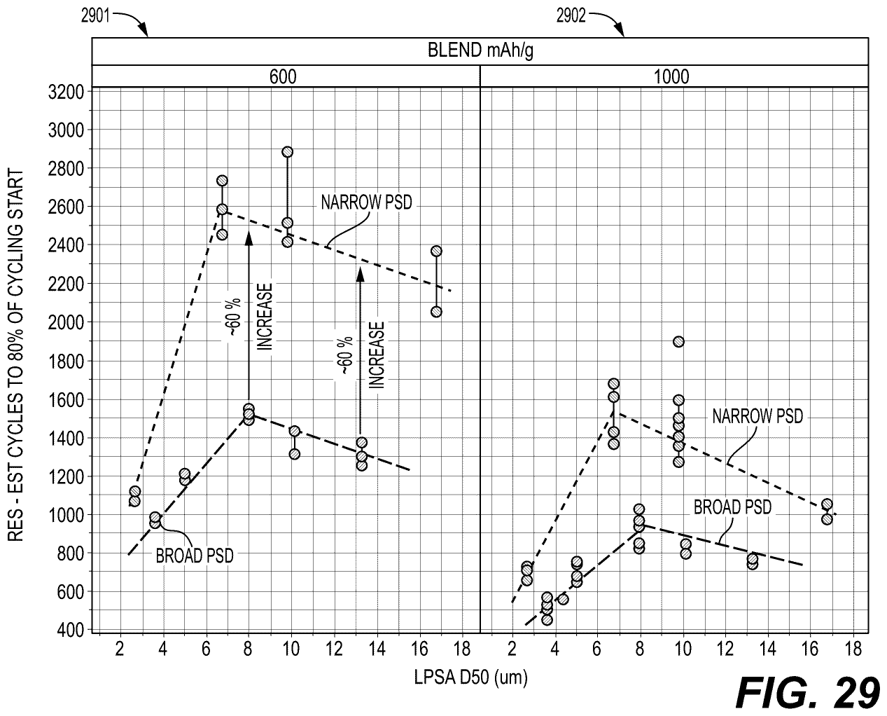

FIG. 29 shows graphical plots 2901 and 2902 showing the dependence of cycle life performance of Li-ion batteries (made with Si—C nanocomposite and graphite blended anode/NCM cathode) made using respective example populations of jagged composite particles in the anode on the D₅₀ values of the respective example populations. The fabrication and testing of electrodes and battery cells are as described herein with reference to the results shown in FIG. 24 and Table 1 (FIG. 25). Graphical plots 2901 and 2901 illustrate trends among populations that have not undergone PSD optimization (so-called “broad” PSDs) and populations that have undergone PSD optimization (so-called “narrow” PSDs). In the examples shown, the Li-ion batteries employed anodes comprising a mixture of the jagged composite particles and graphite particles (“active material mixtures”). Graphical plot 2901 shows cycle life (N80) data of Li-ion batteries employing type A electrodes (˜600 mAh/g electrode active material capacity). Graphical plot 2902 shows cycle life data (N80) of Li-ion batteries employing type B electrodes (˜1000 mAh/g electrode active material capacity).

For a particular value of D₅₀ of the composite particle population and for particular electrode type (˜600 mAh/g or ˜1000 mAh/g electrode active material capacity), Li-ion battery cells employing “narrow” PSDs that have undergone PSD optimization exhibited greater cycle life data (N80) than Li-ion battery cells employing “broad” PSD that have not undergone PSD optimization. The improvement in cycle life (N80) by employing “narrow” PSDs is pronounced for type A electrodes (˜600 mAh/g electrode active material capacity), for which N80 is observed to increase by more than 60% to exceed 2400 cycles in some cases. The improvement of cycle life from employing “narrow” PSDs is also observed in type B electrodes, for which cycle life values (N80) are observed to increase by more than 60% in some cases. For a particular value of D₅₀ of the composite particle population, Li-ion battery cells with a lower capacity blended anode (˜600 mAh/g electrode active material capacity) typically resulted in longer cycle life (N80) relative to Li-ion battery cells with a higher capacity blended anode (˜1000 mAh/g electrode active material capacity) (FIG. 29). As the D₅₀ values increase starting from about 2˜3 μm, better cycling stability (e.g., greater cycle life (N80)) is initially observed, likely due to factors such as less frequent occurrences of side reactions between the electrolyte and the composite particles (e.g., as exemplified by smaller growth of SEI or solid-electrolyte interphase). This trend of increasing cycle life (N80) is observed until optimal ranges (e.g., about 6 to about 9 μm, about 6 to about 10 μm, about 6 to about 12 μm) in the D₅₀ values are reached. As the D₅₀ values increase beyond optimal D₅₀ ranges, mechanical and other issues that limit cycle life may arise and the cycle life decreases to some extent. In some implementations, adoption of composite particles with “narrow” PSDs can significantly boost cycle stability (e.g., cycle life).

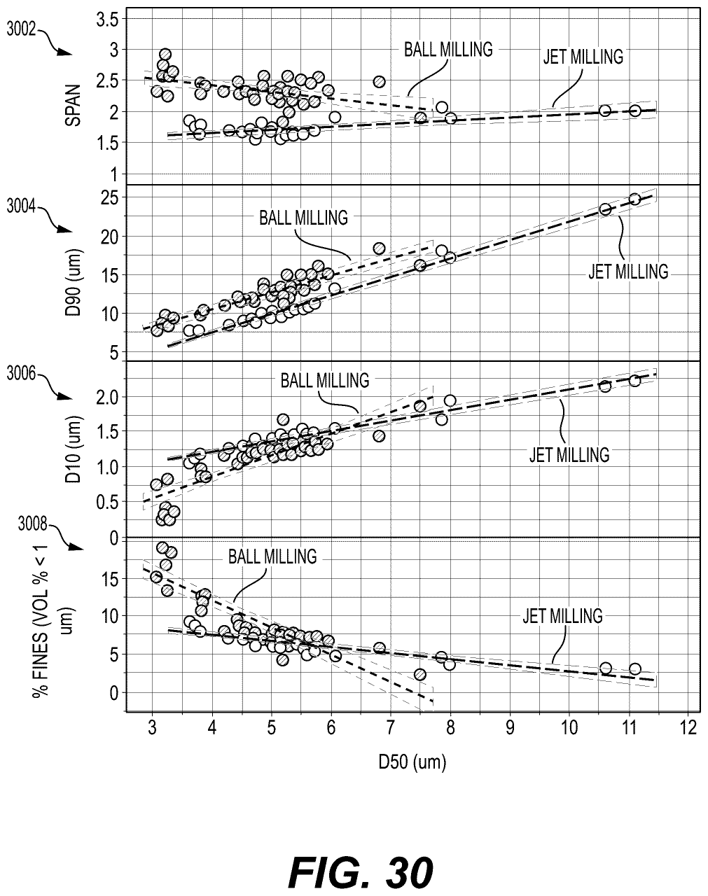

FIG. 30 shows graphical plots 3002, 3004, 3006, and 3008 showing the dependence of selected PSD characteristics of example populations of jagged composite particles on the D₅₀ values of the example populations. In the examples shown in FIG. 30, the PSDs of the respective populations were modified by comminution (either jet milling or ball milling). Graphical plots 3002, 3004, 3006, and 3008 illustrate trends among populations that have undergone ball milling and populations that have undergone jet milling. The PSD characteristics shown are span for 3002, D₉₀ for 3004, D₁₀ for 3006, and volume fraction of fine particles (or “fines,” defined as particles with diameters of 1 μm and below as measured by LPSA) in the population for 3008. Generally, both jet milling and ball milling have been found to be effective tools for comminution of larger particles, yielding composite particle populations with D₅₀ values in a range of about 3 μm to about 12 μm. There are also some differences between jet milling and ball milling. For examples shown in FIG. 30, the following observations may be made: (1) Graphical plot 3002 shows that for D₅₀ values in a range of about 3 μm to about 7 μm, ball milling tends to create populations with a larger span than does jet milling, for a particular D₅₀ value. (2) Graphical plot 3004 shows that for D₅₀ values in a range of about 3 μm to about 7 μm, ball milling tends to create populations with a larger D₉₀ than does jet milling, for a particular D₅₀ value. (3) Graphical plot 3006 shows that for D₅₀ values in a range of about 3 μm to about 6 μm, ball milling tends to create populations with a smaller D₁₀ than does jet milling, for a particular D₅₀ value. (4) Graphical plot 3008 shows that for D₅₀ values in a range of about 3 μm to about 5 μm, ball milling tends to create populations with a higher volume fraction of fines than does jet milling, for a particular D₅₀ value.

Some aspects of this disclosure may also be applicable to cells comprising other intercalation-type cathode materials (e.g., lithium iron phosphate (LFP), lithium manganese oxide (LMO), lithium manganese nickel oxide (LMNO), lithium iron manganese phosphate (LFMP), etc.) and cells comprising other conventional intercalation-type (e.g., carbonaceous-such as synthetic or artificial graphites, soft carbons, hard carbons and their various mixtures) anode materials and may provide benefits of improved rate performance or improved stability, particularly for electrodes with medium and high capacity loadings (e.g., greater than about 3-4 mAh/cm²).

Battery cell modules or battery cell packs may advantageously comprise cells with electrode and/or electrolyte compositions provided in this disclosure. Such cell modules or packs may offer improved performance characteristics, simplified designs, better safety features or lower cost.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered Clauses:
Clause 1. A battery electrode composition, comprising: a population of jagged composite particles, each of the jagged composite particles comprising silicon and carbon; wherein: 90% or more of the jagged composite particles in the population are characterized by aspect ratios of 2.3 or less; 50% or more of the jagged composite particles in the population are characterized by aspect ratios of 1.25 or more; and the population is characterized by a particle size distribution (PSD) as determined by laser particle size distribution analysis (LPSA) such that: a fiftieth-percentile volume-weighted particle size parameter D₅₀ of the PSD is in a range of about 2.0 to about 8.0 μm.
Clause 2. The battery electrode composition of clause 1, wherein: about 90% or more of the jagged composite particles in the population are characterized by aspect ratios of about 2.1 or less.
Clause 3. The battery electrode composition of any of clauses 1 to 2, wherein: about 50% or more of the jagged composite particles in the population are characterized by aspect ratios of about 1.35 or more.
Clause 4. The battery electrode composition of any of clauses 1 to 3, wherein: about 10% or more of the jagged composite particles in the population are characterized by aspect ratios of about 1.3 or less.
Clause 5. The battery electrode composition of any of clauses 1 to 4, wherein: a mass fraction of the silicon in the jagged composite particles is in a range of about 3 wt. % to about 80 wt. %.
Clause 6. The battery electrode composition of clause 5, wherein: the mass fraction of the silicon is in a range of about 35 wt. % to about 50 wt. %.
Clause 7. The battery electrode composition of any of clauses 1 to 6, wherein: a Brunauer-Emmett-Teller (BET) specific surface area of the population is in a range of about 3 m²/g to about 18 m²/g.
Clause 8. The battery electrode composition of any of clauses 1 to 7, wherein: the D₅₀ is in a range of about 2.0 to about 4.0 μm.
Clause 9. The battery electrode composition of clause 8, wherein: a cumulative volume fraction, defined as a cumulative volume of the jagged composite particles with particle sizes of about 4.6 μm or less, divided by a total volume of all of the jagged composite particles, is about 90 vol. % or less; and the particle sizes, the cumulative volume, and the total volume are estimated by the LPSA.
Clause 10. The battery electrode composition of clause 9, wherein: the cumulative volume fraction is about 85 vol. % or less.
Clause 11. The battery electrode composition of clause 10, wherein: the cumulative volume fraction is about 80 vol. % or less.
Clause 12. The battery electrode composition of any of clauses 1 to 11, wherein: the D₅₀ is in a range of about 6.0 to about 8.0 μm.
Clause 13. The battery electrode composition of clause 12, wherein: a Brunauer-Emmett-Teller (BET) specific surface area of the population is in a range of about 3 m²/g to about 12 m²/g.
Clause 14. A battery electrode, comprising: the battery electrode composition of claim 1 disposed on or in a current collector, wherein: the battery electrode comprises a binder.
Clause 15. The battery electrode of clause 14, wherein: a coating density of the battery electrode is in a range of about 0.9 to about 1.0 g/cm³.
Clause 16. The battery electrode of clause 15, additionally comprising a carbon-comprising functional additive(s).
Clause 17. The battery electrode composition of clause 16, wherein the carbon-comprising functional additive(s) is selected from one, two or more of the following: carbon nanotubes (including, but not limited to single walled carbon nanotubes and/or multi-walled carbon nanotubes), carbon nanofibers, carbon black, graphite, exfoliated graphite, graphene oxide, and graphene.
Clause 18. The battery electrode of any of clauses 14 to 17, wherein: the D₅₀ of the PSD of the population is in a range of about 6.0 to about 8.0 μm; and a mass fraction of the binder in the battery electrode is in a range of about 7 wt. % to about 10 wt. %.
Clause 19. The battery electrode of any of clauses 14 to 18, wherein: the D₅₀ of the PSD of the population is in a range of about 6.0 to about 8.0 μm; and an areal binder loading of the battery electrode is in a range of about 99.0 mg/m² to about 13.0 mg/m², the areal binder loading being defined as a mass fraction of the binder in the battery electrode, divided by a product of (1) a mass fraction of the jagged composite particles in the battery electrode, and (2) a Brunauer-Emmett-Teller (BET) specific surface area of the population.
Clause 20. A lithium-ion battery, comprising: an anode current collector; a cathode current collector; the battery electrode of clause 14 configured as an anode, the current collector thereof being configured as the anode current collector; a cathode disposed on or in the cathode current collector; and an electrolyte ionically coupling the anode and the cathode.
Clause 21. A method of making a battery electrode, the method comprising: (A1) providing the battery electrode composition of clause 1; (A2) making a slurry comprising the battery electrode composition and a binder; and (A3) casting the slurry on or in a current collector to form the battery electrode.
Clause 22. A method of making a lithium-ion battery, the method comprising: (B1) making the battery electrode according to the method of clause 21, the battery electrode being configured as an anode and the current collector being configured as an anode current collector; (B2) making or providing a cathode disposed on or in a cathode current collector; and (B3) assembling a battery cell from the anode and the cathode and filling a space between the anode and the cathode with an electrolyte ionically coupling the anode and the cathode to form the lithium-ion battery.
Clause 23. A method of making a lithium-ion battery, the method comprising: (C1) providing the battery electrode of clause 14, the battery electrode being configured as an anode and the current collector being configured as an anode current collector; (C2) making or providing a cathode disposed on or in a cathode current collector; and (C3) assembling a battery cell from the anode and the cathode and filling a space between the anode and the cathode with an electrolyte ionically coupling the anode and the cathode to form the lithium-ion battery.

Further implementation examples are described in the following numbered Additional Clauses:
Additional Clause 1. A battery electrode composition, comprising: a population of jagged composite particles, each of the jagged composite particles comprising silicon and carbon; wherein: about 90% or more of the jagged composite particles in the population are characterized by aspect ratios of about 2.3 or less; about 50% or more of the jagged composite particles in the population are characterized by aspect ratios of about 1.25 or more; and the population is characterized by a particle size distribution (PSD) as determined by laser particle size distribution analysis (LPSA) such that: a fiftieth-percentile volume-weighted particle size parameter (D₅₀) of the PSD of the population is in a range of about 2.0 to about 17.0 μm.
Additional Clause 2. The battery electrode composition of Additional Clause 1, wherein: about 90% or more of the jagged composite particles in the population are characterized by aspect ratios of about 2.1 or less.
Additional Clause 3. The battery electrode composition of any of Additional Clauses 1 to 2, wherein: about 50% or more of the jagged composite particles in the population are characterized by aspect ratios of about 1.35 or more.
Additional Clause 4. The battery electrode composition of any of Additional Clauses 1 to 3, wherein: about 10% or more of the jagged composite particles in the population are characterized by aspect ratios of about 1.3 or less.
Additional Clause 5. The battery electrode composition of any of Additional Clauses 1 to 4, wherein: a mass fraction of the silicon in the jagged composite particles is in a range of about 3 wt. % to about 80 wt. %.
Additional Clause 6. The battery electrode composition of Additional Clause 5, wherein: the mass fraction of the silicon is in a range of about 33 wt. % to about 60 wt. %.
Additional Clause 7. The battery electrode composition of any of Additional Clauses 1 to 6, wherein: a Brunauer-Emmett-Teller (BET) specific surface area (SSA) of the population is in a range of about 1 m²/g to about 18 m²/g.
Additional Clause 8. The battery electrode composition of Additional Clause 7, wherein: the BET-SSA is in a range of about 1 m²/g to about 10 m²/g.
Additional Clause 9. The battery electrode composition of any of Additional Clauses 1 to 8, wherein: the D₅₀ is in a range of about 2.0 to about 8.0 μm.
Additional Clause 10. The battery electrode composition of any of Additional Clauses 1 to 9, wherein: the D₅₀ is in a range of about 6.0 to about 17.0 μm.
Additional Clause 11. The battery electrode composition of Additional Clause 10, wherein: the D₅₀ is in a range of about 6.0 to about 9.0 μm.
Additional Clause 12. The battery electrode composition of any of Additional Clauses 1 to 11, wherein: a span of the PSD of the population is in a range of about 0.3 to about 1.8.
Additional Clause 13. The battery electrode composition of any of Additional Clauses 1 to 12, wherein: a tenth-percentile volume-weighted particle size parameter (D₁₀) of the PSD of the population is at least about 1.0 μm; and a value of the D₁₀ of the PSD of the population divided by the D₅₀ of the PSD of the population is in a range of 35% to 75%.
Additional Clause 14. The battery electrode composition of any of Additional Clauses 1 to 13, wherein: the battery electrode composition comprises a blended mixture of the jagged composite particles and graphite particles; and a mass fraction of the jagged composite particles in the battery electrode composition, excluding any binder, is in a range of about 10 wt. % to about 70 wt. %, or a mass fraction of the graphite particles in the battery electrode composition, excluding any binder, is in a range of about 30 wt. % to about 90 wt. %, or a combination thereof.
Additional Clause 15. The battery electrode composition of Additional Clause 14, wherein the D₅₀ of the PSD of the population is in a range of about 6.0 to about 12.0 μm.
Additional Clause 16. The battery electrode composition of any of Additional Clauses 14 to 15, wherein a tenth-percentile volume-weighted particle size parameter (D₁₀) of the PSD of the population is in a range of about 1.0 to about 4.0 μm.
Additional Clause 17. The battery electrode composition of any of Additional Clauses 14 to 16, wherein a ninetieth-percentile volume-weighted particle size parameter (D₉₀) of the PSD of the population is in a range of about 7.0 to about 25.0 μm.
Additional Clause 18. The battery electrode composition of Additional Clause 17, wherein the Doo is in a range of about 12.0 to about 20.0 μm.
Additional Clause 19. The battery electrode composition of any of Additional Clauses 14 to 18, wherein a ninety-ninth-percentile volume-weighted particle size parameter (D₉₉) of the PSD of the population is in a range of about 15.0 to about 28.0 μm.
Additional Clause 20. The battery electrode composition of any of Additional Clauses 14 to 19, wherein a span of the PSD of the population is in a range of about 0.6 to about 2.1.
Additional Clause 21. The battery electrode composition of any of Additional Clauses 14 to 20, wherein a Brunauer-Emmett-Teller (BET) specific surface area (SSA) of the population is in a range of about 1 m²/g to about 10 m²/g.
Additional Clause 22. The battery electrode composition of any of Additional Clauses 14 to 21, wherein the jagged composite particles exhibit a specific first cycle lithiation capacity in the range of about 1600 mAh/g to about 2200 mAh/g.
Additional Clause 23. The battery electrode composition of any of Additional Clauses 14 to 22, wherein a specific capacity of the blended mixture is in a range of about 600 mAh/g to about 1200 mAh/g when normalized by a mass of the blended mixture.
Additional Clause 24. A battery electrode, comprising: the battery electrode composition of Additional Clause 1 disposed on and/or in a current collector, wherein: the battery electrode comprises a binder.
Additional Clause 25. The battery electrode of Additional Clause 24, wherein: a coating density of the battery electrode is in a range of about 0.9 to about 1.7 g/cm³.
Additional Clause 26. The battery electrode of any of Additional Clauses 24 to 25, further comprising: a carbon-comprising functional additive.
Additional Clause 27. The battery electrode of Additional Clause 26, wherein the carbon-comprising functional additive is selected from: single-walled carbon nanotubes, multi-walled carbon nanotubes, carbon nanofibers, carbon black, exfoliated graphite, graphene oxide, and graphene.
Additional Clause 28. The battery electrode of Additional Clause 27, wherein a mass fraction of the carbon-comprising functional additive in the battery electrode is about 1 wt. % or less.
Additional Clause 29. The battery electrode of any of Additional Clauses 24 to 28, wherein: the D₅₀ of the PSD of the population is in a range of about 6.0 to about 8.0 μm; and a mass fraction of the binder in the battery electrode is in a range of about 7 wt. % to about 10 wt. %.
Additional Clause 30. The battery electrode of any of Additional Clauses 24 to 29, wherein: the D₅₀ of the PSD of the population is in a range of about 6.0 to about 8.0 μm; and an areal binder loading of the battery electrode is in a range of about 9.0 mg/m² to about 13.0 mg/m², the areal binder loading being defined as a mass fraction of the binder in the battery electrode, divided by a product of (1) a mass fraction of the jagged composite particles in the battery electrode, and (2) a Brunauer-Emmett-Teller (BET) specific surface area of the population.
Additional Clause 31. A lithium-ion battery, comprising: an anode current collector; a cathode current collector; the battery electrode of Additional Clause 24 configured as an anode, the current collector thereof being configured as the anode current collector; a cathode disposed on or in the cathode current collector; and an electrolyte ionically coupling the anode and the cathode.
Additional Clause 32. A method of making a battery electrode, the method comprising: (A1) providing the battery electrode composition of Additional Clause 1; (A2) making a slurry comprising the battery electrode composition and a binder; and (A3) casting the slurry on and/or in a current collector to form the battery electrode.
Additional Clause 33. A method of making a lithium-ion battery, the method comprising: (B1) making the battery electrode according to the method of Additional Clause 32, the battery electrode being configured as an anode and the current collector being configured as an anode current collector; (B2) making or providing a cathode disposed on and/or in a cathode current collector; and (B3) assembling a battery cell from the anode and the cathode and filling a space between the anode and the cathode with an electrolyte ionically coupling the anode and the cathode to form the lithium-ion battery.
Additional Clause 34. A method of making a lithium-ion battery, the method comprising: (C1) providing the battery electrode of Additional Clause 24, the battery electrode being configured as an anode and the current collector being configured as an anode current collector; (C2) making or providing a cathode disposed on and/or in a cathode current collector; and (C3) assembling a battery cell from the anode and the cathode and filling a space between the anode and the cathode with an electrolyte ionically coupling the anode and the cathode to form the lithium-ion battery.

This description is provided to enable any person skilled in the art to make or use embodiments of the present invention. It will be appreciated, however, that the present invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the invention.

1. A battery electrode composition, comprising:
a population of jagged composite particles, each of the jagged composite particles comprising silicon and carbon;
wherein:
about 90% or more of the jagged composite particles in the population are characterized by aspect ratios of about 2.3 or less;
about 50% or more of the jagged composite particles in the population are characterized by aspect ratios of about 1.25 or more; and
the population is characterized by a particle size distribution (PSD) as determined by laser particle size distribution analysis (LPSA) such that:
a fiftieth-percentile volume-weighted particle size parameter (D₅₀) of the PSD of the population is in a range of about 2.0 to about 17.0 μm.

2. The battery electrode composition of claim 1, wherein:
about 90% or more of the jagged composite particles in the population are characterized by aspect ratios of about 2.1 or less.

3. The battery electrode composition of claim 1, wherein:
about 50% or more of the jagged composite particles in the population are characterized by aspect ratios of about 1.35 or more.

4. The battery electrode composition of claim 1, wherein:
about 10% or more of the jagged composite particles in the population are characterized by aspect ratios of about 1.3 or less.

5. The battery electrode composition of claim 1, wherein:
a mass fraction of the silicon in the jagged composite particles is in a range of about 3 wt. % to about 80 wt. %.

6. The battery electrode composition of claim 5, wherein:
the mass fraction of the silicon is in a range of about 33 wt. % to about 60 wt. %.

7. The battery electrode composition of claim 1, wherein:
a Brunauer-Emmett-Teller (BET) specific surface area (SSA) of the population is in a range of about 1 m²/g to about 18 m²/g.

8. The battery electrode composition of claim 7, wherein:
the BET-SSA is in a range of about 1 m²/g to about 10 m²/g.

9. The battery electrode composition of claim 1, wherein:
the D₅₀ is in a range of about 2.0 to about 8.0 μm.

10. The battery electrode composition of claim 1, wherein:
the D₅₀ is in a range of about 6.0 to about 17.0 μm.

11. The battery electrode composition of claim 10, wherein:
the D₅₀ is in a range of about 6.0 to about 9.0 μm.

12. The battery electrode composition of claim 1, wherein:
a span of the PSD of the population is in a range of about 0.3 to about 1.8.

13. The battery electrode composition of claim 1, wherein:
a tenth-percentile volume-weighted particle size parameter (D₁₀) of the PSD of the population is at least about 1.0 μm; and
a value of the D₁₀ of the PSD of the population divided by the D₅₀ of the PSD of the population is in a range of 35% to 75%.

14. The battery electrode composition of claim 1, wherein:
the battery electrode composition comprises a blended mixture of the jagged composite particles and graphite particles; and
a mass fraction of the jagged composite particles in the battery electrode composition, excluding any binder, is in a range of about 10 wt. % to about 70 wt. %, or a mass fraction of the graphite particles in the battery electrode composition, excluding any binder, is in a range of about 30 wt. % to about 90 wt. %, or a combination thereof.

15. The battery electrode composition of claim 14, wherein
the D₅₀ of the PSD of the population is in a range of about 6.0 to about 12.0 μm.

16. The battery electrode composition of claim 14, wherein
a tenth-percentile volume-weighted particle size parameter (D₁₀) of the PSD of the population is in a range of about 1.0 to about 4.0 μm.

17. The battery electrode composition of claim 14, wherein
a ninetieth-percentile volume-weighted particle size parameter (D₉₀) of the PSD of the population is in a range of about 7.0 to about 25.0 μm.

18. The battery electrode composition of claim 17, wherein
the D₉₀ is in a range of about 12.0 to about 20.0 μm.

19. The battery electrode composition of claim 14, wherein
a ninety-ninth-percentile volume-weighted particle size parameter (D₉₉) of the PSD of the population is in a range of about 15.0 to about 28.0 μm.

20. The battery electrode composition of claim 14, wherein
a span of the PSD of the population is in a range of about 0.6 to about 2.1.

21. The battery electrode composition of claim 14, wherein
a Brunauer-Emmett-Teller (BET) specific surface area (SSA) of the population is in a range of about 1 m²/g to about 10 m²/g.

22. The battery electrode composition of claim 14, wherein
the jagged composite particles exhibit a specific first cycle lithiation capacity in the range of about 1600 mAh/g to about 2200 mAh/g.

23. The battery electrode composition of claim 14, wherein a specific capacity of the blended mixture is in a range of about 600 mAh/g to about 1200 mAh/g when normalized by a mass of the blended mixture.

24. A battery electrode, comprising:
the battery electrode composition of claim 1 disposed on and/or in a current collector,
wherein:
the battery electrode comprises a binder.

25. The battery electrode of claim 24, wherein:
a coating density of the battery electrode is in a range of about 0.9 to about 1.7 g/cm³.

26. The battery electrode of claim 24, further comprising:
a carbon-comprising functional additive.

27. The battery electrode of claim 26, wherein the carbon-comprising functional additive is selected from: single-walled carbon nanotubes, multi-walled carbon nanotubes, carbon nanofibers, carbon black, exfoliated graphite, graphene oxide, and graphene.

28. The battery electrode of claim 27, wherein a mass fraction of the carbon-comprising functional additive in the battery electrode is about 1 wt. % or less.

29. The battery electrode of claim 24, wherein:
the D₅₀ of the PSD of the population is in a range of about 6.0 to about 8.0 μm; and
a mass fraction of the binder in the battery electrode is in a range of about 7 wt. % to about 10 wt. %.

30. The battery electrode of claim 24, wherein:
the D₅₀ of the PSD of the population is in a range of about 6.0 to about 8.0 μm; and
an areal binder loading of the battery electrode is in a range of about 9.0 mg/m² to about 13.0 mg/m², the areal binder loading being defined as a mass fraction of the binder in the battery electrode, divided by a product of (1) a mass fraction of the jagged composite particles in the battery electrode, and (2) a Brunauer-Emmett-Teller (BET) specific surface area of the population.

31. A lithium-ion battery, comprising:
an anode current collector;
a cathode current collector;
the battery electrode of claim 24 configured as an anode, the current collector thereof being configured as the anode current collector;
a cathode disposed on or in the cathode current collector; and
an electrolyte ionically coupling the anode and the cathode.

32. A method of making a battery electrode, the method comprising:
(A1) providing the battery electrode composition of claim 1;
(A2) making a slurry comprising the battery electrode composition and a binder; and
(A3) casting the slurry on and/or in a current collector to form the battery electrode.

33. A method of making a lithium-ion battery, the method comprising:
(B1) making the battery electrode according to the method of claim 32, the battery electrode being configured as an anode and the current collector being configured as an anode current collector;
(B2) making or providing a cathode disposed on and/or in a cathode current collector; and
(B3) assembling a battery cell from the anode and the cathode and filling a space between the anode and the cathode with an electrolyte ionically coupling the anode and the cathode to form the lithium-ion battery.

34. A method of making a lithium-ion battery, the method comprising:
(C1) providing the battery electrode of claim 24, the battery electrode being configured as an anode and the current collector being configured as an anode current collector;
(C2) making or providing a cathode disposed on and/or in a cathode current collector; and
(C3) assembling a battery cell from the anode and the cathode and filling a space between the anode and the cathode with an electrolyte ionically coupling the anode and the cathode to form the lithium-ion battery.
